(19) United States
(12) Patent Application Publication
(10) Pub. No.: US 2026/0342807 A1
(43) Pub. Date: Oct. 29, 2026

(54) SECURE DISTRIBUTED WORKLOAD EXECUTION WITH INTEGRITY VERIFICATION

(71) Applicant: Haevek Inc., Gainesville, VA (US)

(72) Inventors: Andrew R. M. Hoeft, Gainesville, VA (US); Jonathon W. Arbaugh, Philadelphia, PA (US); Kevin M. Eveker, Moneta, VA (US)

(21) Appl. No.: 19/351,177

(22) Filed: Oct. 6, 2025

Related U.S. Application Data
(60) Provisional application No. 63/704,689, filed on Oct. 8, 2024.
(60) Provisional application No. 63/794,227, filed on Apr. 24, 2025.

(51) Int. Cl. H04L 9/40; G06F 9/50; G06F 21/64

(52) U.S. Cl. CPC H04L 63/12; G06F 9/5083; G06F 21/64

(57) ABSTRACT

An integrity layer implements an Integrity Management (IM) module that creates and challenges integrity digests for artifacts identified by artifact references. A digest entry records an artifact reference, an artifact hash, a digest hash, signatures, a timestamp, metadata, and chain references to other digest entries. Digest entries are stored in an integrity store. To create a digest, a control-layer agent requests creation, the IM module computes the artifact hash, assembles the digest, obtains an agent signature, countersigns, records the digest, and returns it. To challenge, the IM module generates an artifact hash and compares it to the stored artifact hash. If the hash matches, the IM module recursively challenges each referenced digest entry in the chain. Chains may reference digests for source code, a compiler, a build environment, dependencies, and a workload bundle. Creation can occur at source, compilation, packaging, and registration stages.

### RELATED APPLICATIONS

This application claims the benefit of U.S. Provisional Patent Applications 63/704,689 and 63/794,227, filed Oct. 8, 2024 and Apr. 24, 2025, respectively, and which are incorporated by reference.

This application also incorporates by reference U.S. patent application Ser. No. 19/322,524, filed Sep. 8, 2025.

### FIELD OF INVENTION

The present disclosure relates to distributed computing systems, and more particularly to a system and method for secure orchestration and execution of verified distributed compute workloads with integrity verification.

### BACKGROUND

Distributed computing systems have become increasingly prevalent in modern technological landscapes, enabling the processing of large-scale workloads across multiple interconnected nodes. These systems leverage the collective computational power of numerous machines to handle complex tasks, data analysis, and resource-intensive applications. As organizations rely more heavily on distributed architectures, the orchestration and management of workloads across diverse computing environments have grown in complexity.

Trustworthiness and integrity verification in distributed systems present ongoing challenges due to the decentralized nature of these architectures. The distributed execution of workloads introduces potential vulnerabilities at various points in the system, from data transmission between nodes to the execution of code on individual machines. As a result, ensuring the confidentiality, integrity, and availability of workloads throughout their lifecycle has become a focal point in the development of robust distributed computing frameworks.

### SUMMARY

To ensure the security and verifiability of a workflow, a distributed compute system uses an integrity layer to generate and maintain integrity digest entries for workflow artifacts. Integrity digest entries are entries in an integrity data store that contain integrity information for workflow artifacts. For example, the digest entry for an artifact may include a hash of the artifact and reference information for the artifact (e.g., a locator information or identification information for an artifact, such as a file path).

Some of the integrity digest entries include integrity digest chain information. The digest chain information for an integrity digest entry refers to digest entries for artifacts that were used to produce or verify the artifact. For example, an integrity digest entry for compiled code may include, in its integrity digest chain information, references to digest entries for the source code, the compiler, or dependencies used by the source code.

The distributed compute system uses digest entries to verify artifacts before they are used in a workflow. For example, a node (e.g., a physical machine, a virtual machine, or a process executing thereon) within the integrity layer may receive a “digest challenge” request to another node within the distributed compute system. The digest challenge request contains reference information for the artifact and requests that the integrity node verify the artifact. The integrity node identifies an integrity digest entry corresponding to the artifact and may generate a hash based on the provided artifact and compare the generated hash to one that is stored in a corresponding digest entry. The integrity node may determine that the digest challenge was a success if the generated hash matches the hash stored in the digest entry.

If the digest entry also includes chain information, the integrity node may perform a recursive integrity challenge on the digest entries listed in the chain information. Specifically, the integrity node may retrieve each of the artifacts corresponding to the digest entries listed in the chain information and generate a hash for each one. The integrity node may compare each generated hash to a hash in a corresponding integrity digest entry and, if each generated hash matches its corresponding stored hash, the integrity node may determine that the digest challenge was successful. However, if any of the comparisons show a mismatch between hashes, the integrity node may determine that the integrity challenge failed.

These digest challenges may be requested by the distributed compute system's control layer when the control layer builds a workflow package for execution by nodes in the execution layer. For example, the control layer may request an integrity challenge from a node in the integrity layer for each artifact used to generate a workflow package that is transmitted to nodes in the execution layer. For example, the control layer may perform a first integrity challenge for source code received from a user, a second integrity challenge for dependencies used by the source code, a third integrity challenge for the compiler used to compile the source code, and a fourth integrity challenge for the compiled source code. As noted above, this fourth integrity challenge may recursively challenge the previous three artifacts, since the compiled source code is related to those underlying artifacts.

In some aspects, the techniques described herein relate to a method including: transmitting, to an integrity node of an integrity layer of a distributed compute system, a request to perform an integrity challenge for a workflow artifact for a workflow, wherein the integrity challenge request includes reference information for the workflow artifact; accessing the workflow artifact at the integrity node based on the reference information; identifying a digest entry corresponding to the accessed workflow artifact within an integrity store of the distributed compute system, wherein the integrity store includes a set of digest entries for a set of workflow artifacts for the workflow and wherein each of the set of digest entries includes a hash of the corresponding workflow artifact and chain information identifying one or more other digest entries stored by the integrity store upon which the corresponding workflow artifact is based; generating a hash of the accessed workflow artifact; comparing the generated hash to the hash stored in the identified digest entry to determine whether the generated hash matches the stored hash; responsive to the generated hash matching the stored hash, recursively performing an integrity challenge for each of one or more workflow artifacts associated with the one or more digest entries identified in the chain information of the identified digest entry, wherein an integrity challenge for a digest entry of the one or more digest entries includes comparing a generated hashes of the workflow artifact associated with the digest entry with a hash stored in the digest entry; and responsive to the recursively performed integrity challenges being successful, transmitting instructions by the integrity node to another node of distributed compute system to proceed with workflow.

In some aspects, the techniques described herein relate to a method, further including: transmitting the request to perform the integrity challenge to the integrity node by a node within a control layer of the distributed compute system.

In some aspects, the techniques described herein relate to a method, further including: transmitting the request to perform the integrity challenge responsive to receiving instructions from a device associated with a user to execute the workflow.

In some aspects, the techniques described herein relate to a method, further including: receiving the instructions to proceed with the workflow at the other node within the control layer; generating an execution bundle for the workflow, wherein the execution bundle includes the workflow artifact and the one or more workflow artifacts associated with the chain information of the identified digest entry; and transmitting the execution bundle to a node in an execution layer of the distributed compute engine.

In some aspects, the techniques described herein relate to a method, wherein the workflow artifact includes at least one of: source code, compiled source code, a compiler, or a dependency of source code.

In some aspects, the techniques described herein relate to a method, wherein the workflow artifact includes compiled source code and wherein the one or more workflow artifacts of the chain information include source code associated with the compiled source code, a compiler that generated the compiled source code, and a dependency used to generate the compiled source code.

In some aspects, the techniques described herein relate to a method, wherein the reference information for the workflow artifact includes a file path for the workflow artifact.

In some aspects, the techniques described herein relate to a method, wherein the integrity store includes a table for storing the set of digest entries.

In some aspects, the techniques described herein relate to a method, wherein an integrity challenge for a digest entry of the one or more digest entries includes: accessing the workflow artifact associated with the digest entry based on reference information stored in the digest entry; generating a hash of the workflow artifact associated with the digest entry; and comparing the generated hash to the hash stored in the digest entry to determine whether the generated hash matches the stored hash.

In some aspects, the techniques described herein relate to a method, wherein the integrity challenge for the digest entry of the one or more digest entries includes: performing an integrity challenge on one or more other digest entries identified in chain information of the digest entry.

In some aspects, the techniques described herein relate to a non-transitory computer-readable medium storing computer-executable instructions that, when executed, cause a computing system to perform operations including: transmitting, to an integrity node of an integrity layer of a distributed compute system, a request to perform an integrity challenge for a workflow artifact for a workflow, wherein the integrity challenge request includes reference information for the workflow artifact; accessing the workflow artifact at the integrity node based on the reference information; identifying a digest entry corresponding to the accessed workflow artifact within an integrity store of the distributed compute system, wherein the integrity store includes a set of digest entries for a set of workflow artifacts for the workflow and wherein each of the set of digest entries includes a hash of the corresponding workflow artifact and chain information identifying one or more other digest entries stored by the integrity store upon which the corresponding workflow artifact is based; generating a hash of the accessed workflow artifact; comparing the generated hash to the hash stored in the identified digest entry to determine whether the generated hash matches the stored hash; responsive to the generated hash matching the stored hash, recursively performing an integrity challenge for each of one or more workflow artifacts associated with the one or more digest entries identified in the chain information of the identified digest entry, wherein an integrity challenge for a digest entry of the one or more digest entries includes comparing a generated hashes of the workflow artifact associated with the digest entry with a hash stored in the digest entry; and responsive to the recursively performed integrity challenges being successful, transmitting instructions by the integrity node to another node of distributed compute system to proceed with workflow.

In some aspects, the techniques described herein relate to a non-transitory computer-readable medium, the operations further including: transmitting the request to perform the integrity challenge to the integrity node by a node within a control layer of the distributed compute system.

In some aspects, the techniques described herein relate to a non-transitory computer-readable medium, the operations further including: transmitting the request to perform the integrity challenge responsive to receiving instructions from a device associated with a user to execute the workflow.

In some aspects, the techniques described herein relate to a non-transitory computer-readable medium, the operations further including: receiving the instructions to proceed with the workflow at the other node within the control layer; generating an execution bundle for the workflow, wherein the execution bundle includes the workflow artifact and the one or more workflow artifacts associated with the chain information of the identified digest entry; and transmitting the execution bundle to a node in an execution layer of the distributed compute engine.

In some aspects, the techniques described herein relate to a non-transitory computer-readable medium, wherein the workflow artifact includes at least one of: source code, compiled source code, a compiler, or a dependency of source code.

In some aspects, the techniques described herein relate to a non-transitory computer-readable medium, wherein the workflow artifact includes compiled source code and wherein the one or more workflow artifacts of the chain information include source code associated with the compiled source code, a compiler that generated the compiled source code, and a dependency used to generate the compiled source code.

In some aspects, the techniques described herein relate to a non-transitory computer-readable medium, wherein the reference information for the workflow artifact includes a file path for the workflow artifact.

In some aspects, the techniques described herein relate to a non-transitory computer-readable medium, wherein the integrity store includes a table for storing the set of digest entries.

In some aspects, the techniques described herein relate to a non-transitory computer-readable medium, wherein an integrity challenge for a digest entry of the one or more digest entries includes: accessing the workflow artifact associated with the digest entry based on reference information stored in the digest entry; generating a hash of the workflow artifact associated with the digest entry; and comparing the generated hash to the hash stored in the digest entry to determine whether the generated has matches the stored hash.

In some aspects, the techniques described herein relate to a non-transitory computer-readable medium, wherein the integrity challenge for the digest entry of the one or more digest entries includes: performing an integrity challenge on one or more other digest entries identified in chain information of the digest entry.

### BRIEF DESCRIPTION OF THE FIGURES

The accompanying drawings, which are incorporated herein and constitute part of this specification, illustrate exemplary embodiments of the claims, and, together with the general description given and the detailed description, serve to explain the features herein.

FIG. 1 is a block diagram of a distributed compute system for secure orchestration and execution of verified distributed compute workloads, according to various embodiments.

FIG. 2 is a block diagram of a distributed compute system, according to various embodiments.

FIG. 3 is a block diagram showing relationships among system processes in a compute workload lifecycle, according to various embodiments.

FIG. 4 is an integrity digest chain system showing relationships between digest components during workload creation and registration processes, according to various embodiments.

FIG. 5 is a process flow diagram of an integrity digest creation process, according to various embodiments.

FIGS. 6A and 6B are process flow diagrams of integrity digest challenge processes, according to various embodiments.

FIGS. 7A and 7B are together a process flow diagram of a workload creation process, according to various embodiments.

FIG. 8 is a process flow diagram of a workload registration process, according to various embodiments.

FIGS. 9A and 9B are process flow diagrams of workload orchestration and execution processes, according to various embodiments.

FIG. 10 is a process flow diagram of a workload output provenance verification process, according to various embodiments.

FIG. 11 is a process flow diagram of a system initialization process, according to various embodiments.

FIGS. 12A and 12B are together a process flow diagram of an advanced integrity digest challenge process, according to various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims.

Various embodiments include a system and method for secure orchestration and execution of verified distributed compute workloads with integrity verification. The system comprises a control layer, an execution layer, and an integrity layer that work together to ensure the confidentiality, integrity, and availability of workloads throughout their lifecycle, from creation and registration to execution and output verification.

Various embodiment systems provide enhanced security and efficiency for distributed computing environments by creating integrity digests and implementing integrity digest challenges, encrypted communication protocols, and continuous monitoring of workload execution. The modular architecture allows for flexible deployment across various computing environments, including cloud, on-premises, and hybrid infrastructures.

As used herein, the term “layer” refers to a logical separation of an application's components, modules, and/or processes based on functionality and abstraction levels. Layers help enforce separation of concerns, improve maintainability, and structure software into distinct sections. In effect, a layer comprises anything that works together to achieve the functions of the layer. A layer may have multiple components, and each component may have multiple modules and processes.

As used herein, the term “module” refers to a unit of functionality within a system that encapsulates related features and exposes a defined interface for interaction. Modules promote code reuse, maintainability, and separation of concerns by grouping related implementation elements, which may include functions, threads, and/or one or more microservices. Modules may perform one or more workflow processes.

As used herein, the terms “computing system” and “computing device” refer to (but are not limited to) any one or all of servers, workstations, desktop computers, laptop computers, and other similar computing systems that include a memory for storing data and a programmable processing system that may be configured to provide the functionality of various embodiments.

These computing systems and devices may encompass a wide range of configurations, from standalone personal computers to complex distributed networks of interconnected machines. Servers may include high-performance machines designed for continuous operation and handling multiple client requests, often housed in data centers or server farms. Workstations typically refer to powerful desktop computers optimized for specialized tasks such as scientific computing, graphic design, or financial modeling. Desktop computers represent general-purpose machines suitable for home or office use, while laptops offer portability without sacrificing significant computing power.

The memory components in these systems can vary widely, including combinations of volatile RAM for fast data access and non-volatile storage like SSDs or HDDs for long-term data retention. The programmable processing system forms the core of these devices, typically consisting of one or more central processing units (CPUs) that execute instructions and manage system resources. Modern computing systems often incorporate specialized processors to enhance performance in specific domains. For instance, graphical processing units (GPUs), tensor processing units (TPUs), and neural processing units (NPUs) excel at parallel processing tasks for various classes of problems, making them ideal for vectorized operations, scientific simulations, and, increasingly, machine learning and artificial intelligence applications.

The flexibility to configure these systems for various embodiments underscores their adaptability to a wide range of applications and use cases. This configurability allows organizations to tailor their computing resources to specific needs, whether for data analysis, software development, content creation, or any other computational task required by modern businesses and research institutions.

Current related distributed computing systems often fall short in providing comprehensive confidentiality, integrity, and availability verification throughout the workload lifecycle. Many existing solutions rely on outdated technologies and lack robust mechanisms for workload integrity verification, mandatory access controls, and end-to-end data and control code security. These shortcomings can lead to vulnerabilities in workload execution, data breaches, compromised system integrity, and a lack of trust in internal system operations, particularly in complex enterprise environments. Therefore, there is an unmet need for a distributed compute system that can ensure workload integrity, enforce security protocols, and provide efficient execution while maintaining flexibility across various computing environments, including cloud, on-premises, hybrid, and edge infrastructures.

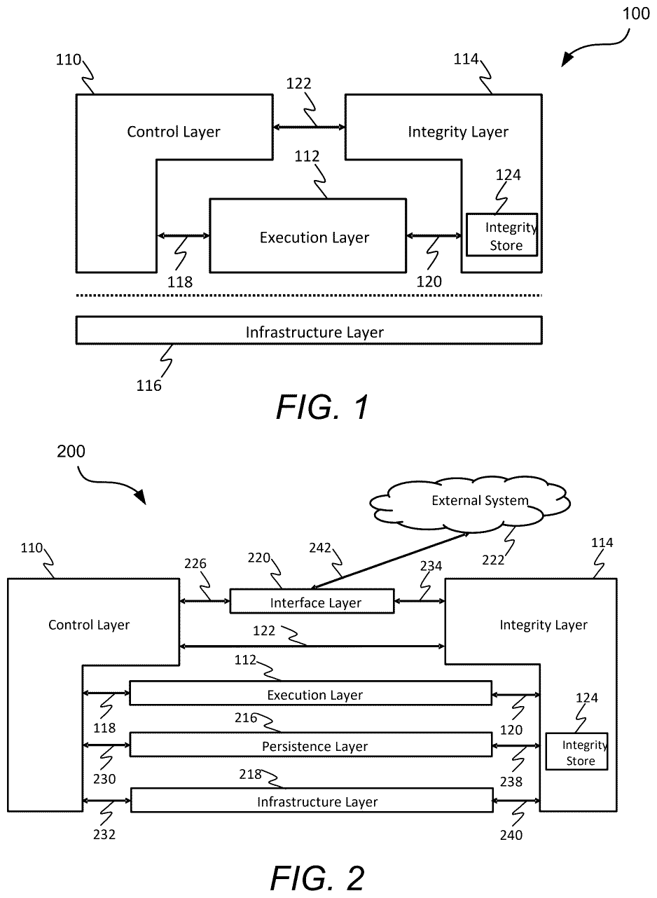

FIG. 1 illustrates a block diagram of a multilayered distributed compute architecture 100 for secure management, orchestration, and execution of verified distributed compute workloads according to various embodiments. This architecture comprises multiple interconnected layers, each serving a specific purpose in the overall system. The design emphasizes confidentiality, integrity, and availability throughout the workload lifecycle, from initial receipt to final execution. By incorporating dedicated layers for control, execution, and integrity management, the system aims to provide a robust framework for handling distributed compute tasks while maintaining high levels of security and verification at each step of the process.

Various embodiments provide methods of secure orchestration and execution of verified distributed compute workloads. Various embodiment methods may include receiving, by a control layer, a compute workload from a source, creating an integrity digest for the compute workload with an integrity layer and/or initiating an integrity digest challenge for the compute workload with an integrity layer, and orchestrating the compute workload within an execution layer based on specified criteria. Various embodiment methods further include monitoring, by the control layer, execution of the compute workload within the execution layer, and responding, by the control layer, to monitored events and alerts generated by the control layer, the execution layer, and the integrity layer.

In some embodiments, the method may include creating, by the integrity layer, an integrity digest for the compute workload. Creating the integrity digest may involve computing a cryptographic hash of the compute workload and storing the hash with associated metadata in an integrity store. The integrity layer may compare these computed hashes against previously stored values to detect any unauthorized tampering, modifications, corruption, or other unintended behavior. The integrity layer may also implement digital signature verification to ensure the authenticity of workloads and system components.

The orchestration of the compute workload may include assigning the compute workload to at least one processor across at least one execution node in the execution layer. Additionally, the method may involve verifying, by the control layer before orchestration, the integrity of the compute workload and/or verifying, by the execution layer before execution on at least one execution node, the integrity of the compute workload.

In various embodiments, the method may further include enforcing, by the integrity layer, encryption for communication and data exchange within the system. This enforcement of encryption may involve configuring the system to use an encryption mechanism that ensures secure communication between system components involved in command-and-control communications over a computer network. For example, the system may use a Transport Layer Security (TLS) protocol or a technique such as mutual-TLS (mTLS). Various other systems may be employed to maintain confidentiality in distributed computing environments.

The multilayered distributed compute architecture 100 for secure orchestration and execution of verified distributed compute workloads may include at least a control layer 110, an execution layer 112, and an integrity layer 114. These components work together to ensure secure and verified workload processing. The multilayered distributed compute architecture 100 may also include an infrastructure layer 116 that is present and communicates with one or more of the other layers 110, 112, 114 but is not actively controlled by the multilayered distributed compute architecture 100 and/or any of its layers 110, 112, 114. The control layer 110 connects to the execution layer 112 via a control-execution connection 118. The integrity layer 114 maintains connections with both the control layer 110 and execution layer 112 through a control-integrity connection 122 and integrity-execution connection 120 respectively. The integrity layer 114 may include an integrity store 124 for maintaining system integrity data.

The control layer 110 may utilize instructions to cause a processing system to perform operations including receiving compute workloads, initiating integrity digest challenges with the integrity layer, orchestrating the compute workload within the execution layer, monitoring the execution of the compute workload within the execution layer, and responding to monitored events and alerts by one or more of the layers 110, 112, 114. The control layer 110 may utilize operating instructions to carry out these operations.

The control layer may receive compute workloads from various internal and/or external sources. For example, the control layer may receive compute workloads that were pre-staged for orchestration before the system is initiated (e.g., the system may be configured with a reference to a directory that stores a workload manifest with references to workload container images, and the system may further be configured to automatically run one or more select workload images in that directory or from that manifest as part of its lifecycle). Using pre-staged compute workloads may not include the involvement of a third party (i.e., an external source); rather, it may involve and/or be initiated by an internal control layer process or direct interaction by a system administrator.

For compute workloads received from an external source, the control layer 110 may implement an interface to accept workload submissions from various sources and validate their format and contents. The term “sources” in this context refers to one or more sources selected from agents and/or components that can submit compute workloads to the control layer 110. These sources may include internal system processes, external applications, user interfaces, or automated scripts. As used herein, the term “agent” refers to an entity that performs actions or makes decisions in relation to a specific environment and can be either an external actor, such as a user, system administrator, or external system, or an internal module or component within the system. An agent may function autonomously, interacting with data, systems, or other agents to achieve predefined objectives. For example, in a multi-agent system, agents may collaborate to solve complex problems, with some acting as external entities providing input or oversight, while others function as internal components managing tasks such as data processing or resource allocation. The interface implemented by the control layer 110 may serve multiple purposes. For example, the interface may provide a standardized entry point for workload submissions, allowing different types of sources to interact with the system in a consistent manner. This interface may support various protocols and data formats to accommodate different source requirements. Additionally, the interface may include its own validation mechanisms to ensure the integrity and compatibility of submitted workloads. This validation process may involve checking the format of the submission to ensure it adheres to predefined standards or schemas. It may also include content validation, which could involve verifying that the workload contains all necessary components, such as code, data references, and execution parameters. By implementing this type of interface, the control layer 110 can effectively manage the influx of compute workloads from diverse sources while maintaining system security and operational consistency.

The control layer 110 may initiate the integrity digest challenge by first requesting the integrity layer 114 verify the authenticity and integrity of a workload or system artifact before allowing further processing or execution. This challenge may involve a multi-step verification process that leverages a cryptographic hash-based integrity digest previously generated and stored in a secure integrity store. The control layer 110 transmits a reference to the artifact and any associated metadata to the integrity layer 114, which in turn retrieves the corresponding integrity digest. The integrity layer 114 calculates a hash of the current artifact and compares it against the stored hash value in the digest. If the computed hash matches the stored value, the challenge is considered successful, confirming that the artifact has not been altered since its last verified state.

Conversely, any mismatch indicates potential tampering or corruption, prompting the control layer 110 to halt the orchestration process and possibly log a failure event for administrative review.

The control layer responds to various situations by implementing a comprehensive set of actions to maintain system integrity and security. In cases where the integrity digest challenge reveals a mismatch, indicating potential tampering or corruption, the control layer may immediately halt the orchestration process to prevent the execution of potentially compromised workloads. This proactive measure may be accompanied by logging a failure event, which may serve as a crucial record for administrative review and subsequent security analysis. The control layer may also initiate a series of predefined security protocols in response to such incidents. These protocols may include alerting system administrators through various channels, such as email notifications or dashboard alerts, to ensure prompt attention to the security concern. In some cases, the control layer may take more aggressive measures, such as isolating the compromised workload to prevent it from affecting other system components or data. This isolation may involve moving the workload to a quarantine area for further analysis or completely removing it from the active system environment. Additionally, the control layer may revoke execution permissions for tasks related to the compromised workload, effectively creating a security perimeter around the potential threat. Once the integrity layer communicates that a compute workload has successfully passed the integrity check, the control layer may proceed with releasing the workload to the execution layer for processing. This release may be accompanied by specific instructions or parameters to guide the execution process, ensuring that the workload is processed according to predefined security and performance criteria. Throughout these processes, the control layer may maintain constant communication with the integrity layer via the control-integrity connection, enabling real-time logging of incidents and triggering of necessary security responses. This ongoing dialogue between layers may allow for a dynamic and responsive security posture, adapting to emerging threats or anomalies as they are detected. The control layer may also play a crucial role in the workload registration process, facilitating the validation and tracking of workloads across different environments. This may involve implementing checkpoints at various stages of the workload lifecycle, from creation to execution, to ensure that the workload remains unchanged and trusted throughout its journey through the system. By orchestrating these diverse responses and maintaining vigilant oversight, the control layer may contribute significantly to the overall confidentiality, integrity, and availability of the distributed compute system.

The integrity digest challenge is a security mechanism designed to ensure that each component of a distributed system adheres to established integrity constraints throughout its lifecycle. It forms part of a broader security framework by providing cryptographic proof of integrity for workloads, executable files, dependencies, configurations, compilers, builders, and other runtime environment data beyond the workload executables/dependencies. This challenge may also involve recursive integrity verification, where the integrity of related artifacts (e.g., source code, compiled binaries, runtime dependencies) is challenged sequentially. Additionally, the challenge can include checks for digital signatures to validate the artifact's origin and authorization status or checks on the verifiable occurrence of events in a chain (e.g., a workload that was manually reviewed and certified with an agent support). This robust verification process prevents unauthorized modifications and helps maintain a trusted execution environment, ensuring that all system components meet strict confidentiality, integrity, and availability standards before execution proceeds.

Thus, the control layer 110 communicating with the integrity layer 114 may ensure that only verified and untampered workloads proceed. Integrity checks, like the integrity digest challenge, may be conducted both prior to and during execution. This comprehensive orchestration framework ensures that operations within the distributed system are executed efficiently, securely, and in alignment with organizational objectives. Once the control layer 110 receives an indication from the integrity layer 114 that a compute workload has passed the integrity check, the control layer 110 may release the compute workload to the execution layer 112 for execution thereof.

To orchestrate operations of the compute workload within the execution layer 112, the control layer 110 may use specific criteria to coordinate activities across system components, manage workload lifecycles, and optimize resource allocation. The control layer 110 orchestrates system operations through a sophisticated coordination of criteria designed to optimize resource allocation and manage the workload lifecycle. This process involves first analyzing incoming workloads to assess their computational requirements, such as processing power, memory, and I/O needs. Based on these parameters, the control layer 110 may select optimal execution nodes within the execution layer 112, accounting for resource availability, current load balancing, and system-wide performance goals. The allocation process may also consider geographic constraints, security requirements, or workload-specific preferences, such as prioritization of time-sensitive tasks. Once resources are assigned, the control layer 110 may prepare the execution layer 112 by configuring runtime dependencies, security protocols, and establishing communication channels between system components. The control layer 110 may also decompose complex workloads into smaller, distributed tasks to enhance parallel processing and minimize execution latency.

For monitoring execution, the control layer 110 may collect performance metrics, track progress, and detect anomalies or errors. For example, during execution of the compute workload by the execution layer 112, the control layer 110 may continuously monitor key performance indicators (KPIs) such as task completion rates, cache hit/miss rates, component latency, task/stage/step retry rates, per-executor completion rates, shuffle efficiency, system utilization, error reports, and the like. Real-time monitoring allows for proactive adjustments, such as reallocating resources, triggering failover mechanisms, or restarting failed processes, thereby maintaining system stability and performance.

The control layer 110 may also implement mechanisms to respond to monitored events and alerts generated by one or more of the control layer, the execution layer, and/or the integrity layer by adjusting resource allocation, restarting failed tasks, or notifying administrators as needed.

The control layer 110 may facilitate dynamic scaling and fault tolerance, automatically responding to events such as hardware failures or increased workload demand by allocating additional resources or redirecting traffic.

The execution layer 112 may utilize instructions received from the control layer 110 to cause a processing system to perform operations including executing the received workloads on one or more processors. Optionally, the execution layer 112 may implement its own mechanisms to verify the integrity of workloads before execution. This verification process may involve comparing cryptographic hashes of the workload against previously stored values, checking digital signatures, and validating the integrity of any dependencies or runtime environments associated with the workload. The execution layer 112 may also implement isolation and sandboxing techniques to enhance security during workload processing.

The integrity layer 114 may utilize instructions to cause the processing system to perform operations including verifying the integrity of workloads and system components throughout the workload lifecycle. That verification process involves computing cryptographic hashes of workloads and system components at various stages of the lifecycle (e.g., between the layers 110, 112, 114). The integrity layer may compare these computed hashes against previously stored values to detect any unauthorized tampering, modifications, corruption, or other unintended behavior. The integrity layer may also implement digital signature verification to ensure the authenticity of workloads and system components. The integrity layer may maintain a chain of integrity digests, allowing for comprehensive verification from initial workload creation through execution and output generation. In certain implementations, the integrity layer may perform recursive integrity checks on dependencies and runtime environments associated with workloads. In some embodiments, the integrity layer may interact with other system layers, such as the control layer and execution layer, to coordinate integrity verification processes and respond to potential security threats or anomalies detected during the workload lifecycle.

The integrity layer 114 may enforce secure execution by implementing a process that verifies the authorization and integrity of operations initiated within the execution layer 112. This verification process may begin when a request to execute a workload or operation is received by the execution layer 112. The integrity layer 114 validates that the request originates from an authorized source, such as the control layer 110 or a client or service explicitly authorized and delegated by the control layer 110. This is achieved through a combination of cryptographic techniques, including digital signature verification and integrity challenges.

In instances in which the control layer 110 delegates execution permissions, the control layer 110 generates a workload execution manifest containing metadata about the compute workload, such as identifiers, resource allocations, and execution parameters. The integrity layer 114 may verify this manifest and/or the associated workload execution bundle by checking the digital signature against known public keys associated with authorized entities, which may be one part of the process of ensuring the instruction has not been altered and originates from a trusted source. In instances in which the verification fails, the integrity layer 114 blocks the execution request and logs a security event for further investigation.

Additionally, the integrity layer 114 may perform an integrity digest challenge to confirm that workload artifacts such as executables, dependencies, configurations, compilers, builders, and/or other runtime environment data have not been tampered with since their last verified state. This may involve computing hashes for the artifact and comparing them with corresponding entries in the integrity store. The integrity layer may also enforce time-limited execution tokens, ensuring that authorization is valid within a specified window, thereby reducing the risk of unauthorized execution attempts due to delayed or replayed instructions. By implementing these measures, the integrity layer 114 may ensure that all operations executed on the execution layer 112 comply with strict security and authorization protocols.

The integrity layer 114 may include an integrity store 124, which may be used to store integrity-related data such as integrity digests and verification results. This type of storage promotes efficient integrity checks and auditing throughout the system. The integrity store 124 may be a secure repository within the integrity layer 114 responsible for maintaining the integrity digests and associated metadata that are used for workload and component verification. The integrity store 124 may provide a reliable and tamper-resistant storage mechanism for cryptographic hashes, integrity challenges, signatures, fingerprints, and audit trails related to system artifacts. In instances in which a compute workload is received in the system, the integrity layer 114 may compute a cryptographic hash of the artifact and record this value, along with metadata such as timestamps, references, and digital signatures, in the integrity store 124. The integrity store 124 may be designed to support fast and efficient retrievals during integrity checks, enabling the multilayered distributed compute architecture 100 to quickly validate artifacts as they progress through different stages of the workload lifecycle. The integrity store 124 may be implemented as one or more resources (i.e., a single resource or a distribution of resources). The integrity store 124 may use various security measures to safeguard its contents, including encryption for data at rest and access control policies that limit retrieval and modification operations to authorized components of the system. Integrity digests within the integrity store 124 are immutable, ensuring that once a digest is created and countersigned, it cannot be altered without detection. During an integrity challenge, the integrity layer 114 may query the integrity store 124 to obtain the relevant digest, compute a fresh hash of the artifact in question, and perform a comparison to verify consistency. The integrity store 124 may also maintain a hierarchical or chain structure for integrity digests, allowing for recursive verification across multiple related artifacts, such as source code, compiled forms, and runtime dependencies. This architecture supports comprehensive integrity management by ensuring that each component of a distributed system remains verifiably secure and unaltered throughout its operational lifecycle.

In some embodiments, the integrity layer 114 may include a compute workload registry service for persisting, indexing, verifying, and serving compute workloads via an application programming interface (API). This service may utilize the integrity digest chain to maintain a comprehensive record of each compute workload's confidentiality, integrity, and availability throughout its lifecycle.

The verification process within the integrity layer 114 may involve a comprehensive integrity check at the point of workload execution or other points associated with any portion of the workload execution bundle. In instances in which the execution layer 112 receives a request to execute a compute workload, the execution layer 112 may initiate a verification request to the integrity layer 114, providing the current integrity digest of the compute workload. The integrity layer 114 may then retrieve the stored integrity digest, which was generated and recorded during the workload registration process, from the integrity store 124. Similarly, the execution layer 112 may initiate verification of a runtime-compiled language/framework in a runtime execution context.

The integrity layer 114 may perform a comparison between the newly provided digest and the stored digest. This comparison ensures that the compute workload has not been modified, corrupted, or tampered with since it was registered. In instances in which the digests match, the integrity layer signals approval to the control layer 110 and the execution layer 112, allowing the compute workload to proceed with execution. However, if the digests do not match, the integrity layer 114 blocks the execution request by sending a rejection command to the execution layer 112 via the integrity-execution connection 120. At the same time, the integrity layer 114 communicates with the control layer 110 via the control-integrity connection 122 to log the incident and trigger any necessary security responses, such as alerting administrators, isolating the compromised workload, or revoking further execution permissions for related tasks.

In embodiments in which multiple artifacts are involved (e.g., compiled binaries, runtime libraries, or sandbox environments), the integrity layer 114 may perform recursive challenges, verifying each component against its respective stored digest. Additionally, digital signatures may be verified to confirm that all compute workload components originate from trusted sources. The integrity layer 114 may also log the outcome of each verification step, creating an audit trail for future reference. This robust process may ensure that verified and unaltered workloads are executed, maintaining the confidentiality, integrity, and availability of the distributed computing environment.

The infrastructure layer 116 may serve as a hardware and resource management layer in the system architecture, providing the physical and virtual infrastructure needed to support the control layer 110, execution layer 112, and integrity layer 114. The infrastructure layer 116 may encompass a wide range of resources, including servers, storage systems, network devices, and cloud infrastructure components. The infrastructure layer 116 may operate independently from the system's other layers (e.g., 110, 112, 114), meaning it need not be actively managed or orchestrated by the multilayered distributed compute architecture 100 and particularly the control layer 110. Instead, the infrastructure layer 116 may maintain preferred functions such as resource provisioning, hardware-level security, and system health monitoring, which may be helpful for the proper operation of distributed workloads.

Communication between the infrastructure layer 116 and other layers 110, 112, 114 may occur through defined interfaces, allowing the multilayered distributed compute architecture 100 to query or request resource status without directly controlling underlying infrastructure operations. The control layer 110 may obtain information on available processing nodes, memory capacity, and network bandwidth from the infrastructure layer 116 to optimize workload orchestration and placement decisions. Similarly, the integrity layer 114 may access logs, telemetry data, and hardware-generated security features such as Trusted Platform Module (TPM) attestations to verify the integrity of physical resources. For example, a Kubernetes daemon and Kubernetes control plane may exist as infrastructure orchestration software installed in the infrastructure layer 116. Also, installed to that Kubernetes cluster is the system, which includes the control layer 110, execution layer 112, and integrity layer 114, having its own resource management, execution management, integrity management, etc. That system may communicate with the Kubernetes control plane through a Kubernetes operator in the control layer and coupled with the Kubernetes control plane. In turn, an operator may communicate with the Kubernetes control plane to allocate resources to execute a compute workload. In this way, there need not be an active control or integrity verification between the control layer and the underlying hardware infrastructure since the Kubernetes control plane stands as middleware between them.

The infrastructure layer 116 may also facilitate dynamic scaling and fault tolerance, automatically responding to events such as hardware failures or increased workload demand by allocating additional resources or redirecting traffic. The infrastructure layer 116 may achieve these functions through built-in resource management algorithms that may operate autonomously based on preconfigured policies or service agreements. This autonomy may enable the infrastructure layer 116 to maintain system stability and performance, while the other control layer 110, execution layer 112, and integrity layer 114 remain focused on workload execution, security, and coordination.

FIG. 2 illustrates a block diagram of a multilayered distributed compute architecture 200 according to various embodiments. The multilayered distributed compute architecture 200 includes the control layer 110, the execution layer 112, the integrity layer 114, as described above. Also, the multilayered distributed compute architecture 200 may additionally include a persistence layer 216, an infrastructure layer 218, and an interface layer 220. These additional persistence layer 216, infrastructure layer 218, and interface layer 220 may enhance the functionality and flexibility of the multilayered distributed compute architecture 200.

The control layer 110 may direct each of the persistence layer 216, infrastructure layer 218, and interface layer 220 and respond to monitored events and alerts generated by the persistence layer 216, infrastructure layer 218, and/or the interface layer 220. The control layer 110 may be configured to utilize the interface layer 220 to handle submissions from one or more external source(s), ensuring flexibility and interoperability within the distributed compute system. The interface implemented by the control layer 110 may serve multiple purposes. For example, the interface may provide a standardized entry point for workload submissions, allowing different types of sources to interact with the system in a consistent manner. This interface may support various protocols and data formats to accommodate different source requirements. Additionally, the interface may include its own validation mechanisms to ensure the integrity and compatibility of submitted workloads. This validation process may involve checking the format of the submission to ensure it adheres to predefined standards or schemas. It may also include content validation, which could involve verifying that the workload contains all necessary components, such as code, data references, and execution parameters. By implementing this type of interface, the control layer 110 can effectively manage the influx of compute workloads from diverse sources while maintaining system security and operational consistency. This approach allows the multilayered distributed compute architecture 100 to be flexible and extensible, capable of integrating with various external systems and accommodating different types of workloads and submission methods.

The integrity layer 114 may enforce encryption for communication and data exchanges within and among the control layer 110, the integrity layer 114, the execution layer 112, the persistence layer 216, the infrastructure layer 218, and the interface layer 220.

The persistence layer 216 may handle secure and verified data storage requirements of the multilayered distributed compute architecture 200, either temporarily or permanently. Stored data may include workload source code, workload machine code, workload metadata, execution metadata, execution state data, source data, intermediate data, output data, log data, audit data, and other data representations that may be referenced by, consumed by, produced by, or otherwise related to the system, and may be controlled and monitored by the control layer 110. The persistence layer 216 may communicate with the control layer 110 and the integrity layer 114 via a control-persistence connection 230 and an integrity-persistence connection 238 respectively. The persistence layer 216 may be responsible for managing and storing data across various operations. By connecting to the integrity layer 114 through the integrity-persistence connection 238, the persistence layer 216 may ensure that all data storage operations are not only secure but also verified for integrity. The integrity-persistence connection 238 also allows for continuous monitoring and validation of data as it is stored, retrieved, or modified within the system.

The persistence layer 216 may implement various data storage technologies and strategies to meet the diverse requirements of the distributed compute system. These may include relational databases for structured data, NoSQL databases for flexible and scalable data storage, or distributed file systems for handling large volumes of unstructured data. The choice of storage technology may depend on factors such as data type, access patterns, scalability needs, and performance requirements. By integrating closely with the integrity layer 114, the persistence layer 216 can enforce data integrity checks at the storage level. This may involve techniques such as encryption of data at rest, cryptographic hashing of stored data, maintaining audit trails of data modifications, and implementing versioning mechanisms to track changes over time. These measures mitigate against unauthorized alterations to stored data and provide a means to detect any tampering attempts.

The secure and verified data storage operations facilitated by the persistence layer 216 may maintain the overall integrity and trustworthiness of the multilayered distributed compute architecture 200. They ensure that workload data, system configurations, and execution results remain consistent and tamper-proof throughout the workload lifecycle. This is particularly useful in scenarios where the system handles sensitive or mission-critical data, as it provides an additional layer of protection against data corruption or malicious interference.

The infrastructure layer 218 may have a dedicated control-infrastructure connection 232 and an integrity-infrastructure connection 240. The infrastructure layer 218 may be controlled and/or monitored by the control layer 110. The infrastructure layer 218 may be included to manage the underlying hardware resources desired for system operation. The infrastructure layer 218 may communicate with the control layer 110 and the integrity layer 114 via the control-infrastructure connection 232 and the integrity-infrastructure connection 240 respectively.

The infrastructure layer 218 may manage the underlying hardware resources for system operation. The control-infrastructure connection 232 may facilitate communication between the infrastructure layer 218 and the control layer 110, allowing for efficient resource allocation and management based on workload requirements and system policies. Similarly, the integrity-infrastructure connection 240 may enable direct communication between the infrastructure layer 218 and the integrity layer 114, ensuring that hardware-level integrity checks and security measures can be implemented and verified. The control-infrastructure connection 232 and integrity-infrastructure connection 240 may allow the infrastructure layer 218 to provide real-time information about available resources, hardware health, and performance metrics to both the control layer 110 and integrity layer 114. This information is useful for making informed decisions about workload placement, resource scaling, and maintaining system integrity. For example, the control layer 110 can use data such as hardware utilization metrics from the infrastructure layer 218 to optimize workload distribution across available hardware resources, while the integrity layer 114 can leverage this connection to verify the integrity of hardware components and detect any potential security breaches at the infrastructure level.

The infrastructure layer 218 may encompass various hardware components such as servers, storage systems, networking equipment, and potentially cloud infrastructure in hybrid deployments. It may also include virtualization technologies that abstract physical resources into logical units for more flexible resource allocation. By maintaining these dedicated connections, the system ensures that resource management and integrity verification processes are tightly integrated with the underlying infrastructure, contributing to the overall security, efficiency, and reliability of the distributed compute system.

The interface layer 220 may facilitate interactions with external system(s) 222. For example, the external systems may include client applications, data sources, and third-party services. The interface layer 220 may interact with external data systems such as databases, data stores, data warehouses, streaming services, message busses, or sockets to retrieve or store data related to compute workloads. The interface layer 220 may interact with, make requests of, and/or respond to requests from the external system(s) 222, which interactions may be controlled and monitored by the control layer 110. The interface layer 220 may also communicate with cloud services or other distributed computing platforms to coordinate resource allocation and workload distribution. The interface layer 220 may connect to external system(s) 222 through one or more of various types of connection 242. The interface layer 220 may also communicate with the control layer 110 and the integrity layer 114 via a control-interface connection 226 and an integrity-interface connection 234 respectively.

The interface layer 220 serves as a useful component in the multilayered distributed compute architecture 200, acting as a bridge between the internal system components and external entities. The interface layer 220 is designed to handle a wide range of interactions, from simple data exchanges to complex resource coordination tasks. The external systems 222 that the interface layer 220 interacts with can be diverse in nature. Client applications may include user-facing software that submits compute workloads or retrieves results. Data sources could encompass various types of databases, data warehouses, or real-time data streams that provide input for workloads or store output data. Third-party services might involve specialized APIs, analytics platforms, model inference services such as Large Language Model (LLM) inference APIs, or other computational resources that augment the system's capabilities. When interacting with external data systems, the interface layer 220 may employ various protocols and query languages to efficiently retrieve or store data related to workloads. This could involve operations such as fetching input datasets, storing and retrieving intermediate results, or archiving final outputs of compute tasks. The communication of the interface layer 220 with cloud services or other distributed computing platforms is particularly useful in the context of resource allocation and workload distribution. This interaction may involve negotiating compute resources, orchestrating data transfers, or coordinating the execution of workloads across multiple environments. For instance, the interface layer 220 might communicate with one or more APIs from one or more cloud providers to dynamically provision additional compute nodes across cloud providers and geographies when the system experiences high demand.

The connections between the interface layer 220 and external systems 222 can take various forms depending on the specific requirements of each interaction. These might include RESTful APIs, GraphQL APIs, gRPC connections, WebSockets, message queues, or other protocols suitable for distributed systems communication. The choice of connection type would depend on factors such as data volume, latency requirements, bandwidth availability, and security considerations. Internally, the interface layer 220 may maintain connections with other core components of the system. The control-interface connection 226 allows the interface layer 220 to communicate with the control layer 110, enabling coordinated management of workloads from external sources. This connection might be used to relay compute workload submissions, resource requests, or status updates between external clients and the control layer 110. Similarly, the integrity-interface connection 234 facilitates communication between the interface layer 220 and the integrity layer 114. This connection plays a significant role in maintaining the confidentiality, integrity, and availability of the system's interactions with external entities. It may be used to verify the authenticity of incoming compute workloads, validate data sources, or ensure that outgoing results maintain their integrity before being transmitted to external systems (e.g., 222). By maintaining these connections and facilitating diverse interactions, the interface layer 220 may ensure that the multilayered distributed compute architecture 200 can seamlessly integrate with a wide array of external systems while maintaining the security, integrity, and efficiency of its internal operations.

In some embodiments, any one or more of the control layer 110, execution layer 112, integrity layer 114, persistence layer 216, infrastructure layer 218, and interface layer 220 may include memory and a processing system coupled to the memory. The processing system may be configured to execute instructions stored in the memory to implement the various layers and modules described above. The modular architecture of the multilayered distributed compute architecture 200 allows for flexible deployment across various computing environments, including cloud, on-premises, and hybrid infrastructures. By incorporating integrity verification at multiple levels and enforcing secure communication protocols, the system may provide enhanced security and efficiency for distributed computing workloads.

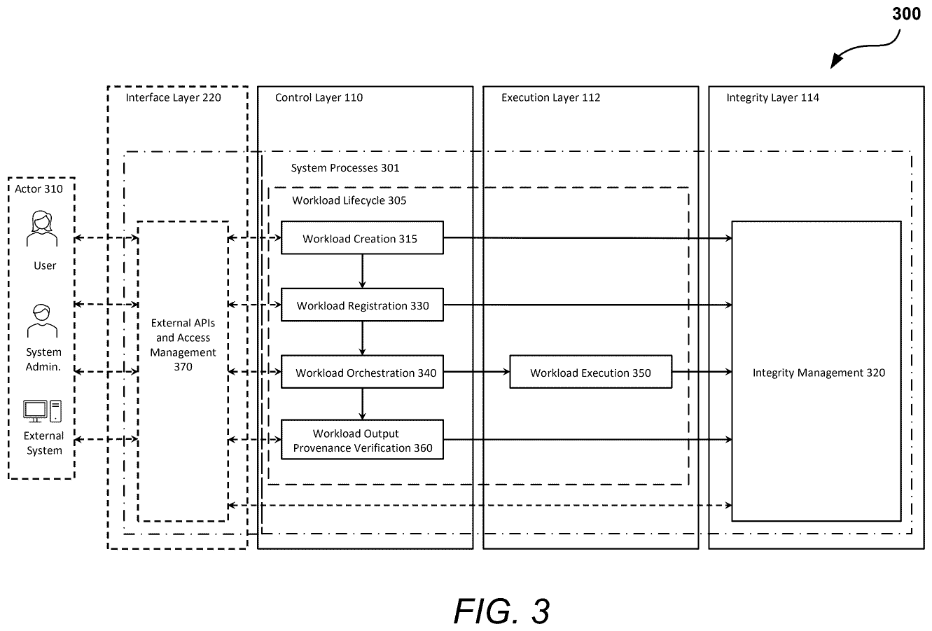

FIG. 3 illustrates a distributed compute system 300 between various system layers (e.g., control layer 110, execution layer 112, integrity layer 114, and optionally interface layer 220) and modules/processes therein that are part of a workload lifecycle 305 according to various embodiments. The system 300 includes the control layer 110, the execution layer 112, and the integrity layer 114. In addition, the system 300 may include the interface layer 220 for when an actor 310 that is external to the system interacts there with via the interface layer 220.

System processes 301 may operate within and across the system layers (e.g., 110, 112, 114, and optionally 220 if available for systems configured to interact with an external agent). The system processes 301 may include modules, such as workload lifecycle 305 and integrity management module 320. Also, if optionally configured to interact with an external agent, the system processes 301 may include one or more modules for handling external APIs and access management 370. System processes 301 are initiated by an agent, which may be an internal component or an external element, such as the actor 310 (e.g., a user, system administrator, or any external system (e.g., 222)).

The workload lifecycle 305, which is part of the system processes 301, includes a series of related modules including workload creation module 315, workload registration module 330, workload orchestration module 340, workload execution module 350, and workload output provenance verification module 360. That series of related modules is supported by at least one other part of the system processes 301; namely integrity management module 320 and, optionally, external APIs and access management 370.

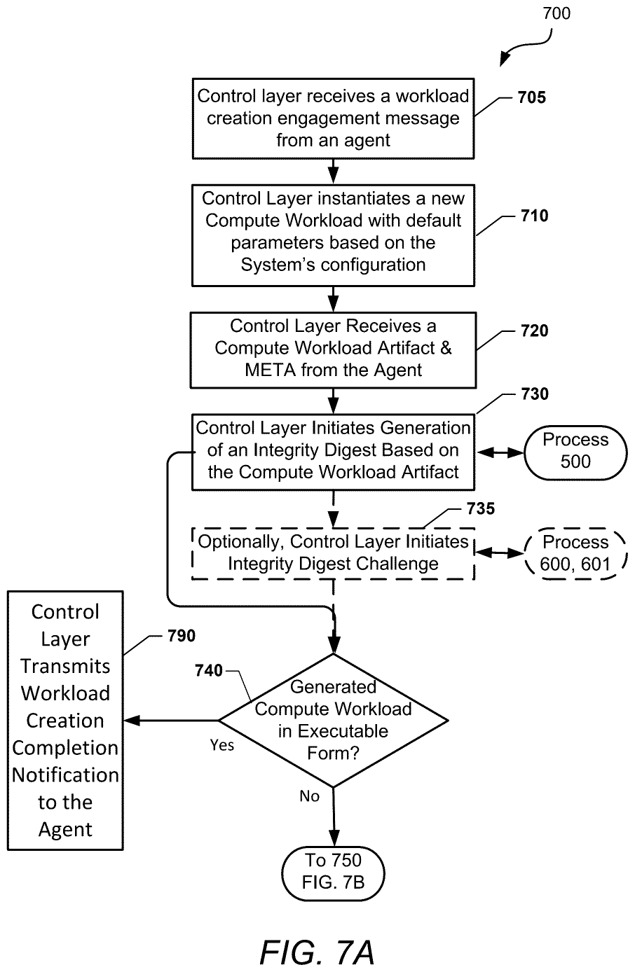

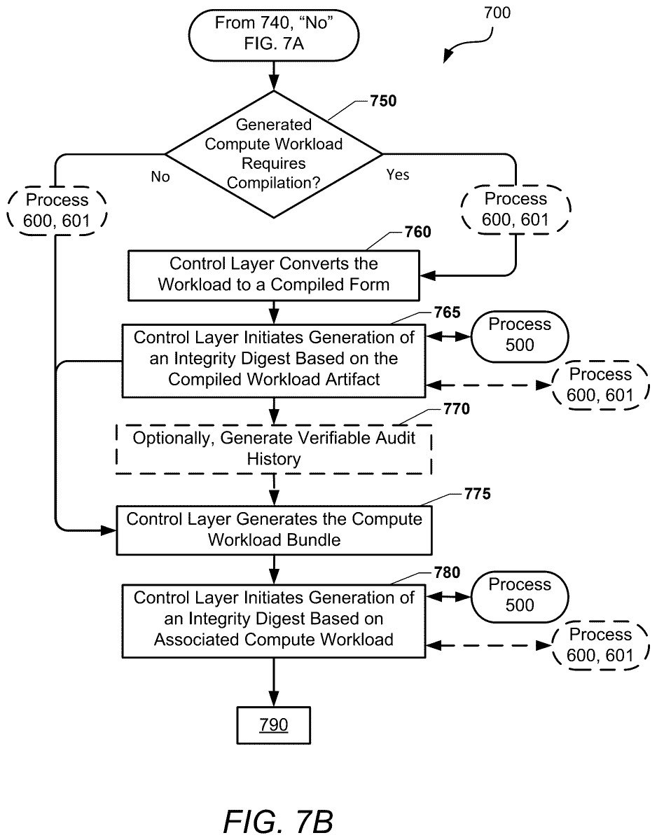

The workload creation module 315 may operate in response to a compute workload being initiated by an agent (e.g., an actor 310 or internal component) to create a new compute workload. The processes of workload creation module 315 are described further with regard to FIGS. 7A and 7B. The workload creation module 315 process may involve receiving the workload from the agent, generating an integrity digest, optionally storing the artifact and digest, determining if pre-compilation is needed, converting to compiled form if required, associating the workload with runtime components, generating an executable form, and notifying the agent of completion. This process ensures the workload is properly prepared and verified before moving to subsequent stages like registration or execution.

In conjunction with workload creation module 315, integrity management module 320, using an integrity management (IM) process, may create one or more integrity digests associated with the compute workload that has been initiated. The IM process will produce one or more integrity digests corresponding to agent-provided workload artifacts (e.g., source code, machine code, workload execution bundle, or the like) for use in subsequent processes in the workload lifecycle 305. The IM process generates one or more integrity digests for each workload artifact provided by the agent in initial and derivative forms. These artifacts may include source code, compiled machine code, or complete workload execution bundles.

The term, “integrity digest,” as used herein refers to a structured, cryptographically verifiable data set that provides a secure and tamper-evident representation of the integrity state of a digital artifact. Unlike a simple cryptographic hash, an integrity digest encapsulates not only the hash of the artifact but also a comprehensive set of metadata, security attributes, and relational references. At its core, it includes a secure cryptographic hash (such as SHA-256, SHA-3, Blake2, or MD5) of the artifact, ensuring that any alteration to the original content is immediately detectable. The integrity digest also contains metadata that describes the artifact and the digest itself-this can include information such as the artifact's type, version, author, and the hashing algorithm used. To ensure temporal accountability, a creation timestamp records when the digest was generated. A critical component of the integrity digest is its digital signature, which is applied by a trusted authority or signing service to validate the origin and authenticity of the digest. In some cases, a countersignature may be included, offering additional verification or endorsement by a second party. The integrity digest references the artifact it secures through a unique identifier or URI, allowing systems or users to locate or verify the corresponding data. Furthermore, an integrity digest may include associations to other digests, creating a web of trust and traceability among related artifacts-such as build inputs, dependencies, or downstream outputs. This relationship-building allows for deep inspection of provenance and supply chain integrity, supporting auditing, compliance, and reproducibility in secure environments. Overall, an integrity digest is used in artifact verification, authentication, and lifecycle management process, ensuring not only that digital content remains unchanged but also that its origin, relationships, and integrity state are transparently and verifiably recorded.

The integrity digest acts as a unique fingerprint for an artifact, allowing the system to detect any unauthorized modifications or tampering that may occur later in the workload lifecycle. The creation of multiple integrity digests for different aspects of a workload (e.g., source code, compiled code, and execution bundle) enables granular verification at various stages of processing. For instance, the system may separately verify the integrity of the original source code and the resulting compiled code. Those different integrity digests may be used by the system, among other things, to ensure that no unauthorized changes were introduced during the compilation process.

The control layer responds to various situations by implementing a comprehensive set of actions to maintain system integrity and security. In cases where the integrity digest challenge reveals a mismatch, indicating potential tampering or corruption, the control layer may immediately halt the orchestration process to prevent the execution of potentially compromised workloads. This proactive measure may be accompanied by logging a failure event, which may serve as a crucial record for administrative review and subsequent security analysis. The control layer may also initiate a series of predefined security protocols in response to such incidents. These protocols may include alerting system administrators through various channels, such as email notifications or dashboard alerts, to ensure prompt attention to the security concern. In some cases, the control layer may take more aggressive measures, such as isolating the compromised workload to prevent it from affecting other system components or data. This isolation may involve moving the workload to a quarantine area for further analysis or completely removing it from the active system environment. Additionally, the control layer may revoke execution permissions for tasks related to the compromised workload, effectively creating a security perimeter around the potential threat. Once the integrity layer communicates that a compute workload has successfully passed the integrity check, the control layer may proceed with releasing the workload to the execution layer for processing. This release may be accompanied by specific instructions or parameters to guide the execution process, ensuring that the workload is processed according to predefined security and performance criteria. Throughout these processes, the control layer may maintain constant communication with the integrity layer via the control-integrity connection, enabling real-time logging of incidents and triggering of necessary security responses. This ongoing dialogue between layers may allow for a dynamic and responsive security posture, adapting to emerging threats or anomalies as they are detected. The control layer may also play a crucial role in the workload registration process, facilitating the validation and tracking of workloads across different environments. This may involve implementing checkpoints at various stages of the workload lifecycle, from creation to execution, to ensure that the workload remains unchanged and trusted throughout its journey through the system. By orchestrating these diverse responses and maintaining vigilant oversight, the control layer may contribute significantly to the overall confidentiality, integrity, and availability of the distributed compute system.

These integrity digests become integral components of the workload's provenance chain, supporting subsequent processes such as workload registration, orchestration, and execution. During these later stages, the system can challenge the integrity of the workload by recomputing the digest and comparing it to the originally stored value. This continuous verification process helps maintain the trustworthiness and security of the distributed compute environment. By creating these integrity digests early in the workload lifecycle, the IM process establishes a foundation for secure and verifiable workload processing. This approach aligns with the system's overall goal of maintaining workload integrity from initial submission through final execution and output generation.

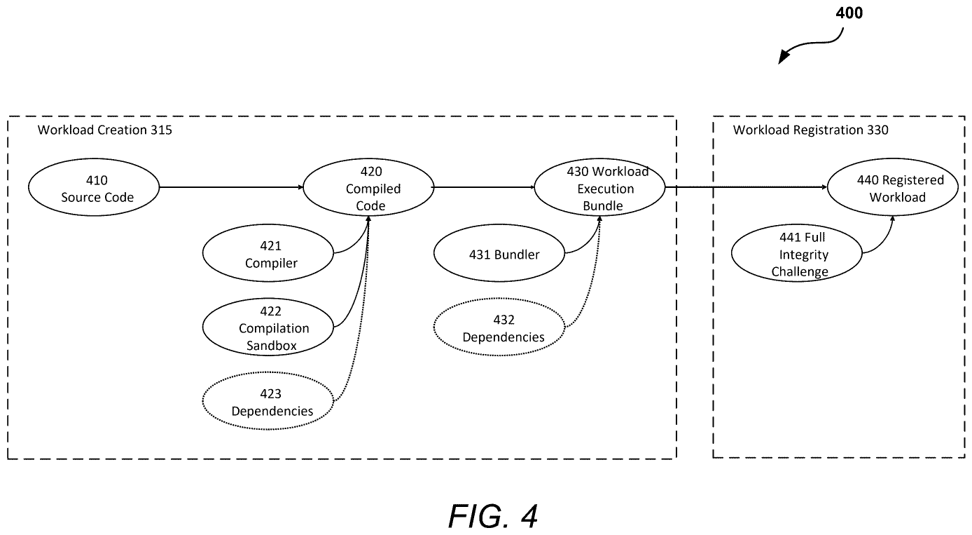

The integrity management module 320 handles processes within the integrity layer 114 (i.e., the IM process) and may be triggered by one of many possible preconfigured or event-driven conditions within the system 300 (e.g., an integrity digest creation event, an integrity digest challenge event, a workload initialization or execution event, a system audit). The IM processes are described further with regard to FIGS. 4, 5, 6, and 12.

In various embodiments, integrity management module 320 may be configured to produce a verifiable audit history of internal system events, which may also produce an integrity digest for the governing workload creation event trigger and any intermediate event triggers (e.g., source code compilation) to preserve this workload creation module 315 process event in the system. Depending on the form of the agent-provided workload artifacts, the system 300 may package the compute workload with requisite metadata into a workload execution bundle (e.g., a container, a virtual machine image, a virtual environment, or other complete representations that allow for downstream registration and execution). In some embodiments, the workload execution bundle may include multiple workloads in predecessor forms (e.g., source code form, compiled machine code form) collected with their metadata to execute together as one composite workload. In advanced integrity configurations requiring multi-party attribution and non-repudiation, the IM process will interact with an external actor 310 through the interface layer 220 for the actor to review and verify one or more of the integrity digests involved in the workload creation module 315 process. In such embodiments, the integrity layer 114 will block the workload lifecycle 305 from advancing to the next step or process until a third-party external actor 310 positively consents with the integrity layer 114 and authorizes the system to proceed.

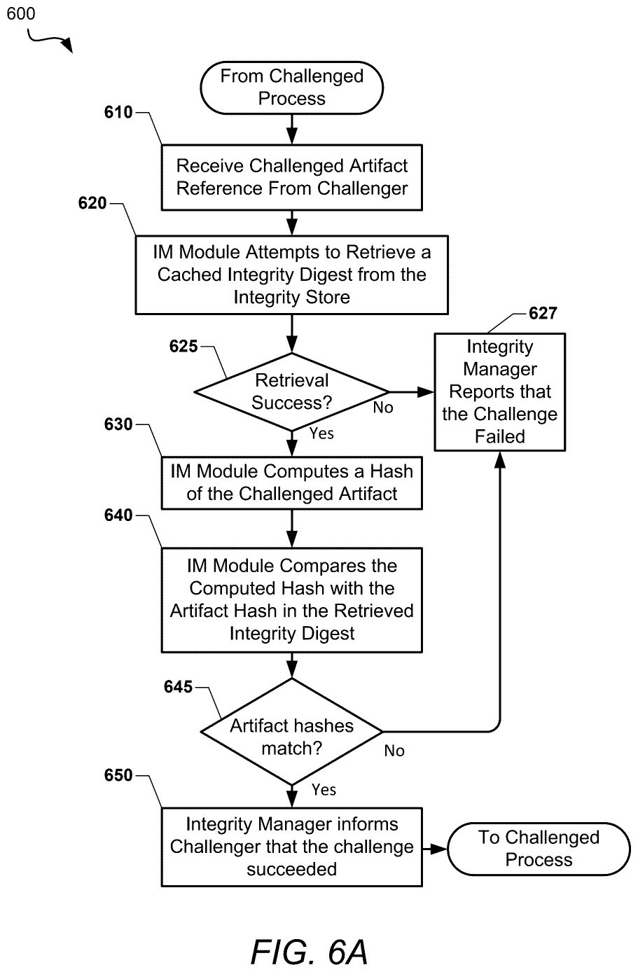

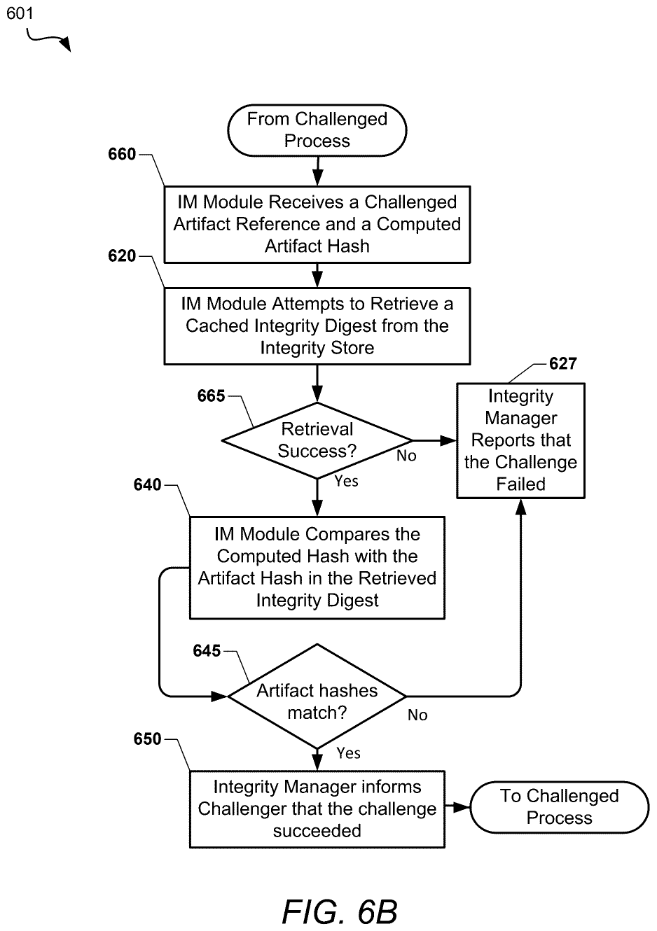

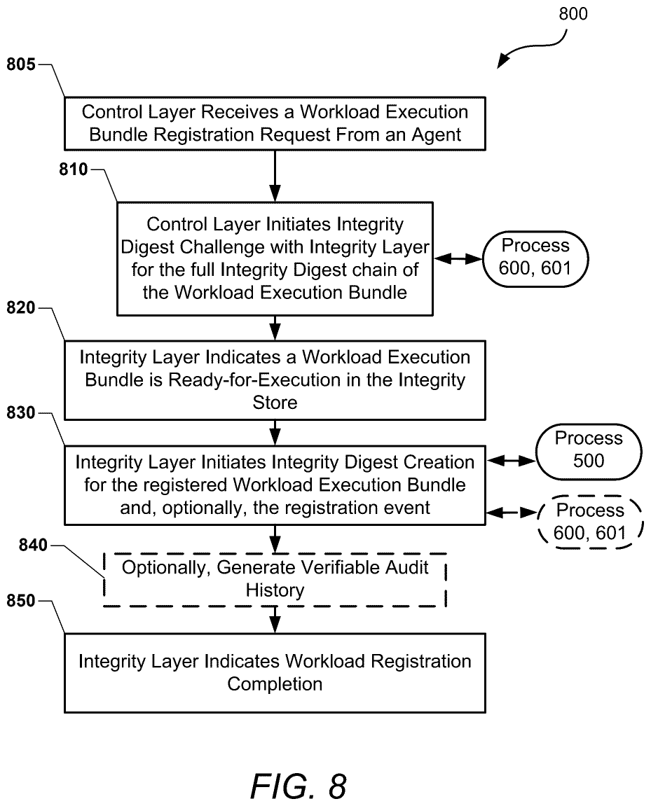

Following workload creation module 315, the workload lifecycle 305 proceeds to workload registration module 330, described in further detail with regard to FIG. 8. During workload registration module 330, the control layer 110 triggers the integrity layer 114 through the IM process to challenge the complete integrity digest chain for the workload execution bundle that is being registered. The process of integrity management module 320, regarding the verification of a challenge to an integrity digest are described further with regard to FIG. 6. If this challenge succeeds, the IM process may record in the integrity store (e.g., 124) that the relevant workload execution bundle is ready for execution and use by subsequent processes in the workload lifecycle 305. This may, for example, take the form of a new reference to the workload execution bundle with a “verified” label and a corresponding integrity digest creation, as indicated further with regard to FIG. 4. The complete integrity digest chain may then be preserved within the workload execution bundle in its persistence location, or a copy of the integrity digest chain may be preserved within the integrity store 124 for future retrieval and integrity digest chain verification during workload execution module 350 or by system audit that may involve an actor 310. If the system is configured to produce a verifiable audit history of internal system events, the IM process will also produce an integrity digest for the workload registration event trigger to preserve this workload registration module 330 process event in the system.

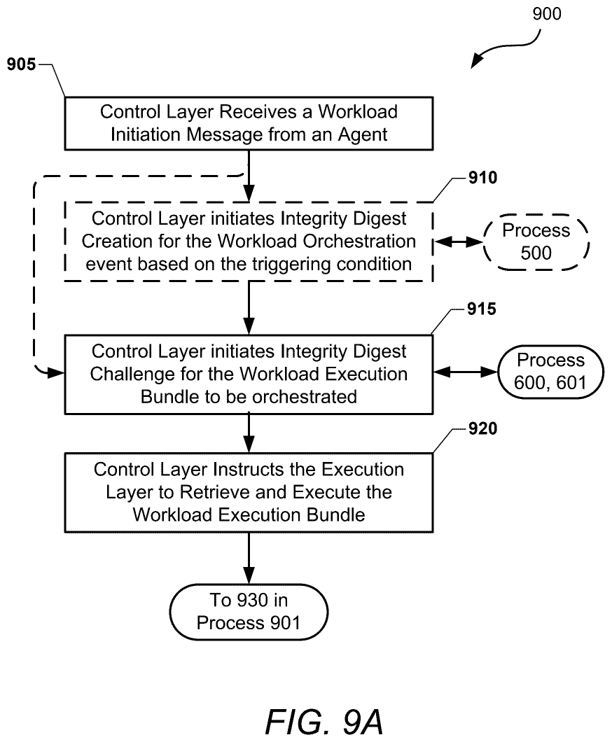

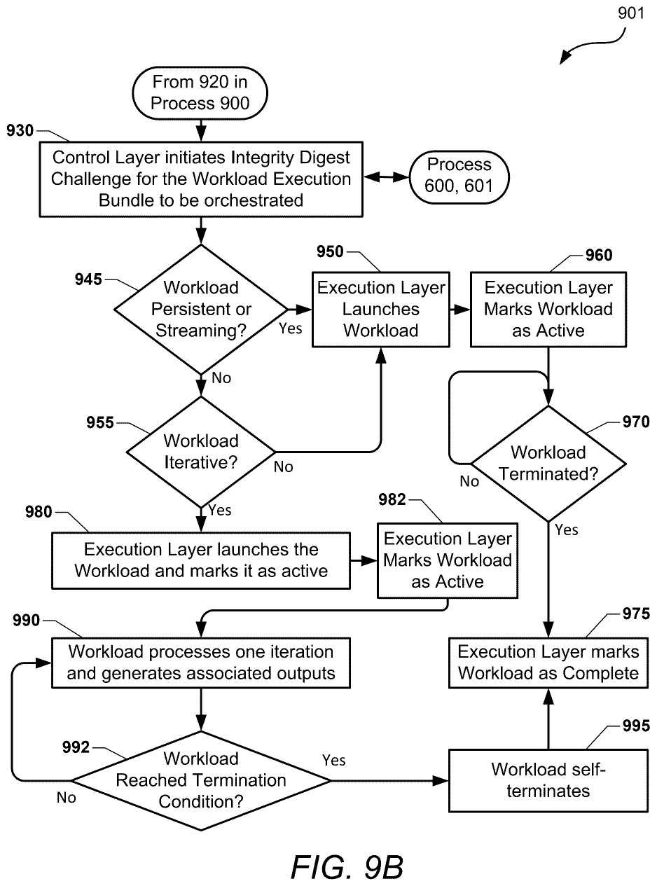

Following workload registration module 330, the workload lifecycle 305 proceeds to workload orchestration module 340 and workload execution module 350, as described with regard to FIG. 9. Under this flow, the workload orchestration module 340 process is first triggered by an agent (e.g., an internal system process or an external actor 310); the control layer 110 then engages the integrity layer 114 through the IM process to challenge the integrity digest of the workload execution bundle to be executed. In instances in which the challenge is successful, the control layer 110 instructs the execution layer 112 to perform the workload execution process (i.e., by the workload execution module 350) with the successfully challenged workload execution bundle on one or more processors. Each processor in the workload execution process may itself challenge the corresponding workload execution bundle to verify successful receipt of the workload execution bundle before beginning execution. In instances in which the system is configured to produce a verifiable audit history of internal system events, the control layer 110 and the execution layer 112 will also engage the IM process to produce integrity digests for the workload orchestration event trigger and workload execution event trigger, respectively, to preserve this workload orchestration process event and workload execution process event, respectively, in the system.

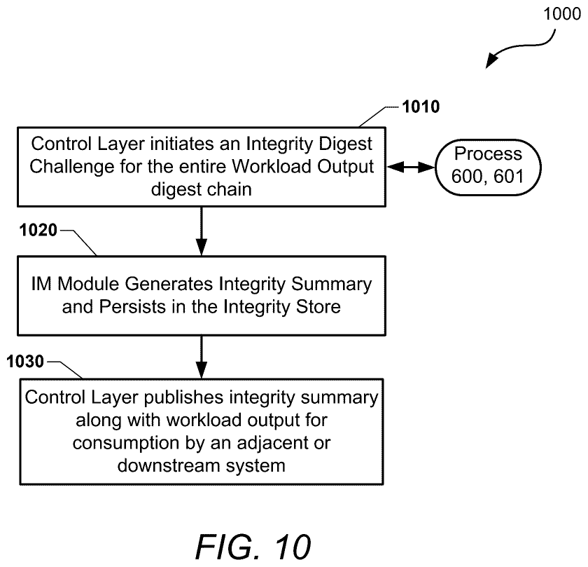

Following workload execution (i.e., by the workload execution module 350), the workload lifecycle 305 proceeds to the workload output provenance verification module 360 process, as described further with regard to FIG. 10. When the workload output provenance verification process is triggered, the control layer 110 engages the integrity layer 114 through the IM process to verify the entire integrity digest chain for the sequence of operations which produced a specific workload output. If the challenge is successful, the IM process generates a new, condensed integrity digest—the integrity summary—as a consolidated reference to the entire provenance tree. This integrity summary represents the complete chain of custody for the relevant workload outputs and provides a guarantee that the integrity of the system processes to produce the relevant workload output has been maintained. The integrity summary also functions as a sharable reference which an agent (e.g., an internal system component or external actor 310) can use to query the system for the complete integrity digest chain. The integrity summary is persisted within the integrity layer 114 for a future system audit and made available by the integrity layer 114 for downstream consumption.

The external APIs and access management 370 process may occur within the interface layer 220 and may be included along with the interface layer 220 when the system is configured to work with the actor 310 that will interact with the system 300 as part of the workload lifecycle 305.

The system processes 301 may include components for workload creation, workload registration, workload orchestration, workload execution, and workload output provenance verification. These components may interact with integrity management processes that verify and validate operations throughout the workload lifecycle.

The control layer 110 may play a central role in managing the workload lifecycle. In some embodiments, the control layer 110 may include instructions to cause the processing system to perform operations including receiving a compute workload from a source. This may initiate the workload creation process.

Following workload creation, the control layer 110 may initiate an integrity digest challenge with the integrity layer 114 for the compute workload. This challenge may help ensure the integrity and authenticity of the workload before further processing.

In instances in which the integrity digest challenge succeeds, the control layer 110 may orchestrate the compute workload within the execution layer 112 based on specified criteria. This orchestration may involve assigning the workload to appropriate resources within the execution layer 112. The control layer 110 may consider various factors when determining how to allocate resources for the compute workload. These factors may include the workload's computational requirements, such as processing power, memory usage, and storage needs. Additionally, the control layer 110 may take into account the current availability and utilization of resources within the execution layer 112 and the infrastructure layer 218, ensuring efficient distribution of workloads across available nodes.

The orchestration process may also involve breaking down complex workloads into smaller, manageable tasks that can be distributed across multiple execution nodes. This approach can enhance parallelism and improve overall system performance. The control layer 110 may use sophisticated algorithms to optimize resource allocation, considering factors such as load balancing, data locality, and network topology to minimize latency and maximize throughput.

Furthermore, the control layer 110 may apply any specified constraints or preferences associated with the workload. These could include requirements for specific hardware configurations, geographical restrictions for data processing, or prioritization based on the workload's importance or urgency. By considering these criteria during orchestration, the system can ensure that workloads are executed in compliance with organizational policies and performance objectives.

The orchestration process may also involve preparing the execution environment for the workload. This could include setting up necessary runtime dependencies, configuring security parameters, and establishing communication channels between distributed components of the workload. By handling these aspects during orchestration, the control layer 110 helps ensure that the execution layer 112 is fully prepared to run the workload efficiently and securely.

During workload execution, the control layer 110 may monitor execution of the compute workload within the execution layer 112. This monitoring may allow the control layer 110 to track progress, detect issues, and manage resource allocation.

Throughout the workload lifecycle, the control layer 110 may respond to monitored events and alerts generated by the control layer 110 itself, the execution layer 112, and the integrity layer 114. This responsiveness may enable dynamic management of workloads and system resources.

The execution layer 112 may be responsible for performing the actual computation tasks associated with the workload. In some embodiments, the execution module 214 within the execution layer 112 may handle the execution of compute workloads on system resources.

The integrity layer 114 may play a role in maintaining system security and workload integrity throughout the lifecycle. The integrity management module 320 within the integrity layer 114 may manage system-wide integrity verification processes, including the integrity digest challenges initiated by the control layer 110.

By orchestrating these system processes 301 and leveraging the interactions between different system components, the system may provide a secure and efficient environment for managing the entire lifecycle of compute workloads, from creation through execution to output verification.

FIG. 4 illustrates an example of a workload artifact sequence 400 which may be produced during the workload creation module 315 and workload registration module 330 processes in accordance with various embodiments. The workload artifact sequence 400 may be supported by an integrity digest chain that may provide a cryptographic record of the relationships between different artifacts and their corresponding integrity digest during workload creation and workload registration in accordance with various embodiments. The system may generate an integrity digest chain during workload creation and workload registration to maintain and verify the integrity of compute workloads throughout a workload lifecycle (e.g., 305). Table 1—Integrity Digest Chain (401), in Appendix A, illustrates an example of an integrity digest chain 401 that includes integrity digest data that may be generated by the integrity layer (e.g., 114) and/or stored in the integrity store (e.g., 124). This integrity digest chain 401 may provide a cryptographic record of the workload artifact sequence 400. Individual integrity digests may be immutable; as such, they may reference preceding integrity digests without modifying the preceding digests' contents. As the integrity layer creates and/or stores new integrity digests in the integrity store, these new integrity digests may extend a sequence of recorded integrity digests or branch the collection of recorded integrity digests in the integrity store at any point.

The workload creation module 315 may be responsible for generating at least part of the integrity digests throughout the workload lifecycle. The workload creation module may first create a source code integrity digest, which records a cryptographic fingerprint of the original source code 410 before compilation. After the source code 410 is compiled, the workload creation module 315 may generate a compiled code integrity digest, ensuring that the compiled workload is verifiable and traceable back to its original source. Once the compiled code 420 is packaged into an executable form as the workload execution bundle 430, the workload creation module may produce a workload execution bundle integrity digest, capturing the cryptographic fingerprint of the final workload package, including bundling and runtime dependencies. Meanwhile, the workload registration module 330 may take the workload execution bundle 430 and create the registered workload 440 and a corresponding registered workload integrity digest, which serves as the authoritative record of the verified workload. In this way, the workload registration module 330 may provide validation and tracking of the workload across different environments, ensuring that it remains unchanged and trusted from creation to execution.

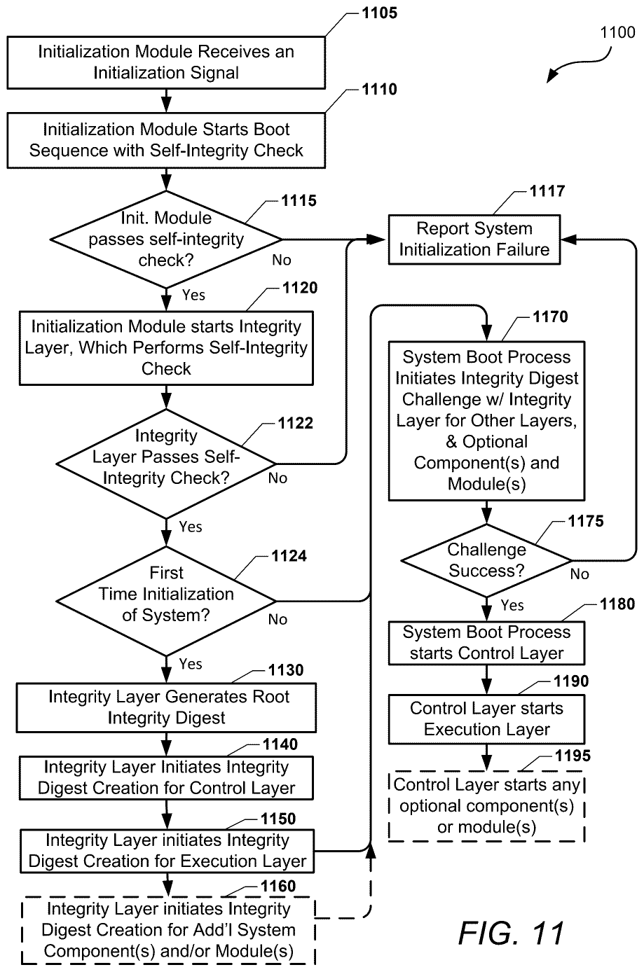

The integrity digest data maintained in an integrity digest chain 401 may be in the form of a data table with entries that include a digest reference field (“dig_ref”), a digest hash field (“dig_hash”), a signatory field (“signatory”), a signature field (“signature”), a countersignature field (“countersignature”), a timestamp field (“timestamp”), an artifact reference field (“artifact_ref”), an artifact hash field (“artifact_hash”), a metadata field (“metadata”), and a digest chain field (“chain”). The digest reference field may provide a unique identifier for each integrity digest chain entry. The digest hash field includes a hash of data from all remaining fields (collectively referred to as the integrity digest's “content”). The timestamp field may reflect when the integrity digest entry was created by the integrity layer. The signature field may be populated with a digital representation of a signature from the signatory. The countersignature field may be populated with a digital representation of a signature by the integrity layer. The signature and countersignature fields together may provide certification of authenticity and cryptographic non-repudiation for the signing and countersigning entities with respect to the contents of the integrity digest. The artifact reference field may contain a text string that points to an object that the integrity layer can access; this may be a file, a directory, a container image, a resolvable database or lookup table entry, an arbitrary data blob, etc. The artifact hash field may contain a computed, compressed representation of data located by the artifact reference. The artifact hash field may be computed with a hashing algorithm configured through a default setting, overridden by configuration during system initialization (e.g., see FIG. 11), or overridden at the time of artifact hash creation through a “hash_algorithm” parameter in the metadata field. The metadata field may be an optional serializable object containing additional relevant information for producing the Integrity Digest. For example, the metadata object may contain a “hash_algorithm” corresponding to the artifact hash which overrides the Integrity Layer's configured algorithm. The chain field may contain a list of other integrity digest entries or digest references that represent this integrity digest's linked predecessor(s). The integrity digest data may be recorded in the integrity store 124.

The example integrity digest chain 401 may begin with a digest entry for source code 410 (e.g., Table 1, first row). In some cases, the source code integrity digest may be created by the integrity layer (e.g., 114) when a compute workload in the form of source code 410 is first submitted to the system. In some cases, an actor (e.g., 310) may submit source code 410 to the control layer (e.g., 110) by directly uploading a bundle of source code files through the interface layer (e.g., 220). In some cases, an actor (e.g., 310) may submit source code 410 to the control layer by providing a reference to an external source code repository (e.g., a git repository location, branch, commit identifier, and optional authentication token). In some cases, the control layer may use a system initialization-time configured instruction to access the source code 410 that is a workload representation from a persistence location such as a file system or database. In doing so the integrity layer (e.g., 114) may compute a hash of the source code 410 and store this hash with additional integrity digest data as a complete source code integrity digest in the integrity store (e.g., 124).

The initial entry in the example integrity digest chain 401 represents the integrity digest for the source code 410, which has a digest reference of “DIGREF0”, signed by “actor0” and countersigned by the integrity layer (e.g., 114). This source code integrity digest corresponds to a cryptographic record of the source code 410 submitted at the beginning of the workload creation module 315. In this case, the artifact reference refers to a zip file containing the source code form of a compute workload, located at “file://path/to/source.zip.” This artifact may have been supplied by an agent (e.g., Actor 310), herein labeled “actor0” based on the integrity digest signatory. Since the artifact is in source code form, the workload creation module 315 (e.g., described above with reference to FIG. 3 and further below with reference to FIGS. 7A and 7B) compiled the source code before incorporation into a workload execution bundle. For the source code integrity digest represented in the integrity digest chain 401, there are no predecessor entries in its digest chain and thus the corresponding “chain” field is empty.

Another entry in the example integrity digest chain 401 represents the compiled code integrity digest, which corresponds to a cryptographic record of the compiled code 420 of the compute workload produced within the workload creation module 315. The entry of the compiled code integrity digest has a new digest reference of “DIGREF1,” still signed by “actor0” and countersigned by the integrity layer In this case, the artifact reference refers to a compiled binary file located at “file://path/to/compiled.bin,” with the corresponding artifact hash beginning “6970fb.” Since a compiled binary file is a derivative representation produced by the workload creation process, the “chain” field for this digest includes “DIGREF0” (the digest for the source code in the preceding integrity digest), as well as references for integrity digests for the compiler 421, compilation sandbox 422, and the optional zip file of compilation dependencies 423 used by the system to produce the compiled form of the workload. While the System does not strictly require an exhaustive set of predecessor integrity digest entries to be included in each integrity digest's chain, the verifiable integrity of the system and of individual compute workloads may be improved with each additional reference to a predecessor entry in the integrity digest chain 401.

The third row in the example integrity digest chain 401 represents the compiler integrity digest, which contains a cryptographic record of the compiler 421 used to transform the source code 410 into compiled code 420 and may uniquely identify the compiler 421 used during the compilation process. This may ensure that the compiled code 420 originates from a specific, verified compiler version and mitigates risks associated with compiler tampering or inconsistencies. This digest typically includes metadata such as the compiler name (e.g., GCC, Clang, MSVC), its version, a cryptographic hash of the compiler binary, and build options or flags used in the compilation process. By associating this compiler integrity digest with the compiled code integrity digest, users can verify that the code was built using an authorized compiler 421.

The fourth row in the example integrity digest chain 401 represents the compilation sandbox integrity digest, which provides a cryptographic record of the compilation sandbox 422 environment in which the compilation process occurred. This digest may ensure that compilation was performed within a reproducible, isolated, and tamper-resistant environment, preventing discrepancies caused by variations in system configurations. The compilation sandbox digest may include system configuration details such as the operating system version and kernel version, environment variables, hashes of container or virtual machine snapshots, and any security policies applied during compilation. Associating this compilation sandbox 422 integrity digest with the compiled code 420 integrity digest allows developers and auditors to confirm that the compiled workload was built under controlled and verifiable conditions.

The fifth row in the example integrity digest chain 401 represents the dependencies integrity digest, which provides a cryptographic record for all external dependencies, libraries, and supporting files that were used in the compilation process. This digest may ensure that all dependencies 423 are accounted for, trusted, and verifiable, preventing inconsistencies that may arise from missing or altered dependencies. It may include cryptographic hashes of linked libraries, versions of third-party packages obtained from package managers like npm, pip, or Maven, system-level shared libraries, and configuration files that influenced the compilation process. By linking this integrity digest for dependencies 423 to the integrity digest of the compiled code 420, developers and auditors can ensure that the same set of dependencies was used for consistent and reproducible builds.

These supporting integrity digests (compiler digest, compilation sandbox digest, dependencies digest) are cryptographically associated with the integrity digest for the compiled code 420 and corresponding compiled code 420 itself through various methods. One approach involves embedding references to the supporting digests within structured metadata formats such as JSON or XML. For example, a metadata file might list the compiled code digest along with digest references or hashes for the compiler digest, sandbox digest, and dependencies digest. Another method uses a Merkle tree structure, where each of the supporting digests serves as a leaf node, contributing to a single root hash in the compiled code integrity digest. This ensures that any modification to the compilation process invalidates the compiled code integrity digest, preserving integrity. Additionally, digital signatures and attestations can be used to establish authenticity and verification.

By incorporating these supporting integrity digests (compiler digest, compilation sandbox digest, dependencies digest) into the compiled code integrity digest, the system ensures that the compiled workload is not only verifiable but also reproducible, reducing risks associated with unauthorized modifications, compiler inconsistencies, and dependency mismatches. This approach strengthens trust in the compilation process, ensuring that the final executable is built from a known and verified source under well-defined conditions.

After compilation, the example integrity digest chain 401 may include another entry for the integrity digest of a workload execution bundle 430. The workload execution bundle digest may provide a cryptographic record of the executable form of the compute workload after it has been fully packaged for deployment as a workload execution bundle 430. In Table 1, the integrity digest of the workload execution bundle 430 has a reference of “DIGREF5”, signed by “actor0” and countersigned by the integrity layer. The workload execution bundle digest may correspond to the derivative workload execution bundle 430 produced at the end of the workload creation (e.g., 315) process. This artifact reference may refer to a workload image (in this case, a container image) that is located at “https://dev-registry.local/workload:1.0,” with the corresponding artifact hash beginning “5a85af.” Since “actor0” initiated the workload creation process that ultimately produced this image in this example, “actor0” is the signatory. As a derivate representation produced by the workload creation process, the chain for this digest includes “DIGREF1” (the digest reference for the compiled code digest), as well as digest references for the bundler digest and the optional runtime dependencies digest.

The workload execution bundle digest may ensure that the final workload bundle is verifiable and has not been tampered with after compilation. To provide further integrity verification, the workload bundle digest may be supported by additional digests, including the bundler digest and the runtime dependencies digest.

The bundler integrity digest may provide a cryptographic record for the tools, scripts, or processes (collectively, the bundler 431) used to package the compiled code into an executable bundle. This digest may ensure that the final packaged workload (e.g., the workload execution bundle 430) is created using an authorized and verifiable bundling process, reducing the risk of unauthorized modifications or compromised packaging tools. The bundler digest may include a cryptographic hash of the bundling tool binaries, metadata about the packaging process, the versions of tools used, and the configurations applied during bundling. This information guarantees that the workload was packaged consistently and in accordance with predefined security and reproducibility standards.

The runtime dependencies integrity digest may provide a cryptographic record to verify the integrity of any additional resources and dependencies 432 required during execution of the compute workload. While the compilation dependencies digest may record which dependencies are included during compilation, the runtime dependencies digest focuses on verifying the correctness and authenticity of external libraries, configuration files, environment settings, and dynamically loaded resources that the workload relies on when it runs within the execution layer (e.g., 112). This digest may contain cryptographic hashes of shared libraries, operating system dependencies, dynamically linked modules, and any external data files required for execution. By maintaining a record of these resources, the digest ensures that only authorized and unaltered components are used during runtime.

The association of these additional integrity digests with the workload execution bundle digest is achieved through structured cryptographic linkage. One common approach is embedding references to the bundler digest and runtime dependencies digest within a structured metadata file, such as a JSON or XML manifest, where each supporting digest is recorded alongside the workload execution bundle digest for verification purposes. Another method involves a Merkle tree structure, where the bundler digest and runtime dependencies digest serve as leaf nodes that contribute to a single root hash, ensuring that any modification to the bundle invalidates the overall digest. Additionally, digital signatures and attestations can be applied to establish trust, where the workload bundle digest is signed by an authoritative source, and the supporting digests are included in a cryptographic proof that guarantees the authenticity of the entire workload execution bundle.

By incorporating the bundler digest and dependencies digest into the workload execution bundle digest, the system may ensure that the executable form of the compute workload remains verifiable, reproducible, and protected from unauthorized modifications. This structured integrity verification process provides confidence that the workload bundle is correctly assembled, securely packaged, and executed in a trusted environment with the expected dependencies and runtime conditions.

Another entry in the example integrity digest chain 401 represents the integrity digest for the registered workload 440, which is referenced in Table 1 as “DIGREF8.” This registered workload digest is signed by “actor0” and countersigned by the integrity layer. The registered workload digest may correspond to a new registered workload 440 artifact, which itself is a product of applying the workload registration process (i.e., by the workload registration module 330) to the workload execution bundle 430 that was produced during the workload creation process (i.e., by the workload creation module 315). During the workload registration process, the preceding workload execution bundle 430 may undergo a full challenge of its integrity digest. If the challenge succeeds, the registered workload 440 may be produced. As a result, the “chain” field for the registered workload 440 contains data corresponding to the workload execution bundle 430 along with a digest entry representing a full integrity challenge 441. This challenge is produced by the IM process and references the result of the registration event challenge for “workload:1.0,” which is associated with “DIGREF 5” in the integrity store.

The presence of the verified, integrity digest for the workload execution bundle 430 and the registered workload 440 itself inherently confirms that the full integrity challenge 441 was successfully completed. Because of this, the full integrity challenge 441 could technically be omitted from the “chain” field of the registered workload integrity digest without compromising its validity. However, it is included in this instance for transparency and completeness, ensuring a more comprehensive representation of the verification process. Consistent with FIGS. 3 and 8, the artifact reference for the registered workload 440 provides a distinct path to locate the verified workload execution bundle 430—in this case, a container image—separate from the original path of the workload execution bundle 430 referenced in the workload execution bundle integrity digest. This does not necessarily indicate that the workload execution bundle itself has changed but rather that a new unique reference or tag has been assigned to it. This distinction serves as an example of how the workload registration module 330 signals that the workload has been verified and is officially marked as “ready for execution” in the integrity store.

The full integrity challenge 441 and corresponding full integrity challenge event integrity digest may play a role in verifying the integrity of the registration process for a compute workload. Once the registered workload digest is created to represent the compute workload after it has been verified and registered within the system, the integrity challenge digest provides an additional layer of security by ensuring that the registration process itself was conducted properly and without tampering. This digest is generated by subjecting the registered workload to a cryptographic integrity challenge, which may involve hashing specific workload components, executing verification checks, or comparing the workload's recorded metadata against the expected values. It ensures that the registered workload matches the originally compiled and packaged workload, preventing unauthorized modifications or inconsistencies during the registration process.

The integrity digest for the full integrity challenge 441 may be directly associated with the registered workload digest through structured cryptographic linkage. One way this association can be implemented is by embedding the full integrity challenge digest within a metadata record accompanying the registered workload digest, ensuring that the verification results are permanently recorded alongside the workload's registration data. Another approach involves incorporating the challenge digest into a Merkle tree structure, where it serves as a verification node contributing to the final registered workload digest. Additionally, digital attestations or signatures can be applied, linking the integrity challenge digest to the registered workload digest as part of a verifiable proof that the workload has undergone and passed integrity validation. By integrating the integrity challenge event digest, the system ensures that the registered workload remains a trusted and verifiable representation of the compute workload, reinforcing confidence in its authenticity, security, and compliance with the integrity verification process.

Note that, in any given integrity digest chain (e.g., 401), predecessor integrity digest entries need not have the same signatory as successor integrity digest entries for their inclusion in the chain to be valid. The individual integrity digests entries may be referenced by multiple integrity digests chains. For example, a third-party digital certificate and its corresponding integrity digest entry could be included in a chain for a source code bundle, the compiled form of the source code, and the workload execution bundle 430 incorporating that compiled form in an embodiment where the workload creation module 315 process may be extended to include a “code signing” step for added confidentiality, integrity, and availability guarantees.

The integrity layer (e.g., 114) may create each of these integrity digests by computing a hash of the corresponding compute workload artifact and storing this artifact hash with additional integrity digest data in the integrity store (e.g., 124). This process may occur prior to any integrity digest challenges performed by the system. An integrity digest chain may allow the control layer (e.g., 110), execution layer (e.g., 112), and integrity layer (e.g., 114) to verify the integrity of a compute workload at any stage of its lifecycle. For example, before the execution layer (e.g., 112) begins processing a compute workload, the integrity layer may perform an integrity digest challenge by comparing the current hash of the workload against the stored hash in the relevant integrity digest. By maintaining a repository of integrity digests and integrity digest chains, the system may provide a robust mechanism for ensuring the security and integrity of compute workloads from their initial creation through compilation, bundling, registration, and execution.

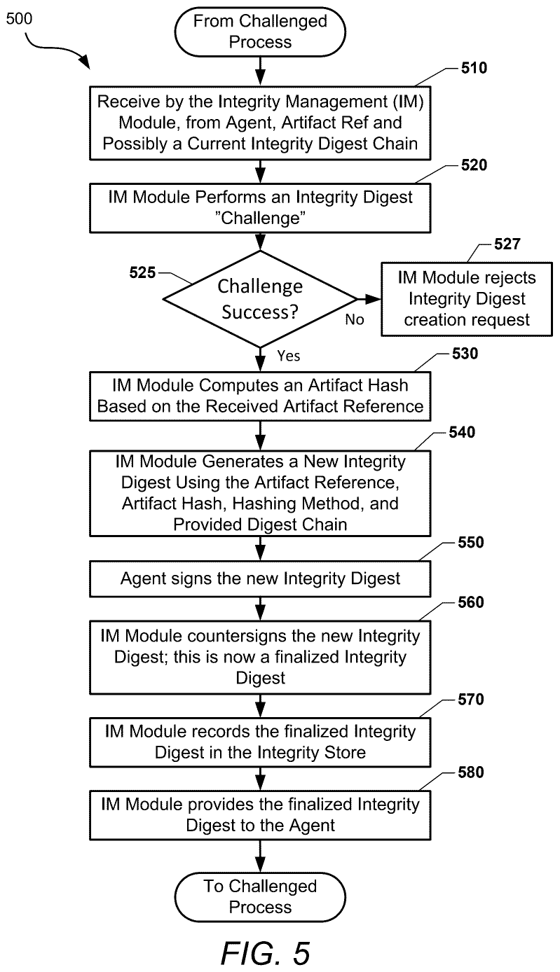

In some embodiments, the system may include an integrity digest creation process for generating and storing integrity digests associated with compute workloads and system components. FIG. 5 illustrates a flowchart for an integrity digest creation process 500.

The integrity digest creation process 500 may involve various elements within the system to ensure comprehensive security and verification. The control layer (e.g., 110) may initiate the process by requesting the creation of an integrity digest for a specific compute workload or system component. This request may be triggered by events such as the introduction of a new workload, modifications to existing components, or scheduled integrity checks. The integrity layer (e.g., 114) may play a central role in the digest creation process. It may receive the request from the control layer and coordinate the necessary operations. The integrity layer, using the integrity management (IM) module (e.g., 320) may be responsible for computing the cryptographic hash of the target artifact, for generating signatures for the signatory and the integrity layer, for producing the digest hash, and for interacting with the integrity store (e.g., 124) to record the created integrity digest(s). The IM module may utilize various hashing algorithms, such as SHA-256, SHA-3, Blake2, or MD5, depending on the system configuration or specific security requirements of the workload. The integrity store may be involved in persisting the newly created integrity digests. It may provide a secure storage mechanism for maintaining the integrity digests throughout the workload lifecycle. The integrity store may also be queried during the process to check for existing digests or to retrieve related digest chains. The execution layer (e.g., 112) may participate in the digest creation process by providing runtime information about the workload or system component. This may include details about the execution environment, runtime dependencies, or dynamic configurations that need to be captured in the integrity digest. In some cases, the persistence layer (e.g., 216) may be involved in storing additional metadata associated with the integrity digest. This could include timestamps, version information, or references to related artifacts that provide context for the digest.

The interface layer (e.g., 220) may facilitate communication between external systems (e.g., 222) or actors (e.g., 310) and the integrity digest creation process. It may allow for the submission of artifacts for digest creation or the retrieval of created digests for verification purposes. The infrastructure layer (e.g., 218) may provide the underlying computational resources necessary for performing cryptographic operations involved in digest creation. This may include specialized hardware for accelerated hashing or secure enclaves for sensitive operations. In some implementations, the system may incorporate a dedicated cryptographic module that works in conjunction with the integrity layer to perform the actual digest computations. This module may implement various cryptographic primitives and protocols to ensure the security and efficiency of the digest creation process. The module(s) handling external APIs and access management 370 may be involved in enforcing access controls during the digest creation process. It may ensure that only authorized entities can initiate digest creation or access sensitive information related to the process. In more advanced configurations, the system may employ a distributed consensus mechanism to validate and agree upon the created integrity digests across multiple nodes. This may involve elements such as blockchain-inspired technologies or distributed ledger systems to enhance the trustworthiness and immutability of the created digests. By involving these various elements, the integrity digest creation process may provide a robust and flexible mechanism for generating verifiable representations of compute workloads and system components throughout their lifecycle in the distributed compute environment.

The integrity digest creation process 500 may begin in block 510 in response to the integrity management (IM) module (e.g., 320) of the integrity layer (e.g., 114) receiving from an agent an artifact reference and potentially an existing integrity digest chain (if available). The integrity digest creation process 500 may be initiated when an agent, which could be an internal system component or an external entity authorized to interact with the system, provides at least an artifact reference and potentially an existing integrity digest chain to the IM process. The artifact reference serves as a unique identifier for a specific compute artifact within the system. The specific compute artifact may be any discrete unit of data or code that needs to be verified, such as a source code file, a compiled binary, or a complete workload execution bundle. The artifact reference allows the system to locate and access the specific item that requires integrity verification. The provided integrity digest chain, if provided, represents the historical record of integrity verifications for the artifact or its predecessors, such as digests that may exist for preceding source code, a compiler, or optional dependencies. This integrity digest chain may not always be present, particularly for newly created artifacts or those being introduced to the system for the first time. The integrity digest chain may be used to maintain a continuous record of an artifact's integrity throughout its lifecycle. Each link in this chain represents a previous integrity verification, creating a traceable history of the artifact's state and transformations over time. This chain may enable the system to detect any unauthorized modifications or tampering that may have occurred between integrity checks. By accepting both the artifact reference and the optional integrity digest chain, the IM process sets the stage for a comprehensive integrity verification. This approach allows the system to not only verify the current state of the artifact but also to validate its provenance, ensuring that the artifact's integrity has been maintained throughout its existence within the system.

In block 520, in response to receiving the artifact reference, and possibly the existing integrity digest chain from the agent, the IM module may perform an integrity digest challenge against the provided integrity digest chain (if one is provided). Further details regarding the process of the integrity digest challenge are described below with regard to FIGS. 6A and 6B. If the provided integrity digest chain is authenticated, the integrity digest challenge will be considered successful. Also, even if no integrity digest chain is provided (e.g., when no integrity digest is available or presented by the agent to the IM process), the integrity digest challenge can be configured to return success or failure by default. However, if the provided integrity digest chain fails to be authenticated, the integrity digest challenge will be considered unsuccessful (i.e., a failure).

In determination block 525, the IM module may determine whether the integrity digest challenge was successful. In response to the IM process determining that the integrity digest challenge was successful (i.e., determination block 525=“Yes”), the IM process will compute an artifact hash in block 530. In response to the IM process determining that the integrity digest challenge failed (i.e., determination block 525=“No”), the IM process will transmit a rejection message to the agent that sent the artifact reference in block 527. This rejection may occur because any provided integrity digest(s) would become part of the chain for the new integrity digest created under this process, and the integrity manager enforces that integrity digests must be valid at the time of creation.

In block 530, the IM module computes an artifact hash based on the artifact reference received in block 510. This computation generates a unique cryptographic representation of the artifact. The artifact hash is typically created using a secure hashing algorithm, such as SHA-256, SHA-3, Blake2, or MD5, which takes the content of the artifact as input and produces a fixed-size output string. This hash serves as a digital fingerprint of the artifact, allowing for quick and efficient integrity verification in subsequent operations. The choice of hashing algorithm may be determined by system configuration or specified in the metadata of the artifact reference. By computing the hash at this stage, the IM process establishes a baseline for future integrity checks, enabling the system to detect any unauthorized modifications to the artifact throughout its lifecycle in the distributed compute environment.

In block 540, the IM process generates a new integrity digest that includes the received artifact reference, the corresponding computed artifact hash, hashing method (optionally included, as described with regard to FIG. 4), the received integrity digest chain (which, if provided, was authenticated in block 520), and a timestamp of this integrity digest creation event. The generation of a new integrity digest in block 540 encapsulates several pieces of information that collectively ensure the authenticity and traceability of the artifact throughout its lifecycle in the distributed compute system. The artifact reference included in the digest serves as a unique identifier for the artifact within the system, allowing for easy retrieval and verification in future operations. The computed artifact hash, generated in block 530, provides a cryptographic representation of the artifact's content, enabling quick integrity checks without the need to access the full artifact data. The optional inclusion of the hashing method (described with reference to FIG. 4) adds an extra layer of flexibility to the system. By specifying the hashing algorithm used, the system can accommodate different security requirements or adapt to new cryptographic standards over time without compromising backward compatibility.

The authenticated integrity digest chain, if provided and verified in block 520, may establish a link between the new digest and previous related digests. This chain of trust allows for the tracking of an artifact's provenance and any transformations it may have undergone, which is particularly valuable in complex distributed systems where artifacts may evolve through multiple stages of processing. The timestamp included in the new digest serves as a temporal anchor, providing a precise record of when the digest was created. This information is used for auditing purposes and can help in detecting potential time-based attacks or inconsistencies in the system. By combining these elements into a single integrity digest, the IM process creates a comprehensive and verifiable record of the artifact's state at a specific point in time. This digest becomes a building block in maintaining the overall integrity and security of the distributed compute system, enabling robust verification processes throughout the artifact's lifecycle.

In block 550, as the initiator of this integrity digest creation event, the agent signs the new integrity digest as the signatory. If the IM process is performing compilation, the IM process may sign directly. If another agent is performing the compilation, they will sign either through the interface layer or provide signature at the time of submission. In some configurations, the agent signature step can be applied by the integrity manager with the agent's signature data stored in the integrity layer. In advanced security configurations as referenced in FIG. 3, this agent signature step may require that the integrity manager provide the in-progress integrity digest to an actor (which may be the agent) for multi-party verification that the integrity digest is valid at the time of creation.

In block 560, the IM process countersigns the new integrity digest and the new integrity digest is now considered “finalized”, implying that no further data will be appended or modifications applied. This finalization step may signify the completion of the digest and ensures its immutability. Once finalized, no further data should be appended or modifications applied to the integrity digest. The countersignature by the IM process serves multiple purposes. First, it provides an additional layer of verification, confirming that the integrity digest has been processed and approved by the system's integrity management component. This dual-signature approach (with the agent's signature from the previous step and the IM's countersignature) enhances the overall security and trustworthiness of the integrity digest, providing digital mechanisms which may ensure authenticity and cryptographic non-repudiation of the content in the created integrity digest. Secondly, the finalization prevents any unauthorized alterations to the digest after its creation. This immutability maintains a reliable chain of trust throughout the workload lifecycle. It ensures that when the integrity digest is later used for verification purposes, such as during workload orchestration or execution, its contents remain exactly as they were at the time of creation. The finalized state of the integrity digest also facilitates efficient storage and retrieval operations. Since no further modifications are permitted, the system can optimize its storage mechanisms and indexing strategies, knowing that the digest's content will remain constant. In the context of the broader IM process, this finalization step marks the end of the digest creation phase and prepares the digest for its role in subsequent system operations, such as integrity challenges, workload verifications, and audit trail maintenance.

In block 570, the IM process records the finalized integrity digest in the integrity store. This recordation provides a comprehensive and verifiable record of this and other integrity-related information within the system. The integrity store serves as a centralized repository for all integrity digests, allowing for efficient retrieval and verification in subsequent operations. By recording the finalized integrity digest, the system ensures that a tamper-evident record of the artifact's state at this specific point in time is preserved. This record can be used for future integrity checks, audit trails, and to establish a chain of trust throughout the artifact's lifecycle in the distributed compute environment. The integrity store may implement various security measures to protect the stored digests, such as encryption, access controls, and redundancy, to maintain the confidentiality, integrity, and availability of this data. Recording the digest in the integrity store also enables other system components, such as the control layer and execution layer, to access and verify the integrity of artifacts as needed during workload orchestration and execution processes.

In block 580, the IM process may transmit or otherwise make available the finalized integrity digest to the agent that initiated this integrity digest creation event. The transmission or making available of the finalized integrity digest may ensure that the agent who initiated the process receives the final result. The transmission of the finalized integrity digest serves multiple purposes, including confirmation, verification, record-keeping, and auditability. It confirms to the agent that the integrity digest creation process has been successfully completed. It allows the agent to verify that the integrity digest accurately represents the compute workload or system component for which it was created. The agent can store this finalized integrity digest for future reference or use in subsequent operations within the distributed compute system. By providing the finalized digest to the initiating agent, the system maintains a clear audit trail of integrity-related actions. The method of transmission or making the digest available may vary depending on the system's configuration and security requirements. This could involve direct transmission over a secure channel, storage in a shared secure repository accessible to the agent, or notification with instructions for secure retrieval. Regardless of the method, the system ensures that only the authorized initiating agent receives the finalized integrity digest, maintaining the confidentiality, integrity, and availability of the process.

Following the transmission of or making available the finalized integrity digest, the IM process may await receipt of a further artifact reference and possibly a related integrity digest chain in block 510, to repeat the integrity digest creation process 500. This cyclical nature of the integrity digest creation process 500 allows for continuous verification and maintenance of integrity within the distributed compute system. By awaiting further artifact references and potential integrity digest chains, the IM process remains in a state of readiness to handle new or updated artifacts as they are introduced to the system. The repetition of the process 500 ensures that each new artifact or modification to existing artifacts undergoes the same rigorous integrity checks. This approach helps maintain a consistent level of security and trustworthiness across all components of the system throughout their lifecycle. Furthermore, this cyclical process supports scenarios where artifacts may evolve or be updated over time. For instance, when a compute workload is modified or a new version is introduced, the system can seamlessly initiate a new integrity digest creation process for the updated artifact. This ensures that the integrity store contains the most up-to-date and relevant integrity information for all artifacts in the system. The continuous nature of this process also facilitates the system's ability to adapt to changing security requirements or newly discovered vulnerabilities. In instances in which, for example, a more robust hashing algorithm is implemented, the system can easily create new integrity digests for existing artifacts using the updated method, thereby enhancing the overall security posture of the distributed compute environment. By maintaining this ongoing cycle of integrity digest creation, the system establishes a comprehensive and evolving chain of trust for all artifacts, providing a solid foundation for secure orchestration and execution of verified distributed compute workloads.

In various embodiments, the system may implement a distinct process for integrity digest challenges to maintain system integrity. FIGS. 6A and 6B illustrate two distinct processes for integrity digest challenges, either of which may be implemented as part of the integrity digest challenge described above with regard to block 520 of integrity digest creation process (e.g., 500) described above with regard to FIG. 5. There are at least two processes for integrity digest challenging that may be implemented in accordance with various embodiments, based on whether the artifact reference is provided by a challenger (e.g., process 600) or computed by the IM process (e.g., process 601).

A difference between these two integrity digest challenge processes lies in the computation of the artifact hash. In the first integrity digest challenge process 600, described below, the IM process computes the hash after retrieving a cached integrity digest. In the second integrity digest challenge process 601, described below, the challenger computes the hash before initiating the integrity digest challenge. These two processes 600, 601 may provide flexibility in how integrity challenges are performed, allowing the system to adapt to different scenarios or requirements. For example, the first integrity digest challenge process 600 may be more suitable when the challenger does not have direct access to the artifact, while the second integrity digest challenge process 601 may be more efficient when the challenger can compute the hash locally.

FIG. 6A illustrates an integrity digest challenge process 600 for when the artifact reference is provided by a challenger, in accordance with various embodiments. The IM module (e.g., 320) of the integrity layer (e.g., 114) may perform the integrity digest challenge process 600, which may be initiated by a challenger. The “challenger,” as used herein, refers to an agent (e.g., an internal system component or external actor 310) who initiates the integrity digest challenge process 600. The challenger may or may not be the same agent involved in other processes described herein.

In block 610, the integrity digest challenge process 600 may begin in response to the IM module receiving from the challenger a challenged artifact reference. The challenged artifact reference serves as a unique identifier for the item that needs to be verified, which could be a compute workload, a system component, or any other element in the distributed compute environment. The challenger, in this context, can be any authorized entity within or external to the system that requires verification of an artifact's integrity. This could include the control layer (e.g., 110), the execution layer (e.g., 112), or even an external actor (e.g., 310) interacting through the interface layer. By providing the challenged artifact reference, the challenger is essentially requesting the IM module to confirm that the artifact in question has not been tampered with and maintains its expected state. The IM module, upon receiving this reference, prepares to perform a series of checks and comparisons to ensure the artifact's integrity.

In block 620, the IM module may attempt to locate and retrieve, from the integrity store (e.g., 124), a cached integrity digest associated with the challenged artifact reference. If the cached integrity digest is retrieved, the integrity digest retrieval will be considered successful. A successful retrieval indicates that the system has a pre-existing record of the artifact's integrity, which can be used as a basis for comparison in the current challenge. This scenario allows for a quick and efficient integrity check against a known, trusted state of the artifact. However, if the cached integrity digest retrieval fails, the integrity digest retrieval will be considered unsuccessful (i.e., a failure). A failed retrieval could occur for several reasons. The artifact might be new to the system and thus lack a corresponding integrity digest. Alternatively, the failure could indicate potential data corruption or unauthorized removal of integrity information from the store. In either of these or other cases, a failed retrieval necessitates a different approach to verifying the artifact's integrity, potentially involving more comprehensive checks or the creation of a new integrity digest. The binary outcome of this retrieval attempt (success or failure) determines the subsequent flow of the integrity digest challenge process. A successful retrieval allows the process to proceed with comparing the current state of the artifact against its cached digest, while a failure may trigger alternative verification procedures or error handling routines. This design ensures that the system can adapt to various scenarios while maintaining a robust approach to integrity verification.

In determination block 625, the IM module may determine whether the cached integrity digest was retrieved. In response to the IM module determining that the cached integrity digest was retrieved (i.e., determination block 625=“Yes”), the IM module will compute an artifact hash in block 630. In response to the IM module determining that the cached integrity digest was not retrieved (i.e., determination block 625=“No”), in block 627 the IM module will report the challenge failure. For example, the IM module may transmit a challenge failed message to the challenger that sent the challenged artifact reference in block 610. Alternatively, or additionally, the IM module may record the failed retrieval.

In response to this failure, the IM module takes a decisive action by transmitting a challenge failed message back to the challenger. This message serves as an immediate notification that the integrity of the challenged artifact cannot be verified due to the absence of a corresponding cached digest. The challenger, which could be any component or external entity that initiated the integrity challenge (such as the control layer, execution layer, or an authorized external system), receives this failure message. This prompt notification allows the challenger to take appropriate action, which might include: 1. Halting the execution of the associated workload; 2. Logging the failure for security auditing purposes; 3. Initiating a process to register the artifact if it's determined to be new and legitimate; and/or 4. Triggering an investigation into potential system integrity issues.

By immediately failing the challenge when the cached digest cannot be retrieved, the system maintains a strict security posture. This approach ensures that only artifacts with verifiable integrity records can proceed through the system, thereby maintaining the overall integrity and trustworthiness of the distributed compute environment.

In block 630, the IM module may compute a hash of the challenged artifact.

The hash function acts as a digital fingerprint, creating a unique fixed-size string of characters that represents the content of the artifact. Any change to the artifact, no matter how small, would result in a different hash value. The IM module has flexibility in choosing the hash algorithm to use. It may employ a default algorithm that is preconfigured in the system, providing a standard approach across all integrity checks. Alternatively, it may use a system-configured hash algorithm, which allows for customization based on specific security requirements or computational constraints of the distributed compute environment. In some cases, the integrity digest itself may specify the hash algorithm to be used. This option may provide a higher level of granularity, allowing for different hash algorithms to be used for different artifacts or at different stages of the workload lifecycle. This flexibility may be particularly useful in scenarios where certain workloads or data types require stronger cryptographic protection. The choice of hash algorithm can impact the security and performance of the integrity verification process. Common hash algorithms may include SHA-256, SHA-3, Blake2, or MD5, each offering different trade-offs between speed and security. The system's ability to support multiple hash algorithms may ensure that it can adapt to evolving cryptographic standards and specific workload requirements. By computing this artifact hash, the IM process establishes a basis for comparison in the subsequent steps of the integrity digest challenge. This computed hash will be compared against the hash stored in the cached integrity digest to determine if the artifact has remained unchanged since its last verified state.

In block 640, the IM module compares the newly computed hash in block 630 to an artifact hash included in the cached integrity digest retrieved in block 620 for determining whether the newly computed hash matches the artifact hash included in the cached integrity digest (i.e., determining whether the artifact hashes match). The newly computed hash represents the current state of the compute workload, while the artifact hash in the cached integrity digest represents the previously verified state. By comparing these two hashes, the system can detect any modifications or tampering that may have occurred to the workload since it was last verified. If the hashes match, it indicates that the compute workload has maintained its integrity and has not been altered. This successful match allows the process to proceed, potentially leading to the execution of the workload. However, if the hashes do not match, it suggests that the workload has been modified or corrupted since its last verification, which may trigger security measures or prevent the workload from being executed. This hash comparison is a security measure in the distributed compute system, ensuring that only verified and unaltered workloads are processed. It helps maintain the overall integrity and trustworthiness of the system by preventing the execution of potentially compromised or maliciously modified workloads.

In determination block 645, the IM module may determine whether the artifact hashes match. In response to the IM module determining that the artifact hashes match (i.e., determination block 645=“Yes”), the IM module will inform the challenger that the challenge was a success in block 650. A successful match indicates that the artifact has not been tampered with or altered since its last verification. The IM module communicates this success to the challenger, which could be the control layer, execution layer, or another system component or external actor that initiated the integrity challenge. This positive outcome allows the system to proceed with confidence in the artifact's integrity, potentially leading to further actions such as workload execution or data processing. The success message may include additional metadata about the verification process, such as timestamps or specific details about the matched hashes, providing a comprehensive audit trail for security and compliance purposes. In response to the IM module determining that the artifact hashes do not match (i.e., determination block 645=“No”),in block 627 the IM module will report that the challenge failed to the challenger that sent the challenged artifact reference in block 610. Following the transmission of the challenge failed message, the IM module may await receipt of a further challenged artifact reference in block 610.

Following the transmission of the challenge success message in block 650, the IM module may await receipt of a further challenged artifact reference in block 610, to repeat the integrity digest creation process 600. This cyclical nature of the process 600 allows for continuous integrity verification within the distributed compute environment. As new artifacts are introduced or existing ones are modified, the system can promptly initiate new challenges to ensure ongoing security. The IM module may maintain a queue of pending challenges, prioritizing them based on factors such as the criticality of the artifact, the frequency of its use, or specific system policies. In some implementations, the IM module may also perform periodic, automated challenges on a set schedule to proactively verify the integrity of system components or frequently accessed artifacts. This approach helps detect any unauthorized changes that might occur during periods of inactivity or as a result of sophisticated, time-delayed attacks. Additionally, the IM module may log each challenge attempt, whether successful or failed, to create a comprehensive audit trail. This log can be invaluable for security analysis, compliance reporting, and system optimization. By continuously cycling through the integrity digest creation process, the system maintains a vigilant stance against potential security threats, ensuring that the distributed compute environment remains robust and trustworthy over time.

FIG. 6B illustrates an alternative integrity digest challenge process 601 in which the challenger initiates the process after computing and providing a hash of the challenged artifact reference to the IM module, in accordance with various embodiments. Thus, like the integrity digest challenge process 600 described above, the challenger may initiate the alternative integrity digest challenge process 601, which is performed by the IM module (e.g., 320) of the integrity layer (e.g., 114).

In block 660, the IM process may begin in response to the IM module receiving from a challenger a challenged artifact reference and a computed artifact hash for that challenged artifact reference. The challenger may compute the artifact hash of the challenged artifact reference using a default, system-configured hash algorithm, or an integrity digest-specified hash algorithm to compute this artifact hash.

In response to the IM module receiving, in block 660, the challenged artifact reference and the computed artifact hash, in block 620 the IM module may attempt to retrieve, from the integrity store (e.g., 124), a cached integrity digest associated with the challenged artifact reference.

In determination block 665, the IM module may determine whether the cached integrity digest was retrieved. In response to the IM module determining that the cached integrity digest was retrieved (i.e., determination block 665=“Yes”), in block 640 the IM module will compare the computed artifact hash to an artifact hash included in the cached integrity digest retrieved in block 620. In response to the IM module determining that the cached integrity digest was not retrieved (i.e., determination block 665=“No”), in block 627 the IM module will report that the challenge failed to the challenger that initiated the challenge (i.e., in block 660).

In response to the comparison, in block 640, of the computed artifact hash to the artifact hash from the cached integrity digest, the process may proceed through determination block 645 and either block 627 or block 650 similar to that described above with regard the process 600 with regard to FIG. 6A. Also, following the transmission of the challenge success message in block 650, the IM module may await receipt of a further challenged artifact reference and computed artifact hash in block 660, to repeat the alternative integrity digest creation process 601.

This cyclical nature of the process 601 allows for continuous integrity verification within the distributed compute environment. As new artifacts are introduced or existing ones are modified, the system can promptly initiate new challenges to ensure ongoing security. The IM module may maintain a queue of pending challenges, prioritizing them based on factors such as the criticality of the artifact, the frequency of its use, or specific system policies. In some implementations, the IM module may also perform periodic, automated challenges on a set schedule to proactively verify the integrity of system components or frequently accessed artifacts. This approach helps detect any unauthorized changes that might occur during periods of inactivity or as a result of sophisticated, time-delayed attacks. Additionally, the IM module may log each challenge attempt, whether successful or failed, to create a comprehensive audit trail. This log can be invaluable for security analysis, compliance reporting, and system optimization. By continuously cycling through the integrity digest creation process, the system maintains a vigilant stance against potential security threats, ensuring that the distributed compute environment remains robust and trustworthy over time.

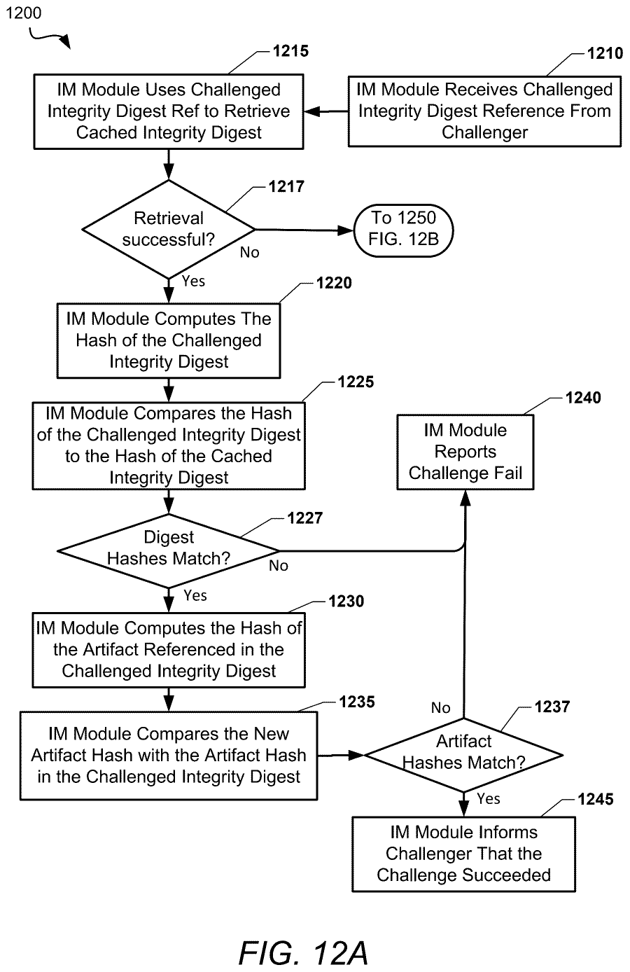

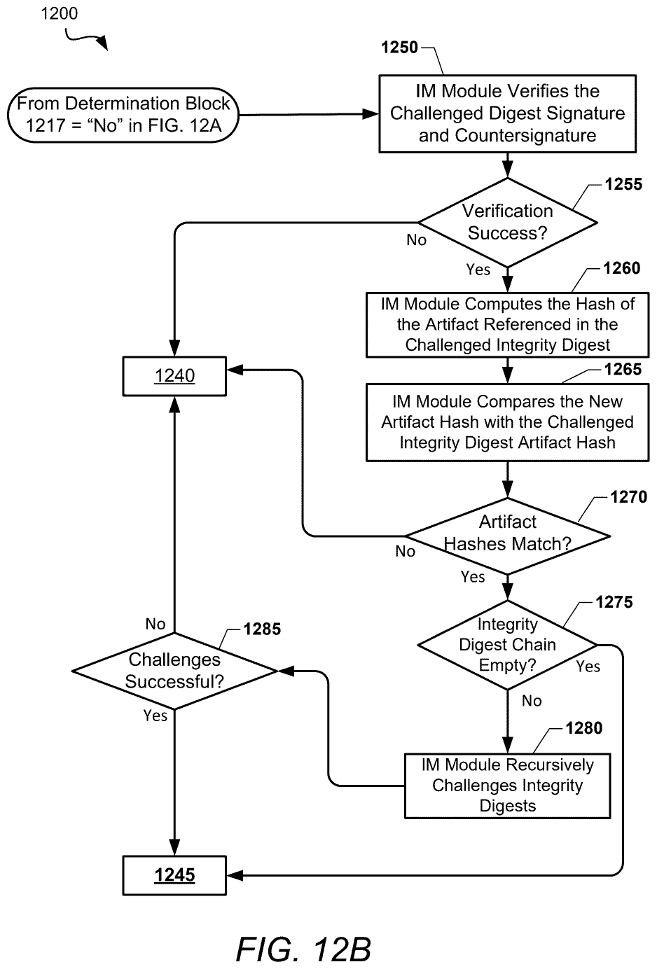

In some embodiments, the system may use further alternative integrity digest challenge processes with one or more additional verification blocks (e.g., advanced integrity digest challenge process 1200 and related description for FIG. 12). These processes may involve not only comparing hashes but also include one or more additional elements, such as verifying signatures, checking the integrity of the entire digest chain, and/or performing recursive challenges on predecessor digests. By implementing these comprehensive verification blocks, the system may enhance its ability to detect tampering or inconsistencies at various stages of the workload lifecycle, from the initial source code (e.g., 410) through the compiled code (e.g., 420), workload bundle (e.g., 430), and/or the registered workload (e.g., 440).

The advanced integrity digest challenge process may be particularly valuable when dealing with complex workloads that involve multiple transformations or dependencies. For instance, when verifying the integrity of a registered workload (e.g., 440), the IM module may recursively challenge the integrity of its predecessor digests, including the workload execution bundle (e.g., 430), the bundler (e.g., 431), and/or the dependencies (e.g., 432). This comprehensive approach may help ensure that not only the final workload but also its provenance chain maintains integrity.

By providing these multiple layers of verification, the system may significantly enhance its security posture and reduce the risk of executing compromised or tampered workloads. This robust integrity verification process may be useful for maintaining the overall trustworthiness and reliability of the distributed compute system, especially in scenarios where workload integrity is paramount, such as in financial, healthcare, or mission-critical applications.

In various embodiments, the system performs workload creation (e.g., 315) according to a process 700 for generating executable workloads. FIGS. 7A and 7B illustrate a process flow of a workload creation process 700 in accordance with various embodiments.

The workload creation process 700 may begin at block 705, in which the control layer (e.g., 110) receives a workload creation engagement message from an agent. The control layer may receive the workload creation engagement message from the agent through various means, depending on the system configuration and the agent's role. For internal system components acting as agents, this workload creation engagement message may be received through direct function calls or inter-process communication mechanisms. For external systems or users, the workload creation engagement message may be received via API calls, command-line interfaces, or graphical user interfaces provided by the interface layer (e.g., 220). This engagement by the agent with the control layer may provide information about the desired compute workload, which may include the workload's source code, configuration parameters, resource requirements, or other relevant metadata. The control layer 110 may receive this information through its designated input channels, which could involve file uploads, data streaming, structured message passing, or other methods depending on the specific implementation. In receiving this information, the control layer 110 acts as the central orchestrator for workload management. The control layer 110 may then coordinate with other system components, such as the integrity layer 114 and execution layer 112, to process the agent's request and initiate the workload creation process.

The system may be configured to be flexible and accommodate various input formats from the agent(s), referred to as “supported representations.” These supported representations encompass a wide range of formats to cater to different use cases and stages of workload development: 1. Source code form: This may be compilable (e.g., C++, Rust, Java) or interpretable (e.g., Python, JavaScript) code. Source code allows for maximum flexibility and customization of the workload; 2. Compiled code form: Pre-compiled binaries or bytecode that are ready for execution but may require specific runtime environments; 3. Conceptual form: A high-level description or specification of the workload, such as declarative representations or configuration diagrams comprising a selection of linked objects from a library of nodes, parameters, and variables, which the system may interpret and translate into executable code; 4. Metadata form: A set of instructions or parameters that define how the workload should be constructed or executed, such as may be provided to a Large Language Model (LLM), an Agentic AI system, or a query processing engine; 5. Executable form: This includes container images (e.g., Docker containers), virtual machine images, or virtual environments. These forms encapsulate the workload along with its dependencies and execution environment; and/or 6. Complete Workload Execution Bundle: A comprehensive package that includes the workload, its dependencies, configuration files, and any other components for execution.

By supporting this diverse range of representations, the system provides flexibility for users and integrates seamlessly with various development and deployment workflows. The ability to accept different forms of input allows the system to cater to different stages of the software development lifecycle, from initial conceptualization to final deployment.

In a block 710, the control layer may instantiate (i.e., create and/or initialize) a new compute workload with default parameters based on the system's configuration. These default parameters may define initial settings and constraints for the workload, serving as a starting point for configuring the workload and ensuring that it has a consistent baseline configuration across the system. The default parameters may include settings such as resource allocation limits (e.g., CPU, memory, storage), execution priority, timeout values, logging levels, and security policies. By basing these default parameters on the system's configuration, the control layer 110 ensures that new workloads are created in alignment with the overall system architecture and policies. This approach helps maintain consistency and predictability in workload behavior, while also allowing for customization as needed in subsequent steps of the workload creation process.

The initial settings defined by these default parameters may include:
1. Resource quotas: Limiting the maximum computational resources the workload can consume;
2. Execution environment: Specifying the default runtime or container image to be used;
3. Network access rules: Defining default network policies and access controls;
4. Data handling policies: Setting initial rules for data storage, encryption, and retention; and/or
5. Monitoring and logging configurations: Establishing default metrics collection and log verbosity levels.

These default constraints help ensure that new workloads adhere to system-wide standards for security, performance, and resource utilization. As the workload creation process continues, these initial parameters can be adjusted or overridden based on specific requirements of the workload or instructions provided by the agent initiating the creation process.

In block 720, the control layer 110 receives a compute workload artifact from the agent. In some cases, the agent may optionally include an agent-generated artifact hash and its associated hashing algorithm. Supported forms may include source code, compiled code, or other representations that the system can process. The received compute workload artifact represents the actual content or code that may be executed as part of a distributed compute workload. The flexibility in supported forms allows the system to accommodate various stages of workload development and different programming paradigms. Source code form may include human-readable programming languages like Python, Java, or C++. This allows developers to submit their original code for processing and execution within the distributed system. Compiled code, on the other hand, may be in the form of bytecode or machine code that has already been processed by a compiler. This pre-compiled form can potentially offer performance benefits but may be less flexible for modification within the system.

The optional inclusion of an agent-generated artifact hash and its associated hashing algorithm provides an additional layer of integrity verification. By allowing the agent to generate and submit its own hash, the system can later compare this hash with one generated internally to ensure the artifact has not been tampered with during transmission or storage. The associated hashing algorithm information ensures that the system uses the correct method when verifying the hash, accommodating potential variations in hashing techniques across different agents or workload types.

Other representations that the system can process may include intermediate formats like abstract syntax trees, bytecode, machine code, or domain-specific languages. These alternative forms provide flexibility for specialized workloads or optimization techniques that may not fit neatly into the categories of source code or compiled code. By supporting a range of artifact forms and optional integrity measures, the control layer demonstrates adaptability to various development workflows and security requirements in the context of distributed compute workloads.

In response to the receipt by the control layer 110 of the workload creation engagement message in block 710, the control layer may engage in various interactions with the agent to facilitate the transmission of the compute workload artifact and, optionally, the agent-generated artifact hash. These interactions may enhance the flexibility and security of the workload creation process. For example, the control layer 110 may send a request to the agent for the compute workload artifact. This request may include information about supported formats and any specific requirements for the workload. In response, the agent may prepare and transmit the artifact in the appropriate format. In some cases, the control layer 110 may provide a secure upload mechanism for the agent to transmit the compute workload artifact. This mechanism may involve generating a temporary, authenticated URL for the agent to use when uploading the artifact, ensuring secure transmission of potentially sensitive code or data. The control layer 110 may also offer an option for the agent to specify preferences or override certain default parameters set in block 710. This interaction may allow the agent to customize the workload configuration before transmitting the artifact, potentially influencing how the system processes or executes the workload. For enhanced security, the control layer 110 may challenge the agent to prove its identity or authorization level before accepting the compute workload artifact. This challenge-response mechanism may involve cryptographic techniques or multi-factor authentication, depending on the system's security requirements. In systems supporting versioning or iterative development, the control layer 110 may query the agent for version information or changelog data related to the compute workload artifact. This interaction may help the system maintain a history of workload modifications and ensure proper version control. The control layer 110 may provide the agent with the option to generate and transmit an artifact hash along with the compute workload artifact. This option may be presented through a configuration setting or as part of the artifact submission process. The control layer may specify supported hashing algorithms or allow the agent to choose its preferred method.

In some implementations, the control layer 110 may offer a dry-run option, where the agent can submit the compute workload artifact for preliminary processing without full execution. This interaction may allow the agent to verify that the artifact is correctly formatted and compatible with the system before proceeding with the full workload creation process. The control layer 110 may also provide an interface for the agent to specify dependencies or environmental requirements associated with the compute workload artifact. This interaction may ensure that the system has all necessary components to process and execute the workload successfully. In scenarios where the compute workload artifact is large or complex, the control layer may support chunked or streaming uploads. This approach may involve multiple interactions between the control layer and the agent, with the artifact being transmitted in segments and reassembled by the system.

These various interaction options between the control layer and the agent may provide a flexible and secure framework for transmitting the compute workload artifact and associated integrity information, accommodating different use cases and security requirements in the distributed compute environment.

In block 730, the control layer initiates the generation of an integrity digest by transmitting a compute workload artifact reference, and an integrity digest chain (if available) to the IM module (e.g., process 500 in FIG. 5). In this way, the control layer interacts with the integrity layer to generate an integrity digest based on the compute workload artifact and its optional agent-generated artifact hash with hashing algorithm. The integrity digest serves as a cryptographic representation of the workload artifact, allowing for future verification and tamper detection. The control layer may use a default hashing algorithm or the one specified by the agent (if provided) to compute the digest. This flexibility allows for compatibility with various security requirements and cryptographic standards. The resulting integrity digest typically includes: a hash of the compute workload artifact, the artifact reference, the hashing algorithm used, a timestamp of the digest creation, and/or the optional agent-generated artifact hash (if provided). By incorporating both system-generated and agent-provided information, the integrity digest creates a comprehensive and verifiable record of the workload's state at this point in the creation process. This digest becomes a component in the integrity digest chain, enabling the system to track and verify the workload's integrity at each stage of its lifecycle, from creation through execution and output generation. The generated integrity digest may then be recorded in the integrity store (e.g., 124) and may be used in subsequent integrity challenges, which may ensure the workload has not been tampered with or corrupted. This process enhances the overall security posture of the distributed compute system by providing a reliable mechanism for workload verification throughout its lifecycle.

If the IM module (e.g., 320), as part of the integrity digest creation process (e.g., 500) rejects the integrity digest creation request (e.g., block 527), the control layer (i.e., the agent that initiated this particular integrity digest creation) may receive a rejection message, which the IM module and/or the control layer may document the failure mode for remediation (i.e., log the failure). This documentation may be stored in the integrity store (e.g., 124) or the persistence layer (e.g., 216) for future reference and analysis.

The integrity layer (e.g., 114) may optionally store the artifact and integrity digest in the integrity store (e.g., 124). The option of whether to store the artifact and/or digest may be based on the system configuration. This operation may involve creating a source code digest or other appropriate digest type depending on the input form. This introduces flexibility in how the system handles artifacts and digests during the workload creation process. By allowing the integrity layer to store these elements, the system can maintain a comprehensive record of workload components and their associated integrity information. This option is particularly useful in scenarios where traceability and auditability are prioritized such as in highly regulated industries or for sensitive workloads.

The decision to store the artifact and/or integrity digest in the integrity store (e.g., 124) is determined by the system configuration, which allows for customization based on specific organizational needs, security requirements, or resource constraints. For instance, in environments with limited storage capacity, the system might be configured to store only the digest, which serves as a compact representation of the artifact's integrity. Conversely, in scenarios where full reproducibility is essential, both the artifact and its digest might be stored. The creation of a source code integrity digest or other appropriate integrity digest type depending on the input form demonstrates the system's adaptability to various workload representations. For source code inputs, a source code digest would be generated, capturing the integrity of the original code before any compilation or transformation. For other input forms, such as pre-compiled binaries or container images, the system would create a digest appropriate to that specific format. This flexibility ensures that the integrity verification process can accommodate a wide range of workload types and development practices. By providing this optional storage step, the system enhances its ability to maintain a chain of trust throughout the workload lifecycle. This can be particularly valuable for debugging, auditing, or reproducing specific workload states in the future. Additionally, storing these elements in the integrity store centralizes the integrity-related information, facilitating efficient retrieval and verification in subsequent stages of the workload lifecycle, such as during orchestration or execution.

In optional block 735, the control layer may initiate an integrity digest challenge of the integrity digest generated from block 730. In this way, the control layer may transmit a compute workload artifact reference to the IM module (e.g., process 600 in FIG. 6A) or by also transmitting a computed artifact hash (if available) to the IM module (e.g., process 601 in FIG. 6B). The control layer acts as the challenger interacting with the integrity layer to challenge the integrity digest for the newly generated integrity digest. This optional integrity digest challenge may be configured to be executed in systems requiring an added layer of verification, traceability, and auditability.

In response to receiving an indication from the IM module that the integrity digest challenge was successful, the process may proceed to determination block 740. If the IM module (e.g., 320), as part of the integrity digest challenge process (e.g., 600, 601) rejects the integrity digest (e.g., block 627), the control layer (i.e., the agent that initiated this particular integrity digest challenge) may receive a rejection message, which the IM module and/or the control layer may document the failure mode for remediation (i.e., log the failure). This documentation may be stored in the integrity store (e.g., 124) or the persistence layer (e.g., 216) for future reference and analysis.

Following either block 730 or optional block 735, the control layer 110 may determine in determination block 740 whether the generated compute workload is in an executable form. Executable forms may include runnable container images, virtual machine images, virtual environments (e.g., a Python virtual environment, a JavaScript virtual environment), or equivalent embodiments that contains the requisite elements to execute the Compute Workload without further required configuration.

The control layer's determination in this regard ensures that the workload can be directly executed without requiring additional compilation or configuration steps.

Executable forms encompass a range of self-contained environments that encapsulate all necessary components for workload execution. Runnable container images, such as Docker container images, provide a lightweight, portable, and consistent environment for running applications. These images include the application code, runtime, system tools, libraries, and settings needed to run the workload across different computing environments. Virtual machine images represent a complete operating system and application stack, including the kernel. These images can be run on hypervisors or cloud platforms, offering a higher level of isolation compared to containers but potentially with more resource overhead. Virtual environments for languages like Python and JavaScript, often accessed through environment managers like Conda and Node.js, create isolated spaces within a host system with a defined language runtime version and a managed collection of resolved runtime dependencies. These environments allow for the installation of specific versions of libraries and dependencies without affecting the global system configuration. This isolation is particularly useful for managing complex dependency requirements or when working with multiple projects that have conflicting dependencies.

By ensuring the workload is in an executable form at this stage, the system can proceed directly to registration, orchestration, and execution without intermediate steps, enhancing efficiency and reducing potential points of failure in the workload lifecycle. This approach aligns with the system's goals of maintaining confidentiality, integrity, and availability throughout the workload process, as executable forms can be easily verified and tracked through the integrity digest chain.

In response to the control layer 110 determining that the generated compute workload is in an executable form (i.e., determination block 740=“Yes”), the control layer may transmit a workload creation completion notification to the agent in block 790, which completes the workload creation process. This action, carried out in block 790, signifies the successful completion of the workload creation process, effectively marking the transition of the workload to a state ready for deployment or further processing within the system.

In response to the control layer determining that the generated compute workload is not in an executable form (i.e., determination block 740=“No”), the control layer may determine whether the generated compute workload requires compilation (i.e., including pre-compilation) in determination block 750.

As illustrated in FIG. 7B, in determination block 750, the control layer may determine whether the generated compute workload requires compilation or even pre-compilation. This evaluation may be guided by the nature of the source code involved in the workload or factors such as the input language and system configuration. Specifically, source code that is implemented in non-interpreted languages typically requires pre-compilation. This is because such languages need to be translated into machine-readable code before execution, which is not inherently handled during runtime. On the other hand, source code implemented in interpreted languages does not generally require pre-compilation as these languages are designed to be compiled at runtime by their nature, allowing for direct execution from the high-level code. This distinction in the handling of source code based on the programming language characteristics ensures that the system can appropriately manage the preparation of various types of workloads, aligning the processing steps with the requirements and capabilities of the underlying languages and runtime environments. This approach facilitates a flexible and efficient management of workload preparation, catering to the diverse needs of different programming paradigms within the distributed computing architecture.

In response to the control layer determining that the generated compute workload requires compilation (i.e., determination block 750=“Yes”), the control layer may convert the workload to a compiled form in block 760. Optionally, prior to converting the workload to compiled form, in block 760, the control layer may initiate the integrity digest challenge process (e.g., 600, 601 in FIGS. 6A, 6B). In this way, the control layer may ensure the IM module challenges the integrity digests for the compiler (e.g., 421), compilation sandbox (e.g., 422), and any dependencies (e.g., 423). As above, the control layer once again acts as the challenger interacting with the integrity layer to challenge the integrity digests. In response to receiving an indication from the IM module that the integrity digest challenges were successful, the process may proceed to block 760. However, in response to receiving an indication (e.g., a rejection message) from the IM module that any one of the integrity digest challenges failed, the control layer may document the failure mode for remediation (i.e., log the failure). This documentation may be stored in the integrity store (e.g., 124) or the persistence layer (e.g., 216) for future reference and analysis.

In response to the control layer determining that the generated compute workload does not require compilation (i.e., determination block 750=“No”), the control layer may generate the workload execution bundle in block 775. Optionally, prior to generating the workload execution bundle, in block 775, the control layer may initiate the integrity digest challenge process (e.g., 600, 601 in FIGS. 6A, 6B). In this way, the control layer may ensure the IM module challenges the integrity digests for the bundler (e.g., 431) and any dependencies (e.g., 432). As above, the control layer once again acts as the challenger interacting with the integrity layer to challenge the integrity digests. In response to receiving an indication from the IM module that the integrity digest challenge was successful, the process may proceed to block 760. However, in response to receiving an indication (e.g., a rejection message) from the IM module that the integrity digest challenge failed, the control layer may document the failure mode for remediation (i.e., log the failure). This documentation may be stored in the integrity store (e.g., 124) or the persistence layer (e.g., 216) for future reference and analysis.

In block 760, the conversion by the control layer of the workload into compiled form may include the association of the compute workload with the required compiler, compilation sandbox, and optional dependencies. For example, if the workload is written in pre-compiled languages (e.g., C++, Rust, Java), the control layer 110 may engage a suitable compiler to process the source code. The compiler will analyze the source code, optimize it for performance, and translate it into an executable binary format. This binary format is specifically tailored to the architecture of the execution environment, ensuring that the workload can be efficiently executed on the target hardware. Additionally, the control layer 110 may manage various compiler settings and options to optimize the compilation process. This might include setting optimization levels, managing include paths for header files, and configuring linker settings for external libraries. The control layer 110 may also handle any dependencies that the source code has on external libraries or modules, ensuring that all necessary components are included during the compilation process. Once the compilation is complete, the control layer may store the compiled form of the workload in a designated location within the system, making it ready for further processing or execution. This compiled form represents a significant transformation from the original source code, encapsulating the computational logic of the workload in a form that is directly executable by the system's hardware. This process ensures that the workload is prepared and optimized for efficient execution within the distributed computing environment, aligning with the system's overall performance and security objectives.

In block 765 the control layer initiates the generation of an integrity digest for the compute workload in compiled form (e.g., process 500 in FIG. 5). In some cases, the control layer may also initiate integrity digest creation for the compilation event itself. This operation may involve creating a compiled code digest and potentially additional digests such as a compiler digest, compilation sandbox digest, and compilation dependencies digest. For instance, the compiler digest may include details about the compiler version and settings used during the compilation process, providing a verifiable record that may be essential for reproducing the same binary output in future builds. The compilation sandbox digest may capture the state of the virtual or isolated environment in which the compilation occurred, ensuring that the compilation process is secure and free from external interferences. Also, the compilation dependencies digest may document the versions and sources of any libraries or tools that the code depends on, which helps in maintaining consistency across different compilation sessions and aids in troubleshooting issues related to dependency management. These digests may collectively contribute to a robust framework for tracking and verifying every aspect of the compilation process, enhancing the overall security and reliability of the distributed computing system.

If the IM module (e.g., 320), as part of this integrity digest creation process (e.g., 500) rejects the integrity digest creation request (e.g., block 527), the control layer (i.e., the agent that initiated this particular integrity digest creation) may receive a rejection message, which the IM module and/or the control layer may document the failure mode for remediation (i.e., log the failure). This documentation may be stored in the integrity store (e.g., 124) or the persistence layer (e.g., 216) for future reference and analysis.

In block 765, the control layer may optionally also initiate an integrity digest challenge of the integrity digest generated from block 730. In this way, the control layer may transmit a compiled workload artifact reference to the IM module (e.g., process 600 in FIG. 6A) or by also transmitting a computed artifact hash (if available) to the IM module (e.g., process 601 in FIG. 6B). The control layer acts as the challenger interacting with the integrity layer to challenge the integrity digest for the newly generated integrity digest. This optional integrity digest challenge may be configured to be executed in systems requiring an added layer of verification, traceability, and auditability.

In response to receiving an indication from the IM module that the integrity digest challenge was successful, the process may proceed to block 775 or optional block 770. If the IM module (e.g., 320), as part of the integrity digest challenge process (e.g., 600, 601) rejects the integrity digest (e.g., block 627), the control layer (i.e., the agent that initiated this particular integrity digest challenge) may receive a rejection message, which the IM module and/or the control layer may document the failure mode for remediation (i.e., log the failure). This documentation may be stored in the integrity store (e.g., 124) or the persistence layer (e.g., 216) for future reference and analysis.

In optional block 770, the control layer may direct the integrity layer to generate a verifiable audit history of internal system events. A system may include and implement the option of generating a verifiable audit history of internal system events in block 770 for several reasons. Firstly, generating a verifiable audit history of internal system events enhances the overall transparency and accountability of the internal activity within the distributed compute system. This audit trail provides a chronological record of all significant actions and events that occur within the system, which may be valuable for troubleshooting, security analysis, and compliance purposes. In the context of workload creation and compilation, this audit history can help track the lifecycle of a workload from its initial source code to its compiled form. Secondly, creating new integrity digests for the compiled code, compilation dependencies, and compilation event adds extra layers of security and verification to the system. These digests serve as cryptographic records of component (e.g., dependencies) and derivative (e.g., compiled code) artifacts within the compilation event, allowing the system to later verify that the compiled code has not been tampered with or altered since its creation. By preserving this record in the integrity store, the system maintains a reliable reference point of the system's state during this event for future integrity checks. Furthermore, this option may be particularly useful in environments where regulatory compliance is a concern. Many industries, such as finance and healthcare, have strict requirements for maintaining audit trails and ensuring the integrity of software systems. By implementing this optional step, the system can more easily demonstrate compliance with these regulations and provide evidence of the integrity of its workload creation and compilation processes. Additionally, in scenarios where multiple parties are involved in the development and execution of workloads, this audit history and integrity digest may serve as a form of non-repudiation. It provides a verifiable record of when and how a particular workload was compiled-including which actor(s) and/or system component(s) participated in the compilation event-which can be useful in resolving disputes or verifying the provenance of code. Further, this option may facilitate more efficient debugging and system maintenance. In instances in which issues arise with a compiled workload, having a detailed audit history and integrity digests from the compilation process may help developers and system administrators quickly trace a problem back to its source, potentially reducing downtime and improving overall system reliability.

If compilation (or pre-compilation) is not required (i.e., determination block 750=“No”), after generating the integrity digest in block 765, or optionally after generating a verifiable audit history in block 770, the process may move to a block 775.

In block 775, the control layer 110 may associate the compute workload with the required runtime environment, any necessary dependencies, and a workload bundler. The control layer may then create the compute workload's executable form, which may be referred to as a workload execution bundle. This association by the control layer of the compute workload may include setting up the required runtime environment that supports the specific needs of the workload, integrating any dependencies that are essential for the workload's functionality, and employing a workload bundler to preserve the runtime environment in a representation that is deterministically reproducible (e.g., as a container image, virtual machine, or virtual environment). The bundler packages the workload along with its dependencies and runtime environment into a unified package. This comprehensive association ensures that the workload is fully prepared and equipped with all necessary elements for successful deployment and execution within the distributed computing system.

In block 775, when the control layer 110 associates the compute workload with the required runtime environment, it ensures that the workload is compatible with the system's operational parameters. For example, in some instances wherein the workload is designed to run in a virtualized hardware orchestration cluster (e.g., Kubernetes) on nodes using x86-based or ARM-based processors, the control layer may ensure that the workload execution bundle is an appropriate container image created from an appropriate, system-approved, environment-compliant, and hardware-compatible base image. In other instances, wherein the workload is designed to run on a Linux-based system, the control layer may ensure that all necessary Linux-specific dependencies are included. Similarly, for a workload intended for a cloud-based environment, the control layer may integrate cloud-specific services or APIs that the workload requires to function optimally.

The inclusion of any necessary dependencies promotes workload performance and stability. These dependencies might include libraries, frameworks, or other software modules that the workload needs to execute. For example, a Python-based data analysis workload might require a specific Python runtime kernel and compatible libraries such as NumPy or Pandas. The control layer ensures these are bundled with the workload to avoid runtime errors. Furthermore, the control layer may use a workload bundler to package the compute workload and its dependencies into a complete executable unit, often referred to as a workload execution bundle. This bundling process might involve containerization technologies such as Docker, where the workload and its runtime environment are encapsulated into a Docker container image. This container can then be easily deployed and executed across diverse computing environments such as hardware-agnostic Kubernetes clusters, maintaining consistency in behavior regardless of the underlying infrastructure. This approach of creating a workload execution bundle may simplify deployment and scaling processes within distributed computing environments. It may allow system administrators or automated orchestration systems to deploy and manage workloads efficiently, ensuring that each workload has everything it needs to run correctly, thereby reducing compatibility issues and simplifying system maintenance and updates.

Following the compute workload bundling in block 775, in block 780 the control layer initiates the generation of an integrity digest for the compute workload bundle (e.g., process 500 in FIG. 5). In some cases, the control layer may also initiate integrity digest creation for the compilation event itself. If the IM module (e.g., 320), as part of this integrity digest creation process (e.g., 500) rejects the integrity digest creation request (e.g., block 527), the control layer (i.e., the agent that initiated this particular integrity digest creation) may receive a rejection message, which the IM module and/or the control layer may document the failure mode for remediation (i.e., log the failure). This documentation may be stored in the integrity store (e.g., 124) or the persistence layer (e.g., 216) for future reference and analysis.

In block 780, the control layer may optionally also initiate an integrity digest challenge of the newly generated integrity digest(s). In this way, the control layer may transmit a compute workload bundle artifact reference to the IM module (e.g., process 600 in FIG. 6A) or by also transmitting a computed artifact hash (if available) to the IM module (e.g., process 601 in FIG. 6B). The control layer acts as the challenger interacting with the integrity layer to challenge the integrity digest for the newly generated integrity digest. This optional integrity digest challenge may be configured to be executed in systems requiring an added layer of verification, traceability, and auditability.

In response to receiving an indication from the IM module that the integrity digest challenge was successful, the process may proceed to block 790. If the IM module (e.g., 320), as part of the integrity digest challenge process (e.g., 600, 601) rejects the integrity digest (e.g., block 627), the control layer (i.e., the agent that initiated this particular integrity digest challenge) may receive a rejection message, which the IM module and/or the control layer may document the failure mode for remediation (i.e., log the failure). This documentation may be stored in the integrity store (e.g., 124) or the persistence layer (e.g., 216) for future reference and analysis.

Following block 780 or the determination in determination block 740 that the generated compute workload in in executable form (i.e., determination block 740 =“Yes”), the control layer may transmit a workload creation completion notification to the agent in block 790, which completes the workload creation process. This action, carried out in block 790, effectively marks the transition of the workload to a state ready for deployment or further processing within the system. At this point, the system may have generated an executable workload along with associated integrity digests for various stages of the creation process.

As noted above, throughout the workload creation process, the system may maintain a chain of integrity digests, allowing for comprehensive verification of the workload's integrity from its initial form through compilation (if applicable) and bundling into an executable form. This integrity chain may be used in subsequent processes such as workload registration and execution to ensure the continued integrity of the workload.

The workload creation process 700 provides a foundational approach for an agent to generate a compute workload within the system as a workload execution bundle. However, in more sophisticated scenarios, a workload execution bundle may encompass multiple workloads in various predecessor forms, such as source code or compiled machine code, along with their associated metadata. These components may be aggregated to function collectively as a single composite workload. Also, a single composite workload may comprise multiple workloads in the same form (e.g., multiple compiled workloads composed into a single workload execution bundle or multiple workload execution bundles composed into one larger workload execution bundle, such as having three container images run together or in sequence as a multi-step workload).

For systems with advanced integrity configurations that necessitate multi-party attribution and non-repudiation, the integrity digest creation events (e.g., 500) within this process may trigger interactions with external actors (e.g., 310). These external entities may be called upon to examine and validate one or more of the newly created integrity digests. In these instances, the integrity layer may implement a safeguard mechanism, preventing the workload lifecycle (e.g., 305) from progressing to subsequent stages until one or more external actors have completed their verification. This verification process culminates in one or more external actors providing explicit positive consent to the integrity layer (where such positive consent is collected by the interface layer and passed either directly to the integrity layer or through the control layer to the integrity layer), thereby authorizing the system to continue with the next steps in the workload lifecycle.

In various embodiments, the system performs workload registration (e.g., 330) according to a process 800 for registering compute workloads. FIG. 8 illustrates a process flow of a workload registration process 800 in accordance with various embodiments. The workload registration process 800 may be used for a compute workload to be considered “ready for execution.”

In block 805, the control layer (e.g., 110) receives a workload execution bundle registration request from an agent. The control layer may receive the workload execution bundle registration request from an agent. The agent may be an internal system component, such as a module within the control layer (e.g., 110), or an external actor interacting with the system through a component of the interface layer (e.g., 220) such as an externally-facing application programming interface (API) or user interface (UI). Additionally, automated processes within the system, such as scheduled tasks, event-driven workflows, or Agentic AI workflows, may act as agents and generate registration requests for workload execution bundles.

This engagement by the agent with the control layer in this regard may provide information about the desired workload execution bundle, such as the workload execution bundle artifact. In some cases, the agent may optionally include an agent-generated artifact hash and its associated hashing algorithm. The control layer 110 may receive this information through its designated input channels, which could involve file uploads, data streaming, structured message passing, or other methods depending on the specific implementation. In receiving this information, the control layer 110 acts as the central orchestrator for workload registration.

In block 810, the control layer initiates an integrity digest challenge by directing the integrity layer to perform the integrity digest challenge for the full integrity digest chain of the workload execution bundle (i.e., both the final integrity digest and each integrity digest in the final digest's chain). In this way, the control layer may transmit one or more artifact references to the IM module (e.g., process 600 in FIG. 6A) or by also transmitting computed artifact hashes (if available) to the IM module (e.g., process 601 in FIG. 6B). The control layer acts as the challenger interacting with the integrity layer to challenge the integrity digest(s). These integrity digest challenges may involve the IM module (e.g., 320) within the integrity layer 114 performing a series of verifications. These verifications may include checking the integrity of each integrity digest in the chain, such as a source code digest compiled code digest, workload bundle digest, and any associated digests such as the compiler digest, compilation sandbox digest, and compilation dependencies digest.

If the IM module (e.g., 320), as part of the integrity digest challenge process (e.g., 600, 601) rejects any one of the integrity digests (e.g., block 627), the control layer (i.e., the agent that initiated these integrity digest challenges) may receive a rejection message. In instances in which any of the recursive integrity digest challenges fail, the workload registration may fail, and the control layer or integrity layer may document the failure mode for remediation. This documentation may be stored in the integrity store (e.g., 124) or the persistence layer (e.g., 216) for future reference and analysis.

In response to receiving an indication from the IM module that the integrity digest challenges were successful, the process may proceed to block 820. In block 820, the integrity layer may indicate that the workload execution bundle has been successfully challenged and is “ready for execution” in the integrity store. This indication may take various forms depending on the system configuration. In some cases, the integrity layer may record the occurrence of a successful integrity digest challenge for this workload registration process in the integrity store. This may be done by, for example, persisting a record with the binary (i.e., yes/no) outcome for the workload registration-induced integrity digest challenge in a persistence location such as a key-value store or file, as exemplified by “db://integrity-store/event/reg/workload/1.0/result”, and then creating an integrity digest for this integrity digest challenge event with an artifact reference mapping to the binary outcome stored in the persistence location. In other cases, the integrity layer may record a new unique reference (i.e., “tag”) for the workload execution bundle, as exemplified by an artifact reference like “https://registry.local/verified/workload:1.0” in the registered workload digest. This new reference may be used by other system components, such as the workload orchestration module 340 and the workload execution module 350, to identify verified and ready-to-execute workloads.

In block 830 the integrity layer may generate a new integrity digest (e.g., using the integrity digest creation process 500) for the registered workload execution bundle. This new integrity digest, similar to the registered workload (e.g., 440), may serve as a consolidated reference point for the provenance chain of the workload. Also, the creation of the new integrity digest may mark the completion of the workload registration process.

In block 830, the integrity layer may optionally also initiate an integrity digest challenge of the integrity digest just generated. This optional integrity digest challenge may be configured to be executed in systems requiring an added layer of verification, traceability, and auditability. In response a successful integrity digest challenge, the process may proceed to block 850 or optional block 840. In response to a failed integrity digest challenge, the IM module may document the failure mode for remediation (i.e., log the failure). This documentation may be stored in the integrity store (e.g., 124) for future reference and analysis. This new integrity digest may be similar to the integrity digest for the full integrity challenge (e.g., 441) and may help preserve a record of the registration action in the integrity layer. The integrity layer may also employ other equivalent methods to confirm at a later time that an integrity digest challenge event occurred during this workload registration process. These approaches may enable the integrity layer to maintain a verifiable record of successful challenges and may ensure that only validated workloads proceed to the execution phase. This process may significantly enhance the security and reliability of the distributed compute system, reducing the risk of executing compromised or tampered workloads.

In optional block 840, the integrity layer may generate a verifiable audit history of internal system events. Optional block 840 may be implemented in systems to generate the verifiable audit history of internal events to enhance transparency, accountability, and security within a distributed compute environment. This audit trail and associated integrity digests offer a reliable, cryptographic record of workload compilation, aiding in troubleshooting, regulatory compliance, and non-repudiation by documenting the lifecycle and integrity of compiled code and its dependencies. Such functionality is particularly valuable in regulated industries or multi-party development scenarios, where traceability and proof of code provenance are critical.

In block 850 the integrity layer 114 may notify (i.e., indicate to) other system components, such as the control layer (e.g., 110) or the execution layer (e.g., 112), about the successful registration of the workload, allowing these components to update their internal states or take further actions as needed. The integrity layer may also prepare and store any necessary information that will be required for future integrity challenges or verifications of the registered workload, ensuring that subsequent processes in the workload lifecycle can efficiently access and validate the workload's integrity. The integrity layer may also update relevant metadata in the integrity store 124 to reflect the successful completion of the registration process, potentially including timestamps, references to the newly created integrity digests, and any other pertinent information about the registered workload.

In various embodiments, the system performs workload orchestration (e.g., 340) and workload execution (e.g., 350). FIG. 9A illustrates a process flow of a workload orchestration process 900 in accordance with various embodiments. FIG. 9B illustrates a process flow of a workload execution process 901 that may follow the orchestration process. Together, these processes 900, 901 include the sequence of operations involved in managing the lifecycle of compute workloads from initial triggering through completion or termination, showcasing how the system orchestrates, executes, and monitors workloads in a secure and verified manner.

As illustrated in FIG. 9A, the workload orchestration processes 900 manages the lifecycle of compute workloads from initial triggering through completion or termination. In block 905 the control layer (e.g., 110) may receive a challenged artifact reference from an agent, signifying that an integrity digest challenge should be initiated. For example, the agent could be the execution layer (e.g., 112) requesting a new workload to process; a scheduled task in the control layer triggering a periodic workload, or an external client application submitting a job through the interface layer (e.g., 220). The challenged artifact reference provided by the agent serves as a unique identifier for the item that needs to be verified.

The workload initiation message received by the control layer 110 in block 905 may take various forms depending on the system configuration and the agent initiating the workload. For internal system components acting as agents, this workload initiation message may be received through direct function calls or inter-process communication mechanisms. For external systems or users, the workload initiation message may be received via API calls, command-line interfaces, or graphical user interfaces provided by the interface layer 220. The message itself may contain information about the desired compute workload, which may include the workload's identifier, execution parameters, resource requirements, or other relevant metadata.

In some cases, the message may also include references to pre-registered workload execution bundles stored within the system. In some cases where agent-provided workloads or references to workload execution bundles are not pre-registered with system, the control layer 110 will trigger the requisite workload creation (e.g., 315) or workload registration (e.g., 330) processes which may ensure the workload is verified and “ready for execution”. In these cases where the agent-provided workloads or references to workloads need first be created or registered, the control layer 110 may receive this information through its designated input channels, which could involve file uploads, data streaming, or structured message passing, depending on the specific implementation.

In optional block 910, the control layer 110 may initiate integrity digest creation (e.g., process 500) for the workload orchestration event. This operation may involve creating a new integrity digest in the integrity store 124 to record the initiation of the orchestration process. In instances in which block 910 is included and performed, it adds an extra layer of verification and traceability to the orchestration process. This may be particularly useful in high-security environments or in systems that require comprehensive audit trails. For example, in a financial services application where every step of workload processing must be verifiable and cryptographically non-repudiable, the system may choose to include block 910. In this embodiment, the creation of an integrity digest for the workload orchestration event would provide a cryptographic record of when and how the orchestration process began.

If the IM module (e.g., 320), as part of this integrity digest creation process (e.g., 500) rejects the integrity digest creation request (e.g., block 527), the control layer (i.e., the agent that initiated this particular integrity digest creation) may receive a rejection message, which the IM module and/or the control layer may document the failure mode for remediation (i.e., log the failure). This documentation may be stored in the integrity store (e.g., 124) or the persistence layer (e.g., 216) for future reference and analysis.

The decision to include or exclude block 910 may depend on factors such as the system's security requirements, performance considerations, and the specific use case of the workload being orchestrated. By making this block optional, the system architecture allows for customization based on these varying needs.

If optional block 910 is not included/performed, the process may proceed directly from block 905 to block 915, where the control layer initiates an integrity digest challenge for the workload execution bundle. This direct progression may be suitable in scenarios where the system prioritizes efficiency or where the initiation of the orchestration process itself does not require a separate integrity record.

In block 915, the control layer 110 may initiate an integrity digest challenge for the workload execution bundle. In this way, the control layer may transmit a registered workload artifact reference to the IM module (e.g., process 600 in FIG. 6A) or by also transmitting a computed artifact hash (if available) to the IM module (e.g., process 601 in FIG. 6B). The control layer acts as the challenger interacting with the integrity layer to challenge the integrity digest. This challenge may involve verifying the integrity of the full integrity challenge digest (e.g., 441) and its associated chain of integrity digests.

In response to receiving an indication from the IM module that the integrity digest challenge was successful, the control layer may instruct the execution layer to retrieve and execute workload execution bundle in block 920. The execution layer may then start the workload execution process in block 930 of process 901 (e.g., FIG. 9B). If the IM module (e.g., 320), as part of the integrity digest challenge process (e.g., 600, 601) rejects the integrity digest (e.g., block 627), the control layer (i.e., the agent that initiated this particular integrity digest challenge) may receive a rejection message, which the IM module and/or the control layer may document the failure mode for remediation (i.e., log the failure). This documentation may be stored in the integrity store (e.g., 124) or the persistence layer (e.g., 216) for future reference and analysis.

As illustrated in FIGS. 9B, 901 provides a sequences of steps which may be performed for a compute workload's execution process. The workload execution process 901 may pick up in block 930 after receiving instruction from the control layer as part of block 920 of the process 900 (e.g., FIG. 9A). The workload execution module (e.g., 350) of the execution layer (e.g., 112) may perform various aspects of the process 901, which manages the workload's execution lifecycle based on the workload's type (persistent, streaming, or iterative) until completion or termination.

In block 930 the execution layer (e.g., 112) may initiate an integrity digest challenge for the workload execution bundle on one or more execution processors. To do so, the execution layer may pull (i.e., load to each of one or more execution processors) an instance of the workload execution bundle, as instructed by the control layer (e.g., 110) from block 920 of the process 900, via the workload execution bundle identifier, reference, manifest, or digest. This identifier, reference, manifest, or digest may allow the execution layer to initiate an integrity digest challenge on each of one or more execution processors by providing the artifact reference, including any existing integrity digest chain, to the integrity layer (e.g., IM module) to challenge the workload integrity digest of each instance of the pulled (i.e., loaded) workload (e.g., using an integrity digest challenge process 600, 601). In this way, the execution layer may verify the integrity of compute workloads before execution on each of one or more execution processors.

This verification may provide an additional layer of security to ensure that the workload has not been altered between orchestration and execution, or during transmission of the workload execution bundle from its persistence location to the execution processor(s). The control layer may have already performed an integrity check before orchestration, but this subsequent verification by the execution layer helps detect any potential changes that could have occurred during the transfer or staging of the workload. This dual-check approach enhances the overall security posture by verifying integrity at multiple points in the workflow. For example, the workload could potentially be modified during network transmission between layers, tampered with while temporarily stored in memory or on disk before execution, or altered by malicious code injection attempts. The execution layer's verification serves as an additional safeguard immediately before running the workload on compute resources.

In response to receiving an indication from the IM module that the integrity digest challenge was successful, the execution layer may determine whether the compute workload is persistent or streaming in determination block 945. If the IM module (e.g., 320), as part of the integrity digest challenge process (e.g., 600, 601) rejects the integrity digest (e.g., block 627), the execution layer (i.e., the agent that initiated this particular integrity digest challenge) may receive a rejection message, which the IM module and/or the execution layer may document the failure mode for remediation (i.e., log the failure), potentially triggering a notification to the agent that initiated the workload. This documentation may be stored in the integrity store (e.g., 124) or the persistence layer (e.g., 216) for future reference and analysis.

In determination block 945, the execution layer evaluates whether the compute workload is either persistent or streaming, as opposed to one-time execution or iterative. This evaluation is used to determine the appropriate execution strategy for the workload. Persistent workloads are designed to run continuously, maintaining state and processing data over extended periods. They typically handle ongoing tasks or services that require high availability, such as may be provided for query processing engines, model serving engines, or other API services. Similarly, streaming workloads may run continuously to process data in real-time or near-real-time as it arrives, often dealing with the processing of continuous or incremental flows of information. Streaming workloads may support interval-or data volume-based execution (e.g., mini-batch/micro-batch execution on a data buffer that gets flushed every 1 second or 100 records), or may be configured to immediately execute when new data elements arrive (e.g., low-latency streaming). Both persistent and streaming workloads contrast with single execution workloads, which process exactly once then terminate, and iterative workloads, which execute in discrete cycles or batches until one or more termination conditions are satisfied. Iterative workloads may have dynamically determined termination conditions based on changes in workload inputs or outputs over time or may have fixed termination conditions determined a priori by externally defined settings (e.g., after a fixed iteration count). The distinction between these workload types influences how the execution layer manages resources, schedules tasks, and handles potential failures or interruptions. For persistent and streaming workloads, the system may need to implement strategies for long-running processes, such as checkpointing or state management, while one-time execution or iterative workloads might require different optimization techniques focused on batch processing efficiency.

In response to the execution layer determining that the compute workload is either persistent or streaming (i.e., determination block 945=“Yes”), the execution layer may launch the compute workload in block 950. In response to the execution layer determining that the compute workload is neither persistent nor streaming (i.e., determination block 945=“No”), the execution layer may determine whether the compute workload is iterative in determination block 955.

In block 950, the execution layer may launch the compute workload using various approaches depending on the system configuration, workload requirements, and available resources. For example, the execution layer may launch a compute workload using container-based deployment, virtual machine instantiation, and/or serverless function execution.

The execution layer may utilize containerization technologies such as Docker or Kubernetes to launch the compute workload. In this approach, the execution layer may initiate the container runtime, configure the necessary network interfaces and storage volumes, and create a container instance based on the workload execution bundle. The workload may then execute within an isolated environment with its own filesystem, network stack, and resource allocations. This method may provide portability across different computing environments and efficient resource utilization.

For workloads requiring more isolation or specific operating system environments, the execution layer may launch the compute workload by instantiating a virtual machine (VM). This process may involve selecting an appropriate VM image, allocating virtual CPU cores, memory, and storage resources, and booting up the VM. Once the VM is running, the execution layer may deploy the workload execution bundle within the VM and initiate the workload processes. This approach may offer stronger isolation between workloads and support for legacy applications that require specific operating system configurations.

In cases where the compute workload is designed as a set of discrete functions, the execution layer may utilize a serverless computing model to launch the workload. The execution layer may parse the workload execution bundle into individual functions, configure triggers or event sources for each function, and register them with a serverless platform. When triggered, these functions may be automatically instantiated, executed, and terminated, allowing for highly scalable and event-driven workload processing.

In block 952, the execution layer 112 In block 960, the execution layer additionally marks the workload as active. A persistent or streaming workload may execute perpetually on viable executors until a failure mode occurs or the control layer terminates the workload. Marking the workload as active indicates that the workload is now running and being processed by the system. This step is useful for tracking the status of workloads within the distributed compute environment. For persistent or streaming workloads, this active state may be maintained for an extended period, potentially indefinitely, as these types of workloads are designed for continuous operation.

Persistent workloads are typically long-running processes that maintain state and continue executing until explicitly terminated. They may handle ongoing tasks, manage continuous data streams, or provide always-on services. Examples of persistent workloads include database management systems, web servers, or monitoring applications. Streaming workloads, on the other hand, process data in real-time or near-real-time as it arrives. These workloads may be designed to handle continuous or incremental flows of information, such as social media feeds, sensor data from IoT devices, or financial market data streams. They remain active to continuously ingest, process, and output data without interruption. Both persistent and streaming workloads will continue to execute on viable executors within the execution layer. Viable executors refer to the available computational resources (such as processors, memory, and storage) that meet the workload's requirements and are capable of running the workload efficiently.

The execution of these workloads continues until one of two conditions is met, namely that a failure mode occurs, or the control layer terminates the workload. A failure mode may occur due to various reasons such as hardware failures, network issues, resource exhaustion, or errors within the workload itself. When a failure is detected, the system may attempt to recover the workload or terminate it, depending on the nature of the failure and the system's configuration. The control layer may terminate the workload for various reasons, including scheduled maintenance, resource reallocation, or in response to external commands or policies. The control layer, being responsible for orchestrating and managing workloads, may have the authority to terminate any active workload when necessary.

By maintaining this active state and allowing for perpetual execution, the system can efficiently handle long-running and real-time or near-real-time processing tasks while still maintaining control over resource allocation and system stability.

In determination block 955, the execution layer may determine whether the compute workload is iterative. This determination helps decide the appropriate execution strategy for the workload. Iterative workloads are designed to perform repeated cycles of computation, often processing data in batches or refining results through multiple passes. Unlike persistent or streaming workloads, which run continuously, iterative workloads have a defined set of repetitions or a termination condition. Examples of iterative workloads include machine learning training algorithms, optimization processes, and simulations that require multiple iterations to converge on a solution. These workloads typically process a finite dataset or perform calculations until a specific condition is met, such as reaching a desired level of accuracy or a maximum number of iterations.

The execution layer's determination of whether a workload is iterative affects how resources are allocated and how the workload's progress is monitored. Iterative workloads may require different handling compared to one-time execution, persistent, or streaming workloads, such as checkpoint management, progress tracking, resource allocation, and/or termination handling. Checkpoint management saves intermediate states between iterations to allow for recovery or analysis. Progress tracking monitors the number of completed iterations or convergence metrics. Resource allocation potentially adjusts computational resources between iterations based on performance or remaining workload. Termination handles implementing logic to detect when the iterative process should conclude based on predefined criteria. By accurately identifying iterative workloads, the execution layer may optimize their execution, ensure proper resource utilization, and manage their lifecycle effectively within the distributed compute environment.

In response to the execution layer determining that the compute workload is not iterative (i.e., determination block 955=“No”), the execution layer may launch the non-iterative, single execution compute workload in block 950. In response to the execution layer determining that the compute workload is iterative (i.e., determination block 955=“Yes”), the execution layer may launch the iterative compute workload in block 980.

In block 950, the execution layer 112 may handle non-iterative single execution workloads differently from iterative or persistent/streaming workloads. When initiated in block 950 and coming from determination block 955=“No”, a non-iterative single execution workload may run through completion once on viable executors, generate associated outputs based on the workload definition, and self-terminate. For non-iterative workloads, the execution process may be comparatively straightforward. The execution layer immediately launches the workload and marks it as active in block 960. This active status indicates that the workload is currently being processed and allows the system to track its progress. Non-iterative single execution workloads are designed to run once from start to finish without repeating cycles or maintaining a persistent state. Once initiated, these workloads execute on viable executors, which are available computational resources within the execution layer that meet the workload's requirements. The workload processes its tasks to completion, possibly in one or more stages comprising one or more steps across one or more data partitions, and may generate outputs as defined in the workload definition. These outputs could include processed data, analysis results, or any other specified deliverables. After completing all its designated tasks, a non-iterative workload may be programmed to self-terminate. This self-termination feature ensures efficient resource management by automatically releasing the computational resources back to the system once the workload has finished its execution. The self-termination also signals to the control layer that the workload has completed its lifecycle, allowing the system to update its status and potentially trigger any post-execution processes or notifications.

This approach to handling non-iterative workloads optimizes system resources by ensuring that workloads do not unnecessarily occupy computational capacity after completion. It also simplifies workload management for the control layer, as these workloads have a clear start and end point without the need for ongoing monitoring or intervention that might be required for persistent or iterative workloads.

In determination block 970, the execution layer may determine whether the compute workload terminated. This includes either the persistent or streaming workloads following block 960 or the non-iterative workloads following block 960. Determination block 970 evaluates whether the compute workload has reached its termination point.

For persistent or streaming workloads, termination is not an inherent part of their execution cycle. These workloads are designed to run continuously, processing data in real-time or maintaining ongoing operations. Termination for such workloads typically occurs due to external factors, such as a system shutdown command, resource constraints, or error conditions that force the workload to stop.

In the case of non-iterative workloads, termination is an expected part of their lifecycle. These workloads are designed to perform a specific task or set of tasks and then conclude their execution. The termination of a non-iterative workload usually indicates the successful completion of its assigned tasks. By implementing this determination block, the execution layer ensures proper management of workload lifecycles, contributing to the overall stability, efficiency, and security of the distributed compute system.

The execution layer's determination of workload termination may assist with resource management, workflow progression, error detection, performance monitoring, and audit/logging. Resource management by the control layer or delegated to the execution layer or infrastructure layer may identify terminated workloads and allow the system to free up computational resources, memory, and storage that were allocated to those workloads. Workflow progression may help in complex systems with interdependent workloads: the termination of one workload might trigger the initiation of subsequent workloads or processes. Error detection is useful for unexpected termination of persistent or streaming workloads could indicate system errors or failures that require immediate attention. Performance monitoring by the control layer or delegated to the execution layer or infrastructure layer may track the termination of workloads, which helps in assessing system performance, workload completion times, and overall efficiency. Audit and logging, which records the execution and termination of workloads, is helpful for maintaining a comprehensive audit trail of system activities.

In response to the execution layer determining that the compute workload terminated (i.e., determination block 970=“Yes”), the execution layer may mark the workload as complete in block 975. In response to the execution layer determining that the compute workload is not terminated (i.e., determination block 970=“No”), the execution layer may continue monitoring the compute workload in determination block 970 until the workload terminates. This execution layer process loop may also coordinate with the control layer as a form of system event or activity monitoring; in turn, the control layer may instruct the execution layer to pre-empt and forcibly terminate a running workload based on monitoring response criteria.

In block 975, following the determination that the workload is terminated in determination block 970 or the workload self-terminates in block 995, the execution layer marks the workload as complete. The control layer may also document the workload completion status with output location for subsequent use. This documentation may be stored in the integrity store (e.g., 124) and/or the persistence layer (e.g., 216) for later retrieval and analysis.

In block 980, after the execution layer determines that a workload is iterative from determination block 955, the execution layer may launch the workload and mark the workload as active in block 982. Iterative workloads differ from single execution, persistent, and streaming workloads in that they have a defined set of iterations (i.e., a fixed iteration count) or one or more dynamically determined termination conditions. Examples of iterative workloads include machine learning training algorithms, optimization processes, and simulations that require multiple iterations to converge on a solution. In instances in which the execution layer launches an iterative workload, it initializes the necessary resources and sets up the environment for the repeated execution cycles.

Marking the workload as active in block 982 assists with resource allocation, status tracking and monitoring, lifecycle management, scheduling, and/or monitoring. Resource allocation signals to the system that computational resources should be dedicated to this workload for its duration. Status tracking and monitoring may allow the control layer and other system components to monitor the workload's progress and state and/or respond to workload-induced system alerts or events. Lifecycle management may indicate the beginning of the workload's active phase, which will continue until a termination condition is met or the maximum number of iterations is reached. Scheduling may enable the execution layer to manage the workload's execution cycles within the broader context of all running workloads in the distributed compute environment.

By launching the iterative workload in block 980 and marking it as active in block 982, the execution layer prepares the system for the subsequent steps in the iterative process, which typically involve executing multiple cycles of the workload, checking for termination conditions, and managing the workload's state between iterations.

In block 990, the workload may process one iteration and generate associated outputs. Iterative workloads are designed to perform repeated cycles of computation. During each iteration, the workload executes its core logic, processes the assigned data or performs calculations, and produces intermediate results or outputs. These outputs may include processed data, updated model parameters, or any other relevant information generated during that specific iteration. The nature of the outputs depends on the workload's purpose and design. For example, in a machine learning training workload, an iteration might involve processing a batch of training data, updating model weights, and generating performance metrics. In an optimization algorithm, each iteration could refine a solution and output better results. The system may store these outputs temporarily or persistently, depending on the workload's requirements and the system's configuration. Additionally, the execution layer may log relevant information about each iteration, such as execution time, resource usage, and any notable events, to facilitate monitoring and optimization of the workload's performance across multiple iterations.

In determination block 992, the execution layer determines whether the iterative workload has reached a termination condition. Termination conditions may vary widely depending on the nature of the workload and its objectives. Common termination conditions include reaching a maximum number of iterations, achieving a desired level of accuracy or convergence, exceeding a time limit, exhausting the input data set, or encountering a specific event or trigger. The execution layer may check these conditions by examining various metrics or flags set during the workload's execution. For example, in a machine learning training workload, the termination condition might be reaching a target model accuracy or a maximum number of training epochs. In an optimization algorithm, it could be achieving a specific threshold for the objective function or detecting that improvements have plateaued.

In instances in which the termination condition is not met, the workload will continue to the next iteration. This cyclical process allows for the refinement of results or the processing of large datasets in manageable chunks. On the other hand, in instances in which the termination condition is met, the workload will proceed to self-terminate in block 995, signaling the completion of its computational task. By implementing this determination step, the execution layer ensures efficient resource utilization and prevents infinite loops, while also allowing workloads to run for as long as necessary to achieve their objectives. This approach balances the need for thorough computation with the practical constraints of system resources and time.

In response to the execution layer determining that the compute workload has reached a termination condition (i.e., determination block 992=“Yes”), the workload self-terminates in block 995. In response to the execution layer determining that the compute workload has not reached a termination condition (i.e., determination block 992=“No”), the execution layer may process another iteration and generate outputs in block 990.

Throughout the processes of workload orchestration and workload execution (e.g., 900, 901), the control layer may be orchestrating the compute workload by assigning the compute workload to at least one processor in the execution layer. This assignment may be based on various factors such as workload requirements, available resources, and system configuration. By implementing these workload orchestration and execution processes, the system may provide a secure and efficient environment for managing compute workloads. The multiple integrity checks throughout the process may help ensure the continued integrity and security of workloads from orchestration through execution and completion.

In various embodiments, the system performs workload output provenance verification (e.g., 360) to ensure the integrity of workload outputs. FIG. 10 illustrates a process flow for a workload output provenance verification process 1000 in accordance with various embodiments.

The workload output provenance verification process 1000, which may begin in response to a workload execution event (e.g., 901), may produce an output in the form of an integrity summary. In block 1010, the control layer (e.g., 110) may initiate an integrity digest challenge (e.g., 601) for the workload output digest chain. The process in block 1010 may occur in response to the execution layer marking a workload as complete (e.g., block 975), or may occur in response to any creation of workload output data (e.g., in a persistent, streaming, or iterative workload after the processing of the workload on an incremental batch of input data). This challenge may evaluate the integrity of all elements in the digest chain involved in generating the output, including integrity digests for workload creation, registration, orchestration, and execution. To initiate this integrity digest challenge, the control layer may supply the IM module (e.g., 320) with an artifact reference for the workload output being challenged. The IM module may perform the integrity digest challenge. This challenge may involve verifying the integrity of each digest in the chain, possibly including the source code digest, the compiled code digest, the workload execution bundle digest, and any associated digests such as the compiler digest, compilation sandbox digest, and dependencies digest.

Following the integrity digest challenge(s) initiated in block 1010, in response to the IM module (e.g., 320), as part of the integrity digest challenge process (e.g., 600, 601), determining that the integrity digest challenge succeeded, the IM module may generate an integrity summary for the workload output in block 1020. In response to the IM module determining that any one of the integrity digest challenges failed, the IM module may report to the control layer that the challenge failed (e.g., 627 in process 600) and mark the output as “not verified.” Marking the output as “not verified” may serve as a clear indicator that the integrity of the workload output could not be confirmed. This status prevents the potentially compromised or tampered output from being used in subsequent processes or decision-making without proper scrutiny. In this way, the IM module may transmit a challenge failed message to the control layer (i.e., the agent that initiated this challenge).

The control layer may document the failure mode for potential remediation. This documentation may be stored in the integrity store and/or the persistence layer (e.g., 216) for future reference and analysis. Documenting the failure mode provides detailed information about the nature of the failure, which can help system administrators or developers identify and address the root cause of the integrity challenge failure. It also creates a record of the integrity verification process, which is useful for maintaining system transparency and accountability. Over time, documented failure modes can reveal patterns or recurring issues that may indicate broader system vulnerabilities or areas for improvement. In regulated industries, documenting such failures and remediation efforts may be useful to meet compliance requirements. By analyzing documented failure modes, the system can be refined and enhanced to prevent similar issues in the future. The documentation of the failure mode may include details such as the specific integrity checks that failed, timestamps, relevant system states, and any contextual information that could aid in the remediation process. This information may be stored in the integrity store (e.g., 124) or the persistence layer (e.g., 216) for future reference and analysis, ensuring that the system maintains a comprehensive record of all integrity-related events throughout the workload lifecycle.

In block 1020, the IM module generates an integrity summary. This integrity summary may serve as a consolidated cryptographic representation of the entire workload output provenance chain. It may encapsulate the results of all successful integrity digest challenges performed on the workload's components and processes, from its initial creation through execution and output generation. The integrity summary may include a hash of all relevant integrity digests, timestamps, and metadata associated with the workload's lifecycle. By generating this summary, the IM module creates a single, verifiable reference point that can be used to quickly validate the integrity of the entire workload output without needing to re-verify each individual component. This summary may be particularly useful for efficient integrity checks in downstream processes or when sharing workload outputs with external systems. The integrity summary may also serve as a tamper-evident seal, as any modifications to the workload or its outputs would result in a mismatch when compared against this summary. The IM module may also store the integrity summary in the integrity store (e.g., 124) and/or the persistence layer (e.g., 216) for further reference and/or analysis. Also, either the IM module may notify the control layer that the integrity summary was generated, or the control layer may monitor the IM module for generation of the integrity summary as an indicator that the integrity challenge was successful.

In block 1030, the control layer may publish the integrity summary along with workload output for consumption by an adjacent or downstream system. This provides a chain of trust and verifiability across interconnected systems within a distributed computing environment. The integrity summary serves as a cryptographic seal of approval, attesting to the integrity and authenticity of the workload output. By publishing this summary alongside the actual output, the control layer enables receiving systems to independently verify the integrity of the data they are consuming.

Adjacent systems may refer to closely coupled components within the same organizational infrastructure, such as data processing pipelines or analytics engines that directly consume the output. Downstream systems, on the other hand, could be more loosely connected entities, potentially including external partners, clients, or even public consumers of the data. The publication process may involve several aspects, such as data packaging, transmission, access control, metadata inclusion, and/or verification instructions. For data packaging, the control layer bundles the integrity summary with the workload output in a standardized format, ensuring that the two elements remain logically linked. For transmission, the packaged data is sent through secure channels, potentially utilizing the mutual Transport Layer Security (mTLS) protocols mentioned earlier in the document. For access control, the control layer may implement fine-grained access policies to ensure that only authorized adjacent or downstream systems can receive the published data. For metadata inclusion, additional contextual information, such as timestamps, workload identifiers, or system state indicators, may be included to provide a comprehensive provenance record. For verification instructions, the published package may include guidelines or references to tools that receiving systems can use to verify the integrity summary against the workload output.

By publishing both the integrity summary and the workload output together, the system creates a self-contained, verifiable unit of data. This approach enhances the overall security and trustworthiness of the distributed compute environment, allowing data to flow between systems while maintaining a robust chain of integrity verification.

By implementing this comprehensive workload output provenance verification process, the system may ensure that only verified and integrity-checked outputs are made available for further use or analysis. This process may significantly enhance the reliability and trustworthiness of the distributed compute system's outputs, reducing the risk of using compromised or tampered results in subsequent operations or decision-making processes.

In some embodiments, the workload output provenance verification process may be integrated with other system processes (e.g., 301), such as workload execution (e.g., 350) and workload orchestration (e.g., 340). This integration may allow for real-time or near-real-time verification of outputs as they are generated, enhancing the overall efficiency and security of the system.

The workload output provenance verification process may leverage the connections between system components, such as the control-execution connection (e.g., 118) and integrity-execution connection (e.g., 120), to facilitate the exchange of integrity-related information throughout the verification process. These connections may enable the coordinated operation of the various system components involved in verifying the provenance of workload outputs.

In some embodiments, the system may initialize using a process for securely starting up and verifying the integrity of system components. FIG. 11 illustrates a flowchart for the system initialization process 1100.

In block 1105, a dedicated initialization module receives an initialization signal from an agent. This initialization signal serves as the trigger for the system boot process, allowing the initialization module to begin coordinating the startup sequence across various components of the distributed compute architecture. The agent initiating this process may be a system administrator performing a manual startup, an automated system daemon executing a scheduled reboot, or an operating system process recovering from a crash. For example, a system administrator might send an API call to initiate the boot sequence when applying critical security updates, or an automated daemon might trigger initialization daily during off-peak hours to ensure system freshness.

Initialization may be triggered for various reasons, such as system startup, configuration changes, or recovery from errors. For example, a system administrator may initiate initialization to apply security patches or update system components. An external system daemon could trigger initialization as part of a scheduled maintenance routine or in response to detected anomalies. An operating system process might initiate initialization after a system crash or power failure to restore normal operations. The flexibility in initialization triggers allows the system to adapt to different operational needs and maintain reliability across diverse scenarios.

Prior to or as part of receiving the initialization signal, the initialization module may receive runtime metadata, configuration settings, and/or enumeration of system components from an agent. This optionally allows for dynamic configuration of the system during the boot process. The agent, which could be an automated script or a system administrator, may provide specific parameters tailored to the current operational needs. For example, the agent might inject configuration settings that enable certain features for a particular workload or provide a list of active system components for this boot instance. This information may be provided by the agent in a configuration file that the initialization module is configured to read or as arguments to the call the runs the initialization process.

In block 1110, the dedicated initialization module starts a system boot sequence, which includes a self-integrity check. This self-integrity check verifies the authenticity and integrity of the boot process itself. The dedicated initialization module may compute a checksum or hash of the boot sequence executable and compare it against a known good value. For instance, the system might use a SHA-256 hash of the boot sequence code and compare it to a securely stored reference hash to detect any unauthorized modifications. This process helps ensure that the foundation of the system startup has not been compromised.

In determination block 1115, the dedicated initialization module determines whether the system boot sequence passed the self-integrity check. The dedicated initialization module may evaluate the results of the integrity check performed in block 1110, comparing the computed checksum or hash against the expected value. For example, in instances in which the computed SHA-256 hash of the boot sequence matches the stored reference hash, the integrity check would be considered successful.

In response to the dedicated initialization module determining that the system boot sequence passed the self-integrity check (i.e., determination block 1115=“Yes”), the initialization module starts the integrity layer (e.g., 114) in block 1120, which will eventually be used for creating and challenging integrity digests. In response to the dedicated initialization module determining that the system boot sequence failed the self-integrity check (i.e., determination block 1115=“No”), the dedicated initialization module reports that the system initialization failed in block 1117. This failure notification may trigger emergency procedures, such as reverting to a known (i.e., trusted), good configuration or alerting system administrators of a potential security breach.

In block 1120, once the integrity layer is started by the initialization module, the integrity layer may perform a self-integrity check. This self-integrity check may confirm that its executable has not been tampered with or otherwise compromised between creation and initialization, and particularly before it begins verifying other system components. The integrity layer may perform a series of self-checks, such as verifying its own executable code, checking the integrity of its cryptographic keys, and validating its configuration files.

In determination block 1122, the integrity layer may determine whether it passed its own self-integrity check. In response to the integrity layer determining that it passes the self-integrity check (i.e., determination block 1122=“Yes”), in determination block 1124 the integrity layer may check whether this is the first time initializing of the system. In response to the integrity layer determining that it fails the self-integrity check (i.e., determination block 1122=“No”), in block 1117 the system reports initialization failure. This failure could trigger a series of recovery procedures or alert system administrators to investigate the integrity breach.

In determination block 1124, the integrity layer may check the integrity store (e.g., 124) to determine whether this is a first time initializing of the system. This determination affects the subsequent steps in the initialization process, particularly regarding the creation of integrity digests. For a first-time initialization, the system may need to establish its initial set of integrity baselines, while subsequent initializations can build upon existing integrity data. In some embodiments, the integrity layer 114 may use its default or runtime-defined configuration settings to create the system's root integrity digest. In some cases, the root integrity digest may be based on an external root certificate authority (CA).

In response to the integrity layer determining that this is a first time initializing of the system (i.e., determination block 1124=“Yes”), the process flows through a sequence of integrity digest creation steps (i.e., blocks 1130, 1140, 1150, and optionally 1160). In block 1130, the integrity layer generates a root integrity digest. This root digest serves as the foundation for the system's chain of trust. It may be based on hardware-rooted trust, such as a Trusted Platform Module (TPM), or derived from a combination of system components and configuration parameters. In block 1140, the integrity layer initiates integrity digest creation for the control layer, establishing a verifiable baseline for this system component. Similarly, in block 1150, the integrity layer initiates integrity digest creation for the execution layer. In optional block 1160, the integrity layer may initiate integrity digest creation for additional system components and/or modules, allowing for a comprehensive integrity baseline of the system.

In response to determining that this is not a first time initializing of the system (i.e., determination block 1124=“No”), following the initiation by the integrity layer of integrity digest creation for the execution layer (i.e., block 1150), or optionally following the initiation by the integrity layer of integrity digest creation for additional system component(s) and/or module(s) (i.e., optional block 1160), in block 1170 the system boot process initiates integrity digest challenges of system components and modules using the integrity layer. This includes challenges for integrity digests created in blocks 1130, 1140, 1150, and optionally 1160, either from the current first-time system initialization or a prior system initialization. This step verifies the integrity of existing system components against their previously established integrity baselines.

In determination block 1175, the initialization module may check whether the integrity digest challenges succeed. This determination ensures that all system components have maintained their integrity since the last initialization or integrity check. The success or failure of these challenges directly impacts the system's decision to proceed with the boot process.

In response to the process determining that the integrity digest challenges fail (i.e., determination block 1175=“No”), the initialization module reports that the system initialization failed in block 1117. This failure could trigger a series of recovery procedures or alert system administrators to investigate the integrity breach.

In response to the initialization module determining that the integrity digest challenges all succeed (i.e., determination block 1175=“Yes”), the system boot process starts the control layer in block 1180, followed by the control layer starting the execution layer in block 1190. Also, in optional block 1195, the control layer may start any optional components or modules. These steps activate the core system components in a verified state.

In some embodiments, the control layer 110 may start the execution layer 112. The control layer 110 may also start any optional system components or modules, such as the persistence layer 216, infrastructure layer 218, or interface layer 220.

By implementing this comprehensive system initialization process 1100, the system may ensure that all components are verified and secure before beginning normal operations. This process may enhance the overall confidentiality, integrity, and availability of the distributed compute system, reducing the risk of compromised or tampered components affecting system operations.

In various embodiments, the system may implement an advanced integrity digest challenge to provide more sophisticated confidentiality, integrity, and availability guarantees. FIGS. 12A and 12B together illustrate a flowchart for an advanced integrity digest challenge process 1200, in accordance with various embodiments. The “challenger,” as used herein, refers to an agent (e.g., an internal system component or external actor 310) who initiates the advanced integrity digest challenge process 1200. The challenger may or may not be the same agent involved in other processes described herein.

In block 1210, the IM module receives from a challenger a challenged integrity digest reference. The challenger, in this context, can be any authorized entity within or external to the system that requires verification of an integrity digest. This could include the control layer (e.g., 110), the execution layer (e.g., 112), or even an external actor (e.g., 310) interacting through the interface layer. By providing the challenged integrity digest reference, the challenger is essentially requesting the IM module to confirm that a particular integrity digest has not been tampered with and maintains its expected state. The IM module, upon receiving this integrity digest reference, prepares to perform a series of checks and comparisons to ensure the integrity of the challenged integrity digest.

In block 1215, the IM module may attempt to locate (e.g., using a query) and retrieve, from the integrity store (e.g., 124), a cached representation of the integrity digest associated with the challenged integrity digest reference. Alternatively or additionally, the retrieval attempt may involve accessing stored integrity digests from a secure database or storage system. For example, the system might query a distributed ledger or a tamper-resistant hardware security module to retrieve the relevant integrity digest. If the cached integrity digest is retrieved, the integrity digest retrieval will be considered successful. In contrast, if the cached integrity digest retrieval fails, the integrity digest retrieval will be considered unsuccessful (i.e., a failure).

In determination block 1217, the IM module evaluates whether the retrieval was successful. This process may be the same or analogous to determination block 625 in process 600. The success or failure of the retrieval may depend on various factors, such as network connectivity, data availability, or access permissions.

In response to the IM module determining that the retrieval was not successful (i.e., determination block 1217=“No”), the IM module may verify the challenged digest signature and countersignature in block 1250 (e.g., FIG. 12B). In response to the IM module determining that the retrieval was successful (i.e., determination block 1217 =“Yes”), the IM module may compute the hash of the challenged integrity digest in block 1220.

In block 1220, the IM module computes the hash of the challenged integrity digest. This computation involves applying a cryptographic hash function to the retrieved integrity digest. The choice of hash function may vary depending on the system's security requirements and computational capabilities. For instance, the system might use SHA-256 for its balance of security and efficiency, or it could employ more advanced algorithms like SHA-3 for enhanced protection against potential vulnerabilities. This process may be the same or analogous to block 630 in process 600.

In block 1225, the IM module compares the hash of the challenged Integrity Digest to the hash of the cached Integrity Digest. This comparison is a step in verifying the integrity of the challenged digest. This process may be the same or analogous to block 640 in process 600.

In determination block 1227, the IM module evaluates if the digest hashes match. This evaluation helps determine whether the challenged integrity digest has been tampered with or remains consistent with its original, verified state. This process may be the same or analogous to determination block 645 in process 600.

In response to the IM module determining that the digest hashes do not match (i.e., determination block 1227=“No”), the IM module may inform the challenger that the challenge failed in block 1240. In response to the IM module determining that the digest hashes match (i.e., determination block 1227=“Yes”), the IM module may compute the hash of the artifact referenced in the challenged Integrity Digest in block 1230.

In block 1230, the IM module computes the hash of the artifact referenced in the challenged integrity digest. This step involves calculating a cryptographic hash of the actual data or code that the integrity digest represents. The system may use various hashing algorithms depending on the nature of the artifact and the required security level. For example, large files might use a streaming hash function to efficiently process the data, while smaller artifacts could use more computationally intensive algorithms for added security.

In block 1235, the IM module compares the new artifact hash with the artifact hash in the challenged integrity digest. This comparison verifies that the artifact itself has not been modified since the integrity digest was created. The IM module may implement secure comparison techniques to prevent potential side-channel attacks during this process.

In determination block 1237, the IM module determines whether the artifact hashes match. This check confirms the integrity of the artifact referenced by the challenged integrity digest.

In response to the IM module determining that the artifact hashes do not match (i.e., determination block 1237=“No”), the IM module may inform the challenger, in block 1240, that the challenge failed. In response to the IM module determining that the artifact hashes match (i.e., determination block 1237=“Yes”), the IM module may inform the challenger that the challenge succeeded in block 1245.

As illustrated in FIG. 12B, in response to the IM module determining that the retrieval of the cached integrity digest was not successful (i.e., determination block 1217=“No”—FIG. 12A), in block 1250, the IM module verifies the challenged digest signature and countersignature. This verification process may involve checking digital signatures using public key cryptography. The system might employ algorithms like RSA or elliptic curve cryptography for signature verification, depending on its security requirements and performance considerations.

In determination block 1255, the IM module determines whether the verification was successful. This evaluation determines whether the signatures on the challenged digest are valid and trustworthy. The verification process may involve cryptographic checks to ensure the authenticity and integrity of the challenged digest. The verification is considered successful only if both the primary signature and the countersignature are valid. This dual-signature approach provides an additional layer of security, as it requires potential attackers to compromise multiple signing authorities to create a falsified digest. The verification process may also include checks for certificate validity, revocation status, and timestamp accuracy to further enhance the trustworthiness of the signatures. In instances in which any part of this verification process fails, it could indicate tampering, use of revoked keys, or other security issues that would render the challenged digest untrustworthy for further use in the system.

In response to the IM module determining that the verification was not successful (i.e., determination block 1255=“No”), the IM module may inform the challenger that the challenge failed in block 1240. In response to the IM module determining that the verification was successful (i.e., determination block 1255=“Yes”), the IM module may compute the hash of the artifact referenced in the challenged integrity digest in block 1260.

In block 1260, the IM module computes the hash of the artifact referenced in the challenged integrity digest. This computation is similar to the process in block 1230, but occurs in a different context within the challenge flow.

In block 1265, the IM module compares the new artifact hash with the challenged Integrity Digest artifact hash. This comparison serves as an additional verification step to ensure the integrity of the artifact. This comparison is similar to the process in block 1235 but occurs in a different context within the challenge flow.

In determination block 1270, the IM module checks if the artifact hashes match. This check confirms whether the artifact referenced in the challenged digest remains unaltered.

In response to the IM module determining that the artifact hashes do not match (i.e., determination block 1270=“No”), the IM module may inform the challenger that the challenge failed in block 1240. In response to the IM module determining that the artifact hashes match (i.e., determination block 1270=“Yes”), the IM module may check whether the integrity digest chain is empty in determination block 1275.

In determination block 1275, the IM module checks whether the integrity digest chain is empty. This check determines whether there are additional linked integrity digests that need to be verified as part of a chain of trust.

In response to the IM module determining that the integrity digest chain is empty (i.e., determination block 1275=“Yes”), the IM module may inform the challenger that the challenge succeeded in block 1245. In response to the IM module determining that the integrity digest chain is not empty (i.e., determination block 1275=“No”), the IM module may recursively challenge each integrity digest in the integrity digest chain in block 1280. This recursive process allows for the verification of a complete chain of integrity digests, potentially tracing back to a root of trust. The system may implement optimizations such as parallel processing or caching intermediate results to enhance the efficiency of this recursive challenge process.

In determination block 1285, the IM module evaluates whether the recursive challenge was successful. This evaluation determines whether all integrity digests in the chain have been successfully verified.

In response to the IM module determining that the recursive challenge was successful (i.e., determination block 1285=“Yes”), the IM module may inform the challenger that the challenge succeeded in block 1245. In response to the IM module determining that the recursive challenge was not successful (i.e., determination block 1285=“No”), the IM module may inform the challenger that the challenge failed in block 1240.

This advanced integrity digest challenge process may provide more sophisticated confidentiality, integrity, and availability guarantees compared to simpler verification methods. By incorporating multiple layers of verification, including hash comparisons, signature verifications, and recursive chain checks, the process may help detect potential tampering or inconsistencies at various stages of the workload lifecycle.

Implementation examples are described in the following paragraphs. While some of the following implementation examples are described in terms of example methods, further example implementations may include: the example methods discussed in the following paragraphs implemented by a computing system including a processing system configured (e.g., with processor-executable instructions) to perform operations of the methods of the following implementation examples; and the example methods discussed in the following paragraphs may be implemented as a non-transitory processor-readable storage medium having stored thereon processor-executable instructions configured to cause a processing system of a computing system to perform the operations of the methods of the following implementation examples.

### Example 1

A method of secure orchestration and execution of verified distributed compute workloads including: receiving, by a control layer, a compute workload from a source; initiating, by the control layer, an integrity digest challenge with an integrity layer for the compute workload; orchestrating, by the control layer, the compute workload within an execution layer based on specified criteria when the integrity digest challenge succeeds; monitoring, by the control layer, execution of the compute workload within the execution layer; and responding, by the control layer, to monitored events and alerts generated by the control layer, the execution layer, and the integrity layer.

### Example 2

The method of example 1, further including: creating, by the integrity layer, an integrity digest for the compute workload prior to the integrity digest challenge.

### Example 3

The method of any of examples 1-2, wherein creating the integrity digest includes: computing a hash of the compute workload; and storing the hash in an integrity store.

### Example 4

The method of any of examples 1-3, wherein orchestrating the compute workload includes: assigning the compute workload to at least one processor across at least one execution node in the execution layer.

### Example 5

The method of any of examples 1-4, further including: verifying, by the execution layer, integrity of the compute workload before execution on the at least one execution node.

### Example 6

The method of any of examples 1-5, further including: enforcing, by the integrity layer, encryption for communication and data exchange within the system.

### Example 7

The method of any of examples 1-6, wherein enforcing encryption includes: configuring the system to use mutual Transport Layer Security (mTLS) between system components involved in command-and-control communications over a computer network.

As used in this application, terminology such as “unit,” “component,” “module,” “system,” etc., is intended to encompass a software-implemented or computer-related entity. These entities may involve, among other possibilities, hardware, firmware, a blend of hardware and software, software alone, or software in an operational state. As examples, a component may encompass a running process on a processor, the processing system itself, an object, an executable file, a thread of execution, a program, or a computing device. To illustrate further, both an application operating on a computing device and the computing device itself may be designated as a component. A component might be situated within a single process or thread of execution or could be distributed across multiple processors or cores. In addition, these components may operate based on various non-volatile computer-readable media that store diverse instructions and/or data structures. Communication between components may take place through local or remote processes, function or procedure calls, electronic signaling, data packet exchanges, and memory interactions, among other known methods of network, computer, processor, or process-related communications.

A number of different types of memories and memory technologies are available or contemplated in the future, any or all of which may be included and used in systems and computing devices that implement the various embodiments.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods may be substituted for or combined with one or more operations of the methods.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an,” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

In one or more embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include random access memory (RAM), read-only memory (ROM), electrically erasable programmable read-only memory (EEPROM), FLASH memory, solid-state drives (SSD), non-volatile memory express (NVMe) drives, or any other medium that may be used to store target program code in the form of instructions or data structures and that may be accessed by a computer. Modern technologies, such as cloud-based storage solutions, including infrastructure-as-a-service (IaaS) platforms, may offer scalable and distributed options for storing and accessing program code.

In addition, the operations of a method or algorithm may reside as one or any combination or set of codes and/or instructions on a non-transitory processor-readable medium and/or computer-readable medium, which may be incorporated into a computer program product. Emerging technologies, including quantum computing storage media and blockchain-based storage solutions, may further enhance data integrity and security. Artificial intelligence (AI) and machine learning (ML)-optimized hardware accelerators, such as graphical processing systems (GPUs) and tensor processing systems (TPUs), may be used to execute complex algorithms.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A method comprising:
transmitting, to an integrity node of an integrity layer of a distributed compute system, a request to perform an integrity challenge for a workflow artifact for a workflow, wherein the integrity challenge request comprises reference information for the workflow artifact;
accessing the workflow artifact at the integrity node based on the reference information;
identifying a digest entry corresponding to the accessed workflow artifact within an integrity store of the distributed compute system, wherein the integrity store comprises a set of digest entries for a set of workflow artifacts for the workflow and wherein each of the set of digest entries comprises a hash of the corresponding workflow artifact and chain information identifying one or more other digest entries stored by the integrity store upon which the corresponding workflow artifact is based;
generating a hash of the accessed workflow artifact;
comparing the generated hash to the hash stored in the identified digest entry to determine whether the generated hash matches the stored hash;
responsive to the generated hash matching the stored hash, recursively performing an integrity challenge for each of one or more workflow artifacts associated with the one or more digest entries identified in the chain information of the identified digest entry, wherein an integrity challenge for a digest entry of the one or more digest entries comprises comparing a generated hashes of the workflow artifact associated with the digest entry with a hash stored in the digest entry; and
responsive to the recursively performed integrity challenges being successful, transmitting instructions by the integrity node to another node of distributed compute system to proceed with workflow.

2. The method of claim 1, further comprising:
transmitting the request to perform the integrity challenge to the integrity node by a node within a control layer of the distributed compute system.

3. The method of claim 2, further comprising:
transmitting the request to perform the integrity challenge responsive to receiving instructions from a device associated with a user to execute the workflow.

4. The method of claim 2, further comprising:
receiving the instructions to proceed with the workflow at the other node within the control layer;
generating an execution bundle for the workflow, wherein the execution bundle comprises the workflow artifact and the one or more workflow artifacts associated with the chain information of the identified digest entry; and
transmitting the execution bundle to a node in an execution layer of the distributed compute engine.

5. The method of claim 1, wherein the workflow artifact comprises at least one of: source code, compiled source code, a compiler, or a dependency of source code.

6. The method of claim 1, wherein the workflow artifact comprises compiled source code and wherein the one or more workflow artifacts of the chain information comprise source code associated with the compiled source code, a compiler that generated the compiled source code, and a dependency used to generate the compiled source code.

7. The method of claim 1, wherein the reference information for the workflow artifact comprises a file path for the workflow artifact.

8. The method of claim 1, wherein the integrity store comprises a table for storing the set of digest entries.

9. The method of claim 1, wherein an integrity challenge for a digest entry of the one or more digest entries comprises:
accessing the workflow artifact associated with the digest entry based on reference information stored in the digest entry;
generating a hash of the workflow artifact associated with the digest entry; and
comparing the generated hash to the hash stored in the digest entry to determine whether the generated has matches the stored hash.

10. The method of claim 9, wherein the integrity challenge for the digest entry of the one or more digest entries comprises:
performing an integrity challenge on one or more other digest entries identified in chain information of the digest entry.

11. A non-transitory computer-readable medium storing computer-executable instructions that, when executed, cause a computing system to perform operations comprising:
transmitting, to an integrity node of an integrity layer of a distributed compute system, a request to perform an integrity challenge for a workflow artifact for a workflow, wherein the integrity challenge request comprises reference information for the workflow artifact;
accessing the workflow artifact at the integrity node based on the reference information;
identifying a digest entry corresponding to the accessed workflow artifact within an integrity store of the distributed compute system, wherein the integrity store comprises a set of digest entries for a set of workflow artifacts for the workflow and wherein each of the set of digest entries comprises a hash of the corresponding workflow artifact and chain information identifying one or more other digest entries stored by the integrity store upon which the corresponding workflow artifact is based;
generating a hash of the accessed workflow artifact;
comparing the generated hash to the hash stored in the identified digest entry to determine whether the generated hash matches the stored hash;
responsive to the generated hash matching the stored hash, recursively performing an integrity challenge for each of one or more workflow artifacts associated with the one or more digest entries identified in the chain information of the identified digest entry, wherein an integrity challenge for a digest entry of the one or more digest entries comprises comparing a generated hashes of the workflow artifact associated with the digest entry with a hash stored in the digest entry; and
responsive to the recursively performed integrity challenges being successful, transmitting instructions by the integrity node to another node of distributed compute system to proceed with workflow.

12. The non-transitory computer-readable medium of claim 11, the operations further comprising:
transmitting the request to perform the integrity challenge to the integrity node by a node within a control layer of the distributed compute system.

13. The non-transitory computer-readable medium of claim 12, the operations further comprising:
transmitting the request to perform the integrity challenge responsive to receiving instructions from a device associated with a user to execute the workflow.

14. The non-transitory computer-readable medium of claim 12, the operations further comprising:
receiving the instructions to proceed with the workflow at the other node within the control layer;
generating an execution bundle for the workflow, wherein the execution bundle comprises the workflow artifact and the one or more workflow artifacts associated with the chain information of the identified digest entry; and
transmitting the execution bundle to a node in an execution layer of the distributed compute engine.

15. The non-transitory computer-readable medium of claim 11, wherein the workflow artifact comprises at least one of: source code, compiled source code, a compiler, or a dependency of source code.

16. The non-transitory computer-readable medium of claim 11, wherein the workflow artifact comprises compiled source code and wherein the one or more workflow artifacts of the chain information comprise source code associated with the compiled source code, a compiler that generated the compiled source code, and a dependency used to generate the compiled source code.

17. The non-transitory computer-readable medium of claim 11, wherein the reference information for the workflow artifact comprises a file path for the workflow artifact.

18. The non-transitory computer-readable medium of claim 11, wherein the integrity store comprises a table for storing the set of digest entries.

19. The non-transitory computer-readable medium of claim 11, wherein an integrity challenge for a digest entry of the one or more digest entries comprises:
accessing the workflow artifact associated with the digest entry based on reference information stored in the digest entry;
generating a hash of the workflow artifact associated with the digest entry; and
comparing the generated hash to the hash stored in the digest entry to determine whether the generated has matches the stored hash.

20. The non-transitory computer-readable medium of claim 19, wherein the integrity challenge for the digest entry of the one or more digest entries comprises:
performing an integrity challenge on one or more other digest entries identified in chain information of the digest entry.
